(19) United States
(12) Patent Application Publication
(10) Pub. No.: US 2025/0141704 A1
(43) Pub. Date: May 1, 2025

(54) TECHNIQUE FOR OPTIMIZING PCC RULES UPDATES FOR MULTIPLE PDU SESSIONS

(71) Applicant: Nokia Solutions and Networks Oy, Espoo (FI)

(72) Inventors: Horst Thomas BELLING, Munich (DE); Rajesh Babu NATARAJAN, Bangalore (IN); Apostolos PAPAGEORGIOU, Massy (FR); Parthasarathi RAVINDRAN, Bangalore (IN)

(21) Appl. No.: 18/925,193

(22) Filed: Oct. 24, 2024

(30) Foreign Application Priority Data
Oct. 25, 2023 (IN) 202341072605

(51) Int. Cl. H04L 12/14; H04L 67/141; H04L 67/146

(52) U.S. Cl. CPC H04L 12/1407; H04L 67/141; H04L 67/146

(57) ABSTRACT

An apparatus configured to: determine at least one policy and charging control rule, wherein the at least one policy and charging control rule applies to a plurality of protocol data unit sessions, wherein the at least one policy and charging control rule is associated with at least one indication of at least one of the plurality of protocol data unit sessions to which the at least one policy and charging control rule applies; and provide the at least one policy and charging control rule.

### TECHNICAL FIELD

The example and non-limiting embodiments relate generally to policy and charging control (PCC) rules and, more particularly, to updates to PCC rules applicable for multiple protocol data unit (PDU) sessions and/or multiple UEs.

### BACKGROUND

It is known, for PCC rule updates, to provide updates to the session management function (SMF) per session management (SM) policy association.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: determine at least one policy and charging control rule, wherein the at least one policy and charging control rule applies to a plurality of protocol data unit sessions, wherein the at least one policy and charging control rule is associated with at least one indication of at least one of the plurality of protocol data unit sessions to which the at least one policy and charging control rule applies; and provide the at least one policy and charging control rule.

In accordance with one aspect, a method comprising: determining, with a policy charging function, at least one policy and charging control rule, wherein the at least one policy and charging control rule applies to a plurality of protocol data unit sessions, wherein the at least one policy and charging control rule is associated with at least one indication of at least one of the plurality of protocol data unit sessions to which the at least one policy and charging control rule applies; and providing the at least one policy and charging control rule.

In accordance with one aspect, an apparatus comprising means for: determining at least one policy and charging control rule, wherein the at least one policy and charging control rule applies to a plurality of protocol data unit sessions, wherein the at least one policy and charging control rule is associated with at least one indication of at least one of the plurality of protocol data unit sessions to which the at least one policy and charging control rule applies; and providing the at least one policy and charging control rule.

In accordance with one aspect, a non-transitory computer-readable medium comprising program instructions stored thereon for performing at least the following: determining at least one policy and charging control rule, wherein the at least one policy and charging control rule applies to a plurality of protocol data unit sessions, wherein the at least one policy and charging control rule is associated with at least one indication of at least one of the plurality of protocol data unit sessions to which the at least one policy and charging control rule applies; and causing providing of the at least one policy and charging control rule.

In accordance with one aspect, an apparatus comprising: at least one processor; and at least one memory storing instructions that, when executed by the at least one processor, cause the apparatus at least to: establish a plurality of protocol data unit sessions, wherein respective protocol data unit sessions of the plurality of protocol data unit sessions are configured to be used to send data streams towards a user equipment and/or to receive data streams from the user equipment; receive at least one policy and charging control rule, wherein the at least one policy and charging control rule applies to two or more of the plurality of protocol data unit sessions, wherein the at least one policy and charging control rule is associated with at least one indication of the two or more protocol data unit sessions to which the at least one policy and charging control rule applies; and apply one or more of the at least one policy and charging control rules to data streams transported within respective ones of the two or more protocol data unit sessions.

In accordance with one aspect, a method comprising: establishing, with a session management function, a plurality of protocol data unit sessions, wherein respective protocol data unit sessions of the plurality of protocol data unit sessions are configured to be used to send data streams towards a user equipment and/or to receive data streams from the user equipment; receiving at least one policy and charging control rule, wherein the at least one policy and charging control rule applies to two or more of the plurality of protocol data unit sessions, wherein the at least one policy and charging control rule is associated with at least one indication of the two or more protocol data unit sessions to which the at least one policy and charging control rule applies; and applying one or more of the at least one policy and charging control rules to data streams transported within respective ones of the two or more protocol data unit sessions.

In accordance with one aspect, an apparatus comprising means for: establishing a plurality of protocol data unit sessions, wherein respective protocol data unit sessions of the plurality of protocol data unit sessions are configured to be used to send data streams towards a user equipment and/or to receive data streams from the user equipment; receiving at least one policy and charging control rule, wherein the at least one policy and charging control rule applies to two or more of the plurality of protocol data unit sessions, wherein the at least one policy and charging control rule is associated with at least one indication of the two or more protocol data unit sessions to which the at least one policy and charging control rule applies; and applying one or more of the at least one policy and charging control rules to data streams transported within respective ones of the two or more protocol data unit sessions.

In accordance with one aspect, a non-transitory computer-readable medium comprising program instructions stored thereon for performing at least the following: causing establishing of a plurality of protocol data unit sessions, wherein respective protocol data unit sessions of the plurality of protocol data unit sessions are configured to be used to send data streams towards a user equipment and/or to receive data streams from the user equipment; causing receiving of at least one policy and charging control rule, wherein the at least one policy and charging control rule applies to two or more of the plurality of protocol data unit sessions, wherein the at least one policy and charging control rule is associated with at least one indication of the two or more protocol data unit sessions to which the at least one policy and charging control rule applies; and applying one or more of the at least one policy and charging control rules to data streams transported within respective ones of the two or more protocol data unit sessions.

In accordance with one aspect, an apparatus comprising: at least one processor; and at least one memory storing instructions that, when executed by the at least one processor, cause the apparatus at least to: determine at least one policy and charging control rule, wherein the at least one policy and charging control rule comprises at least one policy fragment identifier, wherein the at least one policy fragment identifier identifies a fragment of policy or charging information that is applicable to a plurality of protocol data unit sessions; and provide the at least one policy and charging control rule.

In accordance with one aspect, a method comprising: determining, with a policy charging function, at least one policy and charging control rule, wherein the at least one policy and charging control rule comprises at least one policy fragment identifier, wherein the at least one policy fragment identifier identifies a fragment of policy or charging information that is applicable to a plurality of protocol data unit sessions; and providing the at least one policy and charging control rule.

In accordance with one aspect, an apparatus comprising means for: determining at least one policy and charging control rule, wherein the at least one policy and charging control rule comprises at least one policy fragment identifier, wherein the at least one policy fragment identifier identifies a fragment of policy or charging information that is applicable to a plurality of protocol data unit sessions; and providing the at least one policy and charging control rule.

In accordance with one aspect, a non-transitory computer-readable medium comprising program instructions stored thereon for performing at least the following: determining at least one policy and charging control rule, wherein the at least one policy and charging control rule comprises at least one policy fragment identifier, wherein the at least one policy fragment identifier identifies a fragment of policy or charging information that is applicable to a plurality of protocol data unit sessions; and causing providing of the at least one policy and charging control rule.

In accordance with one aspect, an apparatus comprising: at least one processor; and at least one memory storing instructions that, when executed by the at least one processor, cause the apparatus at least to: establish a plurality of protocol data unit sessions, wherein respective ones of the plurality of protocol data unit sessions are configured to be used to send data streams towards a user equipment and/or to receive data streams from the user equipment; and receive, from a policy and charging function, at least one policy and charging control rule in a first policy control session associated with a first protocol data unit session of the plurality of protocol data unit sessions, wherein the at least one policy and charging control rule comprises at least one policy fragment identifier, wherein the at least one policy fragment identifier identifies a fragment of policy or charging information that is applicable to two or more of the plurality of protocol data unit sessions.

In accordance with one aspect, a method comprising: establishing, with a session management function, a plurality of protocol data unit sessions, wherein respective ones of the plurality of protocol data unit sessions are configured to be used to send data streams towards a user equipment and/or to receive data streams from the user equipment; and receiving, from a policy and charging function, at least one policy and charging control rule in a first policy control session associated with a first protocol data unit session of the plurality of protocol data unit sessions, wherein the at least one policy and charging control rule comprises at least one policy fragment identifier, wherein the at least one policy fragment identifier identifies a fragment of policy or charging information that is applicable to two or more of the plurality of protocol data unit sessions.

In accordance with one aspect, an apparatus comprising means for: establishing a plurality of protocol data unit sessions, wherein respective ones of the plurality of protocol data unit sessions are configured to be used to send data streams towards a user equipment and/or to receive data streams from the user equipment; and receiving, from a policy and charging function, at least one policy and charging control rule in a first policy control session associated with a first protocol data unit session of the plurality of protocol data unit sessions, wherein the at least one policy and charging control rule comprises at least one policy fragment identifier, wherein the at least one policy fragment identifier identifies a fragment of policy or charging information that is applicable to two or more of the plurality of protocol data unit sessions.

In accordance with one aspect, a non-transitory computer-readable medium comprising program instructions stored thereon for performing at least the following: causing establishing of a plurality of protocol data unit sessions, wherein respective ones of the plurality of protocol data unit sessions are configured to be used to send data streams towards a user equipment and/or to receive data streams from the user equipment; and causing receiving, from a policy and charging function, of at least one policy and charging control rule in a first policy control session associated with a first protocol data unit session of the plurality of protocol data unit sessions, wherein the at least one policy and charging control rule comprises at least one policy fragment identifier, wherein the at least one policy fragment identifier identifies a fragment of policy or charging information that is applicable to two or more of the plurality of protocol data unit sessions.

In accordance with one aspect, an apparatus comprising: at least one processor; and at least one memory storing instructions that, when executed by the at least one processor, cause the apparatus at least to: receive, from a session management function, a request to update or create at least one session management policy association; transmit, to the session management function, a response to the received request, wherein the response comprises, at least, a correlation identifier assigned to one or more protocol data unit sessions; determine one or more session management policy associations for which new or updated policy and charging control rules are required; determine a session management policy association of the one or more session management policy associations associated with the session management function; determine one or more correlation identifiers associated with the session management policy association associated with the session management function; and transmit, to the session management function, an indication to update one or more protocol data unit sessions, associated with the one or more determined correlation identifiers, with the new or updated policy and charging control rules.

In accordance with one aspect, a method comprising: receiving, with a policy charging function from a session management function, a request to update or create at least one session management policy association; transmitting, to the session management function, a response to the received request, wherein the response comprises, at least, a correlation identifier assigned to one or more protocol data unit sessions; determining one or more session management policy associations for which new or updated policy and charging rules are required; determining a session management policy association of the one or more session management policy associations associated with the session management function; determining one or more correlation identifiers associated with the session management policy association associated with the session management function; and transmitting, to the session management function, an indication to update one or more protocol data unit sessions, associated with the one or more determined correlation identifiers, with the new or updated policy and charging control rules.

In accordance with one aspect, an apparatus comprising means for: receiving, from a session management function, a request to update or create at least one session management policy association; transmitting, to the session management function, a response to the received request, wherein the response comprises, at least, a correlation identifier assigned to one or more protocol data unit sessions; determining one or more session management policy associations for which new or updated policy and charging control rules are required; determining a session management policy association of the one or more session management policy associations associated with the session management function; determining one or more correlation identifiers associated with the session management policy association associated with the session management function; and transmitting, to the session management function, an indication to update one or more protocol data unit sessions, associated with the one or more determined correlation identifiers, with the new or updated policy and charging control rules.

In accordance with one aspect, a non-transitory computer-readable medium comprising program instructions stored thereon for performing at least the following: causing receiving, from a session management function, of a request to update or create at least one session management policy association; causing transmitting, to the session management function, of a response to the received request, wherein the response comprises, at least, a correlation identifier assigned to one or more protocol data unit sessions; determining r more session management policy associations for which new or updated policy and charging control rules are required; determining a session management policy association of the one or more session management policy associations associated with the session management function; determining one or more correlation identifiers associated with the session management policy association associated with the session management function; and causing transmitting, to the session management function, of an indication to update one or more protocol data unit sessions, associated with the one or more determined correlation identifiers, with the new or updated policy and charging control rules.

In accordance with one aspect, an apparatus comprising: at least one processor; and at least one memory storing instructions that, when executed by the at least one processor, cause the apparatus at least to: transmit, to a policy charging function, a request to update or create at least one session management policy association; receive, from the policy charging function, a response to the transmitted request, wherein the response comprises, at least, a correlation identifier assigned to one or more protocol data unit sessions; receive, from the policy charging function, an indication to update one or more protocol data unit sessions, associated with one or more correlation identifiers, with new or updated policy and charging control rules, wherein the indication comprises, at least, the new or updated policy and charging control rules; and apply the new or updated policy and charging control rules to the one or more protocol data unit sessions.

In accordance with one aspect, a method comprising: transmitting, with a session management function to a policy charging function, a request to update or create at least one session management policy association; receiving, from the policy charging function, a response to the transmitted request, wherein the response comprises, at least, a correlation identifier assigned to one or more protocol data unit sessions; receiving, from the policy charging function, an indication to update one or more protocol data unit sessions, associated with one or more correlation identifiers, with new or updated policy and charging control rules, wherein the indication comprises, at least, the new or updated policy and charging control rules; and applying the new or updated policy and charging control rules to the one or more protocol data unit sessions.

In accordance with one aspect, an apparatus comprising means for: transmitting, to a policy charging function, a request to update or create at least one session management policy association; receiving, from the policy charging function, a response to the transmitted request, wherein the response comprises, at least, a correlation identifier assigned to one or more protocol data unit sessions; receiving, from the policy charging function, an indication to update one or more protocol data unit sessions, associated with one or more correlation identifiers, with new or updated policy and charging control rules, wherein the indication comprises, at least, the new or updated policy and charging control rules; and applying the new or updated policy and charging control rules to the one or more protocol data unit sessions.

In accordance with one aspect, a non-transitory computer-readable medium comprising program instructions stored thereon for performing at least the following: causing transmitting, to a policy charging function, of a request to update or create at least one session management policy association; causing receiving, from the policy charging function, of a response to the transmitted request, wherein the response comprises, at least, a correlation identifier assigned to one or more protocol data unit sessions; causing receiving, from the policy charging function, of an indication to update one or more protocol data unit sessions, associated with one or more correlation identifiers, with new or updated policy and charging control rules, wherein the indication comprises, at least, the new or updated policy and charging control rules; and applying the new or updated policy and charging control rules to the one or more protocol data unit sessions.

In accordance with one aspect, an apparatus comprising: at least one processor; and at least one memory storing instructions that, when executed by the at least one processor, cause the apparatus at least to: receive, from a session management function, at least one request to create a session management policy association, wherein the at least one request comprises at least one of: a protocol data unit session identifier, a user equipment identifier, or a session management function identifier; transmit, to the session management function, a response to the at least one request; receive, from the session management function, a request to create a session management shared policy association for at least one of: a same data network name the apparatus and the session management function serve, or a same network slice selection assistance information the apparatus and the session management function serve; receive, from the session management function, a uniform resource locator at which the session management function can receive updates associated with the session management shared policy association; transmit, to the session management function, an indication of at least one protocol data unit session associated with the session management shared policy association; determine one or more protocol data unit sessions for which new or updated policy and charging control rules are required, and that are associated with session management function; and transmit, to the session management function at the uniform resource locator, an indication to update the one or more protocol data unit sessions with the new or updated policy and charging control rules, wherein the indication comprises, at least, identifiers for the one or more protocol data unit sessions and the new or updated policy and charging control rules.

In accordance with one aspect, a method comprising: receiving, with a policy charging function from a session management function, at least one request to create a session management policy association, wherein the at least one request comprises at least one of: a protocol data unit session identifier, a user equipment identifier, or a session management function identifier; transmitting, to the session management function, a response to the at least one request; receiving, from the session management function, a request to create a session management shared policy association for at least one of: a same data network name the policy charging function and the session management function serve, or a same network slice selection assistance information the policy charging function and the session management function serve; receiving, from the session management function, a uniform resource locator at which the session management function can receive updates associated with the session management shared policy association; transmitting, to the session management function, an indication of at least one protocol data unit session associated with the session management shared policy association; determining one or more protocol data unit sessions for which new or updated policy and charging control rules are required, and that are associated with session management function; and transmitting, to the session management function at the uniform resource locator, an indication to update the one or more protocol data unit sessions with the new or updated policy and charging control rules, wherein the indication comprises, at least, identifiers for the one or more protocol data unit sessions and the new or updated policy and charging control rules.

In accordance with one aspect, an apparatus comprising means for: receiving, from a session management function, at least one request to create a session management policy association, wherein the at least one request comprises at least one of: a protocol data unit session identifier, a user equipment identifier, or a session management function identifier; transmitting, to the session management function, a response to the at least one request; receiving, from the session management function, a request to create a session management shared policy association for at least one of: a same data network name the apparatus and the session management function serve, or a same network slice selection assistance information the apparatus and the session management function serve; receiving, from the session management function, a uniform resource locator at which the session management function can receive updates associated with the session management shared policy association; transmitting, to the session management function, an indication of at least one protocol data unit session associated with the session management shared policy association; determining one or more protocol data unit sessions for which new or updated policy and charging control rules are required, and that are associated with session management function; and transmitting, to the session management function at the uniform resource locator, an indication to update the one or more protocol data unit sessions with the new or updated policy and charging control rules, wherein the indication comprises, at least, identifiers for the one or more protocol data unit sessions and the new or updated policy and charging control rules.

In accordance with one aspect, a non-transitory computer-readable medium comprising program instructions stored thereon for performing at least the following: causing receiving, with a policy charging function from a session management function, of at least one request to create a session management policy association, wherein the at least one request comprises at least one of: a protocol data unit session identifier, a user equipment identifier, or a session management function identifier; causing transmitting, to the session management function, of a response to the at least one request; causing receiving, from the session management function, of a request to create a session management shared policy association for at least one of: a same data network name the policy charging function and the session management function serve, or a same network slice selection assistance information the policy charging function and the session management function serve; causing receiving, from the session management function, of a uniform resource locator at which the session management function can receive updates associated with the session management shared policy association; causing transmitting, to the session management function, of an indication of at least one protocol data unit session associated with the session management shared policy association; determining one or more protocol data unit sessions for which new or updated policy and charging control rules are required, and that are associated with session management function; and causing transmitting, to the session management function at the uniform resource locator, of an indication to update the one or more protocol data unit sessions with the new or updated policy and charging control rules, wherein the indication comprises, at least, identifiers for the one or more protocol data unit sessions and the new or updated policy and charging control rules.

In accordance with one aspect, an apparatus comprising: at least one processor; and at least one memory storing instructions that, when executed by the at least one processor, cause the apparatus at least to: transmit, to a policy charging function, at least one request to create a session management policy association, wherein the at least one request comprises at least one of: a protocol data unit session identifier, a user equipment identifier, or a session management function identifier; receive, from the policy charging function, a response to the at least one request; transmit, to the policy charging function, a request to create session management shared policy association for at least one of: a same data network name the apparatus and the policy charging function serve, or a same network slice selection assistance information the apparatus and the policy charging function serve; transmit, to the policy charging function, a uniform resource locator at which updates associated with the session management shared policy association can be received; receive, from the policy charging function, an indication of at least one protocol data unit session associated with the session management shared policy association; and receive, from the policy charging function at the uniform resource locator, an indication to update one or more protocol data unit sessions with new or updated policy and charging control rules, wherein the indication comprises, at least, identifiers for the one or more protocol data unit sessions and the new or updated policy and charging control rules.

In accordance with one aspect, a method comprising: transmitting, with a session management function to a policy charging function, at least one request to create a session management policy association, wherein the at least one request comprises at least one of: a protocol data unit session identifier, a user equipment identifier, or a session management function identifier; receiving, from the policy charging function, a response to the at least one request; transmitting, to the policy charging function, a request to create session management shared policy association for at least one of: a same data network name the session management function and the policy charging function serve, or a same network slice selection assistance information the session management function and the policy charging function serve; transmitting, to the policy charging function, a uniform resource locator at which updates associated with the session management shared policy association can be received; receiving, from the policy charging function, an indication of at least one protocol data unit session associated with the session management shared policy association; and receiving, from the policy charging function at the uniform resource locator, an indication to update one or more protocol data unit sessions with new or updated policy and charging control rules, wherein the indication comprises, at least, identifiers for the one or more protocol data unit sessions and the new or updated policy and charging control rules.

In accordance with one aspect, an apparatus comprising means for: transmitting, to a policy charging function, at least one request to create a session management policy association, wherein the at least one request comprises at least one of: a protocol data unit session identifier, a user equipment identifier, or a session management function identifier; receiving, from the policy charging function, a response to the at least one request; transmitting, to the policy charging function, a request to create session management shared policy association for at least one of: a same data network name the apparatus and the policy charging function serve, or a same network slice selection assistance information the apparatus and the policy charging function serve; transmitting, to the policy charging function, a uniform resource locator at which updates associated with the session management shared policy association can be received; receiving, from the policy charging function, an indication of at least one protocol data unit session associated with the session management shared policy association; and receiving, from the policy charging function at the uniform resource locator, an indication to update one or more protocol data unit sessions with new or updated policy and charging control rules, wherein the indication comprises, at least, identifiers for the one or more protocol data unit sessions and the new or updated policy and charging control rules.

In accordance with one aspect, a non-transitory computer-readable medium comprising program instructions stored thereon for performing at least the following: causing transmitting, with a session management function to a policy charging function, of at least one request to create a session management policy association, wherein the at least one request comprises at least one of: a protocol data unit session identifier, a user equipment identifier, or a session management function identifier; causing receiving, from the policy charging function, of a response to the at least one request; causing transmitting, to the policy charging function, of a request to create session management shared policy association for at least one of: a same data network name the session management function and the policy charging function serve, or a same network slice selection assistance information the session management function and the policy charging function serve; causing transmitting, to the policy charging function, of a uniform resource locator at which updates associated with the session management shared policy association can be received; causing receiving, from the policy charging function, of an indication of at least one protocol data unit session associated with the session management shared policy association; and causing receiving, from the policy charging function at the uniform resource locator, of an indication to update one or more protocol data unit sessions with new or updated policy and charging control rules, wherein the indication comprises, at least, identifiers for the one or more protocol data unit sessions and the new or updated policy and charging control rules.

In accordance with one aspect, an apparatus comprising: at least one processor; and at least one memory storing instructions that, when executed by the at least one processor, cause the apparatus at least to: determine a reference corresponding to data; provide the reference and the data to a data repository; and provide at least one update to the data in the data repository using the reference.

In accordance with one aspect, a method comprising: determining, with an application function, a reference corresponding to data; providing the reference and the data to a data repository; and providing at least one update to the data in the data repository using the reference.

In accordance with one aspect, an apparatus comprising means for: determining a reference corresponding to data; providing the reference and the data to a data repository; and providing at least one update to the data in the data repository using the reference.

In accordance with one aspect, a non-transitory computer-readable medium comprising program instructions stored thereon for performing at least the following: determining a reference corresponding to data; causing providing of the reference and the data to a data repository; and causing providing of at least one update to the data in the data repository using the reference.

In accordance with one aspect, an apparatus comprising: at least one processor; and at least one memory storing instructions that, when executed by the at least one processor, cause the apparatus at least to: transmit, to a data repository, a request to subscribe to data stored in the data repository; receive, from the data repository, at least one notification of the data; and determine an update to the data based, at least partially, on the at least one notification.

In accordance with one aspect, a method comprising: transmitting, with a session management function to a data repository, a request to subscribe to data stored in the data repository; receiving, from the data repository, at least one notification of the data; and determining an update to the data based, at least partially, on the at least one notification.

In accordance with one aspect, an apparatus comprising means for: transmitting, to a data repository, a request to subscribe to data stored in the data repository; receiving, from the data repository, at least one notification of the data; and determining an update to the data based, at least partially, on the at least one notification.

In accordance with one aspect, a non-transitory computer-readable medium comprising program instructions stored thereon for performing at least the following: causing transmitting, to a data repository, of a request to subscribe to data stored in the data repository; causing receiving, from the data repository, of at least one notification of the data; and determining an update to the data based, at least partially, on the at least one notification.

In accordance with one aspect, an apparatus comprising: at least one processor; and at least one memory storing instructions that, when executed by the at least one processor, cause the apparatus at least to: receive data and a reference corresponding to the data; store the data in association with the reference; receive, from a session management function, a request to subscribe to the stored data; and transmit, to the session management function, at least one notification of the data in response to a determination that the data is authorized.

In accordance with one aspect, a method comprising: receiving, with a unified data repository, data and a reference corresponding to the data; storing the data in association with the reference; receiving, from a session management function, a request to subscribe to the stored data; and transmitting, to the session management function, at least one notification of the data in response to a determination that the data is authorized.

In accordance with one aspect, an apparatus comprising means for: receiving data and a reference corresponding to the data; storing the data in association with the reference; receiving, from a session management function, a request to subscribe to the stored data; and transmitting, to the session management function, at least one notification of the data in response to a determination that the data is authorized.

In accordance with one aspect, a non-transitory computer-readable medium comprising program instructions stored thereon for performing at least the following: causing receiving of data and a reference corresponding to the data; causing storing of the data in association with the reference; causing receiving, from a session management function, of a request to subscribe to the stored data; and causing transmitting, to the session management function, of at least one notification of the data in response to a determination that the data is authorized.

In accordance with one aspect, an apparatus comprising: at least one processor; and at least one memory storing instructions that, when executed by the at least one processor, cause the apparatus at least to: provide an indication that data stored at a data repository is authorized; and transmit, to the data repository, at least one update to the data using a reference stored in association with the data.

In accordance with one aspect, a method comprising: providing, with a policy charging function, an indication that data stored at a data repository is authorized; and transmitting, to the data repository, at least one update to the data using a reference stored in association with the data.

In accordance with one aspect, an apparatus comprising means for: providing an indication that data stored at a data repository is authorized; and transmitting, to the data repository, at least one update to the data using a reference stored in association with the data.

In accordance with one aspect, a non-transitory computer-readable medium comprising program instructions stored thereon for performing at least the following: causing providing of an indication that data stored at a data repository is authorized; and causing transmitting, to the data repository, of at least one update to the data using a reference stored in association with the data.

In accordance with one aspect, an apparatus comprising: at least one processor; and at least one memory storing instructions that, when executed by the at least one processor, cause the apparatus at least to: receive, from a session management function, a request to create a session management shared policy association for at least one of: a same data network name the apparatus and the session management function serve, or a same network slice selection assistance information the apparatus and the session management function serve; receive, from the session management function, a uniform resource locator at which the session management function can receive updates associated with the session management shared policy association; transmit, to the session management function, a response to the request, wherein the response comprises, at least, one or more policy and charging control rules, wherein the one or more policy and charging control rules respectively comprise a reference to a shared structure; receive, from the session management function, at least one request to create a session management policy association for a protocol data unit, wherein the at least one request comprises at least one of: a protocol data unit session identifier, a user equipment identifier, or a session management function identifier; transmit, to the session management function, at least one policy and charging control rule associated with the session management policy association, and at least one reference to the at least one policy and charging control rule in the shared structure; determine one or more protocol data unit sessions for which new or updated policy and charging control rules are required; update the shared structure based on at least one of the one or more determined protocol data unit sessions; and transmit, to the session management function at the uniform resource locator, an indication that the shared structure has been updated.

In accordance with one aspect, a method comprising: receiving, with a policy charging function from a session management function, a request to create a session management shared policy association for at least one of: a same data network name the policy charging function and the session management function serve, or a same network slice selection assistance information the policy charging function and the session management function serve; receiving, from the session management function, a uniform resource locator at which the session management function can receive updates associated with the session management shared policy association; transmitting, to the session management function, a response to the request, wherein the response comprises, at least, one or more policy and charging control rules, wherein the one or more policy and charging control rules respectively comprise a reference to a shared structure; receiving, from the session management function, at least one request to create a session management policy association for a protocol data unit, wherein the at least one request comprises at least one of: a protocol data unit session identifier, a user equipment identifier, or a session management function identifier; transmitting, to the session management function, at least one policy and charging control rule associated with the session management policy association, and at least one reference to the at least one policy and charging control rule in the shared structure; determining one or more protocol data unit sessions for which new or updated policy and charging control rules are required; updating the shared structure based on at least one of the one or more determined protocol data unit sessions; and transmitting, to the session management function at the uniform resource locator, an indication that the shared structure has been updated.

In accordance with one aspect, an apparatus comprising means for: receiving, from a session management function, a request to create a session management shared policy association for at least one of: a same data network name the apparatus and the session management function serve, or a same network slice selection assistance information the apparatus and the session management function serve; receiving, from the session management function, a uniform resource locator at which the session management function can receive updates associated with the session management shared policy association; transmitting, to the session management function, a response to the request, wherein the response comprises, at least, one or more policy and charging control rules, wherein the one or more policy and charging control rules respectively comprise a reference to a shared structure; receiving, from the session management function, at least one request to create a session management policy association for a protocol data unit, wherein the at least one request comprises at least one of: a protocol data unit session identifier, a user equipment identifier, or a session management function identifier; transmitting, to the session management function, at least one policy and charging control rule associated with the session management policy association, and at least one reference to the at least one policy and charging control rule in the shared structure; determining one or more protocol data unit sessions for which new or updated policy and charging control rules are required; updating the shared structure based on at least one of the one or more determined protocol data unit sessions; and transmitting, to the session management function at the uniform resource locator, an indication that the shared structure has been updated.

In accordance with one aspect, a non-transitory computer-readable medium comprising program instructions stored thereon for performing at least the following: causing receiving, with a policy charging function from a session management function, of a request to create a session management shared policy association for at least one of: a same data network name the policy charging function and the session management function serve, or a same network slice selection assistance information the policy charging function and the session management function serve; causing receiving, from the session management function, of a uniform resource locator at which the session management function can receive updates associated with the session management shared policy association; causing transmitting, to the session management function, of a response to the request, wherein the response comprises, at least, one or more policy and charging control rules, wherein the one or more policy and charging control rules respectively comprise a reference to a shared structure; causing receiving, from the session management function, of at least one request to create a session management policy association for a protocol data unit, wherein the at least one request comprises at least one of: a protocol data unit session identifier, a user equipment identifier, or a session management function identifier; causing transmitting, to the session management function, of at least one policy and charging control rule associated with the session management policy association, and at least one reference to the at least one policy and charging control rule in the shared structure; determining one or more protocol data unit sessions for which new or updated policy and charging control rules are required; updating the shared structure based on at least one of the one or more determined protocol data unit sessions; and causing transmitting, to the session management function at the uniform resource locator, of an indication that the shared structure has been updated.

In accordance with one aspect, an apparatus comprising: at least one processor; and at least one memory storing instructions that, when executed by the at least one processor, cause the apparatus at least to: transmit, to a policy charging function, a request to create a session management shared policy association for at least one of: a same data network name the apparatus and the policy charging function serve, or a same network slice selection assistance information the apparatus and the policy charging function serve; transmit, to the policy charging function, a uniform resource locator at which updates associated with the session management shared policy association can be received; receive, from the policy charging function, a response to the request, wherein the response comprises, at least, one or more policy and charging control rules, wherein the one or more policy and charging control rules respectively comprise a reference to a shared structure; transmit, to the policy charging function, at least one request to create a session management policy association for a protocol data unit, wherein the at least one request comprises at least one of: a protocol data unit session identifier, a user equipment identifier, or a session management function identifier; receive, from the policy charging function, at least one policy and charging control rule associated with the session management policy association, and at least one reference to the at least one policy and charging control rule in the shared structure; and receive, from the policy charging function at the uniform resource locator, an indication that the shared structure has been updated.

In accordance with one aspect, a method comprising: transmitting, with a session management function to a policy charging function, a request to create a session management shared policy association for at least one of: a same data network name the session management function and the policy charging function serve, or a same network slice selection assistance information the session management function and the policy charging function serve; transmitting, to the policy charging function, a uniform resource locator at which updates associated with the session management shared policy association can be received; receiving, from the policy charging function, a response to the request, wherein the response comprises, at least, one or more policy and charging control rules, wherein the one or more policy and charging control rules respectively comprise a reference to a shared structure; transmitting, to the policy charging function, at least one request to create a session management policy association for a protocol data unit, wherein the at least one request comprises at least one of: a protocol data unit session identifier, a user equipment identifier, or a session management function identifier; receiving, from the policy charging function, at least one policy and charging control rule associated with the session management policy association, and at least one reference to the at least one policy and charging control rule in the shared structure; and receiving, from the policy charging function at the uniform resource locator, an indication that the shared structure has been updated.

In accordance with one aspect, an apparatus comprising means for: transmitting, to a policy charging function, a request to create a session management shared policy association for at least one of: a same data network name the apparatus and the policy charging function serve, or a same network slice selection assistance information the apparatus and the policy charging function serve; transmitting, to the policy charging function, a uniform resource locator at which updates associated with the session management shared policy association can be received; receiving, from the policy charging function, a response to the request, wherein the response comprises, at least, one or more policy and charging control rules, wherein the one or more policy and charging control rules respectively comprise a reference to a shared structure; transmitting, to the policy charging function, at least one request to create a session management policy association for a protocol data unit, wherein the at least one request comprises at least one of: a protocol data unit session identifier, a user equipment identifier, or a session management function identifier; receiving, from the policy charging function, at least one policy and charging control rule associated with the session management policy association, and at least one reference to the at least one policy and charging control rule in the shared structure; and receiving, from the policy charging function at the uniform resource locator, an indication that the shared structure has been updated.

In accordance with one aspect, a non-transitory computer-readable medium comprising program instructions stored thereon for performing at least the following: causing transmitting, with a session management function to a policy charging function, of a request to create a session management shared policy association for at least one of: a same data network name the session management function and the policy charging function serve, or a same network slice selection assistance information the session management function and the policy charging function serve; causing transmitting, to the policy charging function, of a uniform resource locator at which updates associated with the session management shared policy association can be received; causing receiving, from the policy charging function, of a response to the request, wherein the response comprises, at least, one or more policy and charging control rules, wherein the one or more policy and charging control rules respectively comprise a reference to a shared structure; causing transmitting, to the policy charging function, of at least one request to create a session management policy association for a protocol data unit, wherein the at least one request comprises at least one of: a protocol data unit session identifier, a user equipment identifier, or a session management function identifier; causing receiving, from the policy charging function, of at least one policy and charging control rule associated with the session management policy association, and at least one reference to the at least one policy and charging control rule in the shared structure; and causing receiving, from the policy charging function at the uniform resource locator, of an indication that the shared structure has been updated.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a flowchart illustrating steps as described herein;

FIG. 3 is a flowchart illustrating steps as described herein;

FIG. 4 is a diagram illustrating features as described herein;

FIG. 5 is a flowchart illustrating steps as described herein;

FIG. 6 is a flowchart illustrating steps as described herein;

FIG. 7 is a flowchart illustrating steps as described herein;

FIG. 8 is a flowchart illustrating steps as described herein;

FIG. 9 is a flowchart illustrating steps as described herein;

FIG. 10 is a flowchart illustrating steps as described herein;

FIG. 11 is a flowchart illustrating steps as described herein;

FIG. 12 is a flowchart illustrating steps as described herein;

FIG. 13 is a flowchart illustrating steps as described herein;

FIG. 14 is a flowchart illustrating steps as described herein;

FIG. 15 is a flowchart illustrating steps as described herein;

FIG. 16 is a flowchart illustrating steps as described herein;

FIG. 17 is a flowchart illustrating steps as described herein;

FIG. 18 is a flowchart illustrating steps as described herein;

FIG. 19 is a flowchart illustrating steps as described herein; and

FIG. 20 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
5QI 5G QoS identifier
AF application function
AMF access and mobility management function
ARP allocation and retention priority
CRAN cloud radio access network
CU central unit
DNAI data network access identifier
DNN data network name
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
EPS evolved packet system
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
I/F interface
L1 layer 1
LTE long term evolution
MAC medium access control
MME mobility management entity
N6 5G interface between the UPF and a Data Network
NBI northbound interface
NEF network exposure function
ng or NG new generation
ng-eNB or NG-eNB new generation eNB
NR new radio
NRF Network Repository Function
NSSAI network slice selection assistance information
N/W or NW network
NWDAF network data analytics function
O-RAN open radio access network
PCC policy and charging control
PCEF policy control enforcement function
PCF policy charging function
PCRF policy and charging rules function
PDCP packet data convergence protocol
PDN packet data network
PDU protocol data unit
PFD packet flow description/descriptor
PFDF packet flow description function
PGW PDN gateway
PHY physical layer
QOS quality of service
RAN radio access network
RAR random access response
RF radio frequency
RLC radio link control
RRC radio resource control
RRH remote radio head
RS reference signal
RU radio unit
Rx receiver
SDAP service data adaptation protocol
SGW serving gateway
SM session management
SMF session management function
S-NSSAI single-network slice selection assistance information
TCP transmission control protocol
Tx transmitter
UDP user datagram protocol
UDR unified data repository
UE user equipment (e.g., a wireless, typically mobile device)
UPF user plane function
URL uniform resource locator
VNR virtualized network function

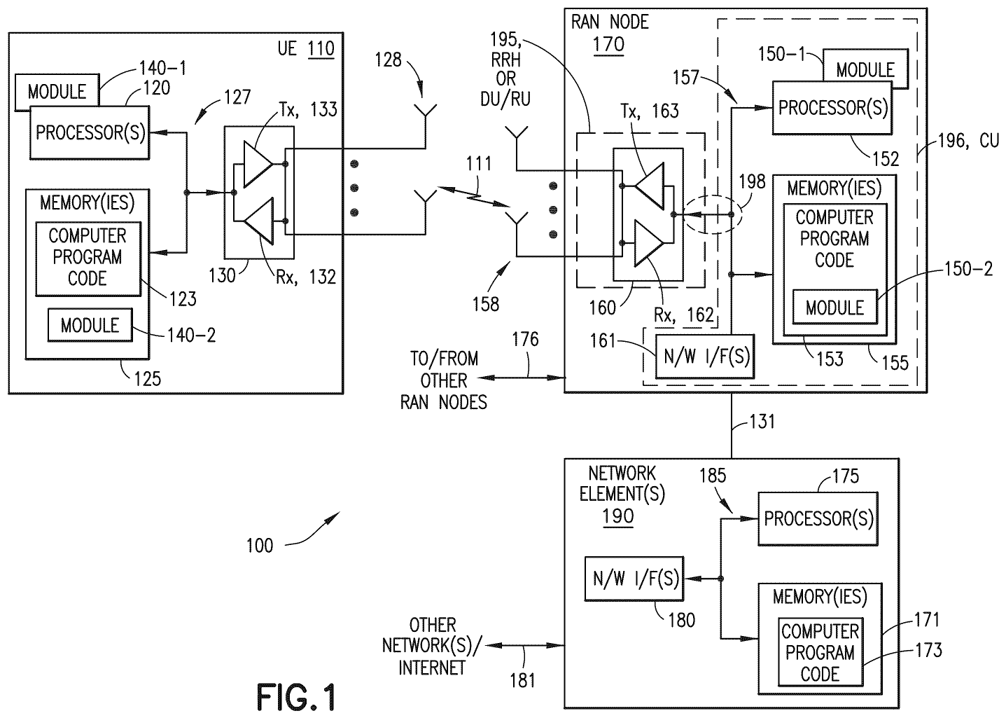

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the qNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein may generally relate to policy and charging control (PCC) rules.

For 5GC, when the policy charging function (PCF) determines that new PCC rules are required for a protocol data unit (PDU) session, for example due to an application function (AF) request, it shall provide them to the session management function (SMF) using the Npcf_SMPolicyControl_UpdateNotify service operation. When the same new PCC rules shall apply for multiple UEs (or multiple PDU sessions of the same UE), the PCF needs to invoke Npcf_SMPolicyControl_UpdateNotify once session per management (SM) policy association, for example once per UE/PDU Session. When the required quality of service (QOS) or QoS monitoring changes for multiple UE IP addresses, the AF and/or network exposure function (NEF) needs to invoke Npcf_PolicyAuthorization_Update request once per UE IP address.

PCC is documented by 3GPP for 5GC in TS 23.503 (stage 2) and (among other specifications) TS 29.512, TS 29.513, TS 29.514 and TS 29.551 (stage 3). A PCC rule is a set of information enabling the detection of a service data flow and providing parameters for policy control and/or charging control and/or other control or support information. The possible information is described in clause 6.3.1 of TS 23.503.

For the evolved packet system (EPS), when the policy and charging rules function (PCRF) determines that new PCC rules are required for a packet data network (PDN) connection, for example due to an AF request, it shall provide them to the packet data network gateway (PGW) and/or policy control enforcement function (PCEF) using a diameter random access response (RAR) message. When the same new PCC rules shall apply for multiple UEs (or multiple PDN connections of the same UE), the PCRF needs to invoke the diameter RAR message once per SM policy association, for example once per UE/PDN connection.

PCC is documented by 3GPP for EPS in TS 23.203 (stage 2) and TS 29.212, TS 29.213, TS 29.214, TS 29.250 and TS 29.251 (stage 3).

A PCC rule contains a description of traffic flows it relates to (e.g. IP source and destination addresses and UDP/TCP source destination port numbers) that may also take the form of an application identifier. The related traffic flow description for the application identifier is then provided from the AF towards the NEF (e.g. packet flow description function (PFDF)) and then towards the SMF as a packet flow description (PFD) without involvement of the PCF. See clause 4.18 of TS 23.502.

Invoking Npcf_SMPolicyControl_UpdateNotify once per SM policy association, for example once per UE/PDU session, may lead to excessive signaling if many UEs/PDU sessions require the same PCC rule update(s) (e.g. updates indicated within the same AF request are applicable to multiple/group of UEs). For example, if the AF request that triggered this update of PCC rules targeted a group identifier corresponding to a group of 1000 UEs, then 1000 separate HTTP messages between the PCF and the SMF will have to be sent. The same excessive signaling problem is applicable for NEF to PCF, in case Nnef_AFsessionWithQoS service with multiple UEs leads to multiple invocations of Npcf_PolicyAuthorization per UE/PDU session.

In an example embodiment, signaling of PCC rules that apply to multiple UEs/PDU sessions may be handled by the same SMF in one single message towards that SMF. The applicability of the PCC rule to multiple policy control session or PDU sessions/UEs may be indicated as part of the PCC rule (i.e. within the PCC rule itself). The applicability of the PCC rule to multiple policy control sessions may be indicated either via a correlation ID that is assigned by the PCF to each related policy control session, or by direction indication of applicable PDU sessions/UEs or policy control session IDs. Optionally, one of the existing policy control sessions may be used to provide such PCC rules. Alternatively, a (dedicated) non-PDU session related policy control session may be used to provide such PCC rules.

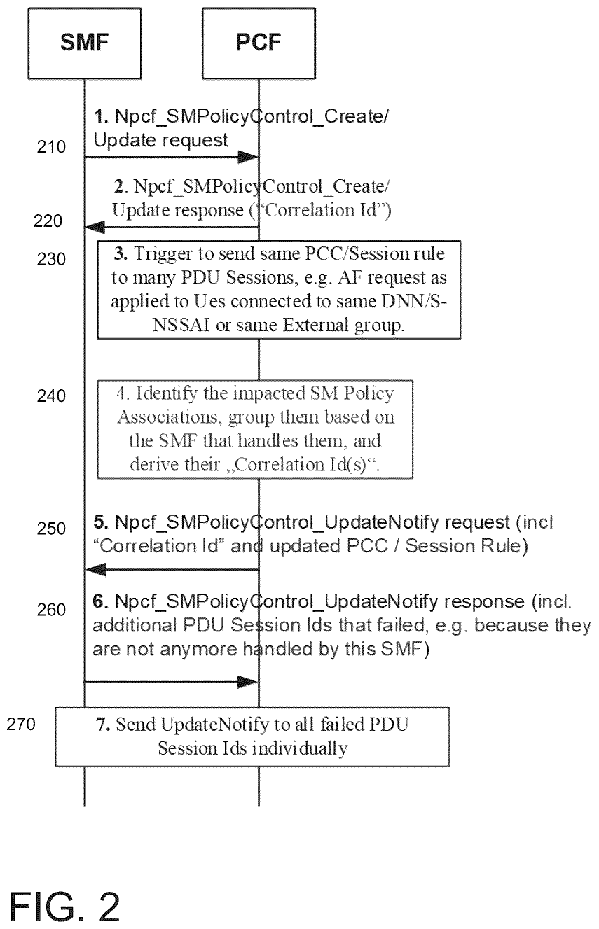

Referring now to FIG. 2, illustrated is an example of implicit indication of additional impacted SM policy associations. At 210, the SMF may create or update an SM policy association with the PCF as described in 3GPP TS 29.513 clause 5.2. For example, the SMF may transmit, to the PCF, a Npcf_SMPolicyControl_Create/Update request. The SMF may create or update an SM policy association multiple times, for example at least once per PDU session. At 220, the PCF may respond to the SM policy association creation/update request. The PCF may also provide one or more correlation identifier(s) in the response. For example, the PCF may transmit, to the SMF, a Npcf_SMPolicyControl_Create/Update response.

In an example, the PCF may provide a mapping of correlation IDs to PDU sessions. For example, the PCF may indicate, to the SMF, that correlation ID 1 is assigned to PDU sessions A, B, C; and correlation ID 2 is assigned to PDU sessions D, E, F. This example is not limiting; a single correlation ID may map to any number of PDU sessions.

The “Correlation Id(s)” may be assigned to be the same for, for example, all the PDU sessions with the same data network name (DNN) and/or single network slice selection assistance information (S-NSSAI) and/or other characteristics (e.g. access type, attributes of the SM policy context provided by the SMF, etc.). Additionally or alternatively, the “Correlation Id(s)” may be assigned to be the same, for example, for all the PDU sessions of UEs identified by a group ID. Additionally or alternatively, the “Correlation Id(s)” may be assigned to be the same for any combination of PDU sessions for which the PCF expects to need “batch” updates, for example based on implementation.

There are various possibilities for implementation-specific “grouping” of the PDU sessions. The PCF may, for example, be configured with information that indicates which AF is responsible for a PDU session. This may be, for example, based on DNN/S-NSSAI, target UE groups, or their combination. For example, the PCF may know that UE groups A, B, and C in slices S1 and S2 are all managed by a same AF, and therefore that AF is likely to send requests for them, so the PCF may assign the same correlation ID to all of those UE groups.

Another example is IP address ranges. The PCF may be configured to know that IPs belonging to a specific address range are given by the SMF to, for example, V2X applications, which may be expected to have similar requirements/requests later, so the PCF may assign the same correlation ID to all PDU sessions that have an IP in that range.

At 230, due to internal PCF logic or due to an external AF request that targets a group of UEs (e.g. Nnef_TrafficInfluence or Nnef_AfSessionWithQoS, see 3GPP TS 29.522), the PCF may be required to install new/updated PCC rules (with the same contents) for multiple PDU sessions (i.e. multiple SM policy associations), or to deinstall/uninstall such PCC rules. In other words, the PCF may detect a trigger, or may determine, to send the same PCC/session rule to many PDU sessions. An example of such a trigger may be an AF request as applied to UEs connected to the same DNN/S-NSSAI or same external group.

An example of internal PCF logic may be based on periodic checking of statistics of network usage and performance (either locally or by contacting the network data analytics function (NWDAF)) and a determination that the PCF should stop authorizing too demanding QoS for PDU sessions of a certain type, or towards certain external networks.

At 240, the PCF may identify the SM policy associations that need to be updated due to the above, and may derive their correlation identifier(s), and may group them based on the SMF that handles them. At 250, the PCF may invoke Npcf_SMPolicyControl_UpdateNotify only once per handling SMF (e.g. each SMF for which at least one correlation ID has been created and for which an update has been triggered) by, for example, including the Correlation Id(s) which indicate that the update is applicable to all the PDU sessions with the given Correlation Id(s). For example, the PCF may transmit, to the SMF, a Npcf_SMPolicyControl_UpdateNotify request, which may include the Correlation ID and updated PCC/session rule. Optionally, the PCF may include an “exception list” that includes the PDU session ID, which was assigned the same “Correlation Id” but may not be applicable (i.e. excluded) for the UpdateNotify request in some rare cases, for example based on an AF request. In other words, the PCF may indicate a PDU session that is associated with a correlation ID, but to which new or updated PCC rules do not apply.

At 260, the SMF may respond to the UpdateNotify request, but may also indicate if there is some failure at one or more of the PDU sessions in applying the requested update. For example, the SMF may transmit, the PCF, a to Npcf_SMPolicyControl_UpdateNotify response, which may include additional PDU session IDs that failed, for example because they are no longer handled by this SMF. Failure may mean that the update of a PDU session was not successful and/or was not performed. At 270, the PCF may attempt to update individually those SM policy associations for which the update failed by sending an UpdateNotify to each of them (e.g. using existing mechanisms).

In an example embodiment, explicit indication of additional impacted SM policy associations may be provided. For example, instead of using Correlation Ids in steps 2 (220), 4 (240), and 5 (250), the PCF may explicitly indicate in step 5 (250) the entire list of impacted PDU sessions (e.g. by including in the UpdateNotify an array of impacted PDU Session Ids). A technical effect of using correlation identifiers may be to avoid having to send an array of, for example, 1000 PDU session Ids. However, using a list of impacted PDU sessions may have the technical effect of being more straightforward and not needing prior creation of correlation IDs nor extensions of the SMPolicyControl_Create/Update response.

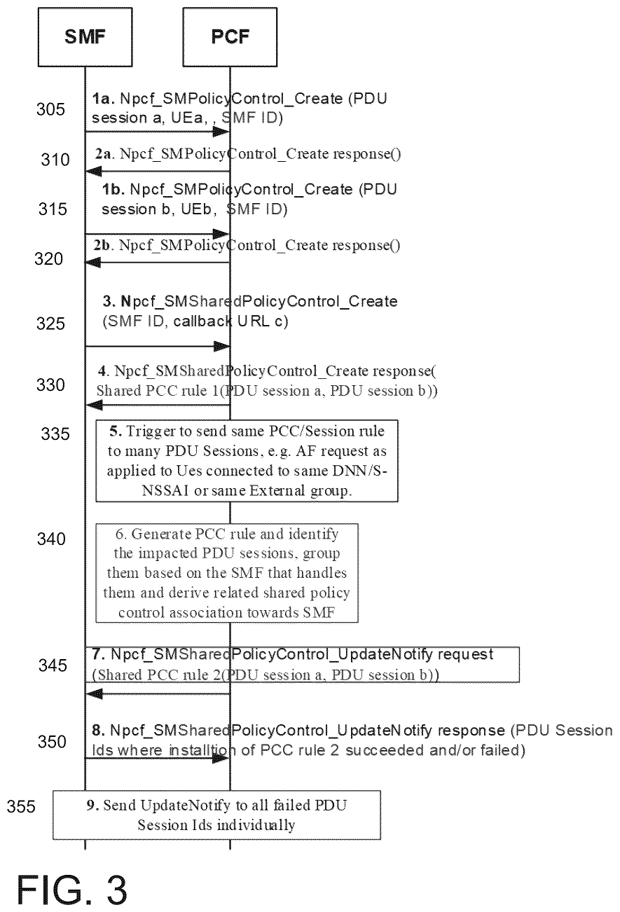

Referring now to FIG. 3, illustrated is an example of explicit indication of impacted PDU sessions through a non-PDU session related policy control session. At 305, 310, 315, 320, for each PDU session, the SMF may create an SM policy association with the PCF as described in 3GPP TS 29.513 clause 5.2. The SMF may create or update an SM policy association multiple times, for example at least once per PDU session. The SMF may provide the PDU session ID and UE ID and its own SMF ID in the request. For each PDU session, the PCF may accept the creation of a SM Policy Association. For example, at 305, 315, the SMF may transmit, to the PCF, a Npcf_SMPolicyControl_Create request, which may include an indication of a PDU session, an indication of a UE, and a SMF ID. At 310, 320, the PCF may transmit, to the SMF, a Npcf_SMPolicyControl_Create response.

At 325, the SMF may detect at the network repository function (NRF) PCF(s) serving DNN/NSSAI that the SMF also serves. For each such PCF, the SMF may create an SM shared policy association (i.e. in the PCF) and provide its own SMF ID and a URL where to receive updates in the request. For example, the SMF may transmit, to the PCF, a Npcf_SMSharedPolicyControl_Create request. Both the SMF and the PCF may be aware of the SM shared policy association and where it is stored. At 330, the PCF may accept the creation of a SM shared policy association (e.g. with respect to 305, 315, or both). It may provide shared PCC rule(s) and then indicate for each shared PCC rule the PDU session(s) and UE ID(s) to which it applies. The PCF may only indicate PDU session(s) and UE ID(s) for which it has established policy associations with the SMF. For example, the PCF may transmit, to the SMF, a Npcf_SMSharedPolicyControl_Create response. At 335, due to internal PCF logic or due to an external AF request that targets a group of UEs (e.g. Nnef_TrafficInfluence or Nnef_AfSessionWithQoS, see 3GPP TS 29.522), the PCF may be required to install new/updated PCC rules (with the same contents) for multiple PDU sessions (i.e. multiple SM policy associations), or to deinstall/uninstall such PCC rules. In other words, the PCF may detect a trigger to send the same PCC/session rule to many PDU sessions. An example of such a trigger may be an AF request as applied to UEs connected to the same DNN/S-NSSAI or same external group. At 340, the PCF may derive and relate shared PCC rules and may identify the SM policy associations and/or PDU sessions and UE IDs for which the shared PCC rule applies (i.e. SM shared policy associations). The PCF may identify the affected SMFs and related shared SM policy associations based on the SMF ID associated with SM policy associations. The PCF may invoke Npcf_SMSharedPolicyControl_UpdateNotify only once per handling SMF (e.g. each SMF for which at least one correlation ID has been created and for which an update has been triggered), and may provide instructions to install, update, or deinstall/uninstall shared PCC rule(s) and indicate, for each installed shared PCC rule, the PDU session(s) and UE ID(s) to which it applies. The PCF may update the shared PCC rules with updated information about applicable PDU sessions and UE IDs, for example PDU sessions and UE IDs to be added and/or to be removed.

At 345, the PCF may transmit, to the SMF, a Npcf_SMSharedPolicyControl_UpdateNotify request. At 350, the SMF may respond to the UpdateNotify request, and optionally indicate PDU session IDs and/or UE IDs for which the PCC rule operation succeeded and/or for which the PCC rule operation failed. For example, the SMF may to PCF, a transmit, the Npcf_SMSharedPolicyControl_UpdateNotify response. At 355, the PCF may attempt to update individually those SM policy associations for which the update failed by sending an UpdateNotify message to each of them (e.g. using existing mechanisms).

In another example embodiment, the PCC rules may contain a reference to a data structure that may be available at the SMF and that may be applicable to PCC rules in many SM policy associations. The reference to the data structure may comprise, for example, a policy fragment identifier. For example, the SMF may have a list of reference/structure pairs (e.g. ref1: QoS1, TrafficSteeringX, ref2: QoS1, TrafficSteeringX, etc.). The PCC rule may contain only the reference. In order to change the QoS of a PCC rule, the PCF may not change the PCC rule at all, but change/update only the data structure that corresponds to, for example, ref1. For example, a fragment of policy or charging information mapped to a policy fragment identifier may be updated within the data structure.

Update of the structure may be independent of the SM policy association, and may indirectly update all PCC rules that reference it (e.g. automatically). Optionally, implicit PCC rule updates may be based on references, where the data structure (with traffic control reference) may be stored in the unified data repository (UDR), and the SMF may fetch the structure from there and/or subscribe to updates (e.g. with respect to part of the structure). Storage in other (network) entities may be possible. Additionally or alternatively, PFDs (e.g. within the UDR) may be extended with additional contents, for example to control the QoS of packet flows. Additionally or alternatively, a non-PDU session related policy control session may be used to provide such data structures from PCF to SMF.

In an example embodiment, for parts of the PCC rule that are frequently AF-influenced (e.g. QoSData and TrafficControlData), a reference may be included in the PCC rule, instead of the detailed values (this option currently does not exist in the PCC rule, see 3GPP TS 29.512). TABLE 1 illustrates a small extract of the example PCC rule definition of 29.512, which may be extended to include gosRef and tcRef. TABLE 1 may comprise an example of implicit PCC rule updates based on references.

TABLE 1

| | Policy control (QoSData) | |
|---|---|---|
| qosRef | Reference to QoSData available | Optional |
| | at the SMF | |
| 5QI | Identifier of the authorized QoS | Mandatory, |
| | parameters for the service data | unless qosRef |
| | flow. | is provided |
| ARP | The Allocation and Retention | Mandatory, |
| | Priority for the service data | unless qosRef |
| | flow consisting of the priority | is provided |
| | level, the pre-emption | |
| | capability and the pre-emption | |
| | vulnerability. | |
| Gate status | The gate status indicates | Optional |
| | whether the service data flow may | |
| | pass (Gate is open) or shall be | |
| | discarded (Gate is closed). | |
| . . . | . . . | . . . |

| | AF influenced Traffic Steering | |
|---|---|---|
| | Enforcement Control | |
| | (TrafficControlData) | |
| tcRef | Reference to TrafficControlData | Optional |
| | available at the SMF | |
| Data Network | Identifier of the target Data | Optional |
| Access | Network Access. | |
| Identifier | | |
| Per DNAI: N6 | Describes the information for | Optional |
| traffic routing | traffic steering to the DNAI. | |
| information | | |
| . . . | . . . | . . . |

Both tcRef and TrafficControlData may be available at the SMF as a pair.

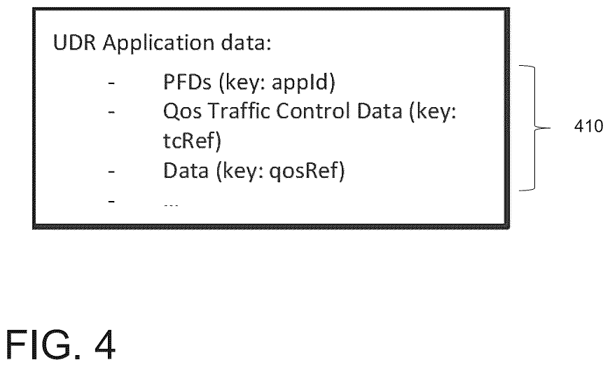

In an example embodiment, new application data may be defined in the UDR and respective northbound interfaces (NBIs) in the NEF, for example in order to allow the AF to change the values that correspond to such references, and allow the SMF to retrieve and subscribe to such data. Referring now to FIG. 4, illustrated is an example of the UDR application data including, at 410, QOS traffic control data (key: tcRef) and data (key: qosRef).

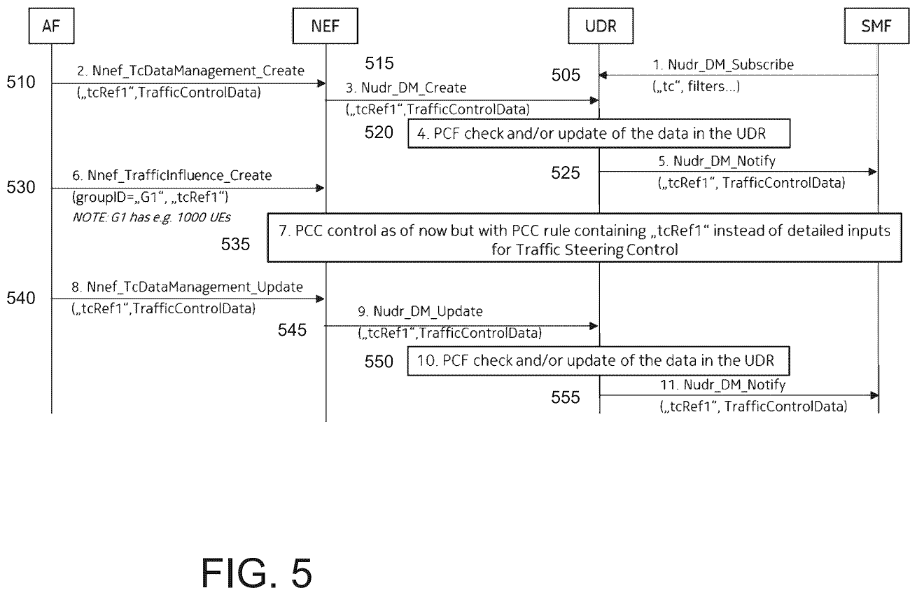

The AF (or the PCF itself) may then update multiple UEs/sessions without any N7 interactions (i.e. without any PCF-SMF signaling). Referring now to FIG. 5, illustrated is an example of implicit PCC rule updates based on references. In an example embodiment, tcRef corresponding to specific traffic control data (e.g. that is part of one or more PCC rules), which are stored in the UDR, may be defined and notified to the SMF based on subscription. This data (i.e. the tcRef to traffic control data association) may be provided either by the AF (step 2 (510)) or directly by the PCF itself (step 4 (520)). When it is provided by the AF, the PCF may check and authorize this data (see step 4 (520)), for example by having subscribed at the UDR to be notified when new entries come from the AF/NEF and then setting an “authorized” flag to “true” after checking. The data may be notified to the SMF (see step 5 (525)) only as soon as the “authorized” flag has been set to true. The checking may involve comparing the requested change and/or data against local policies; if the data does not conform with (e.g. violates) local policies, the data may not be authorized.

At 505, the SMF may transmit, to the UDR, Nudr_DM_Subscribe. At 510, the AF may transmit, to the NEF, Nnef_TcDataManagement_Create. The AF may not be aware of any PCC rules; it may be configured to provide updates to data using a reference. At 515, the NEF may transmit, to the UDR, Nudr_DM_Create. At 520, the PCF may check and/or update the data in the UDR. At 525, the UDR may transmit, to the SMF, Nudr_DM_Notify. One or more PCC rules may be installed on the SMF by the PCF. The SMF may receive notifications regarding data stored at the UDR that is referenced in PCC rules.

In an example embodiment, tcRef may be used as an input to the TrafficInfluence_Create request, for example in order to provision the initial PCC rules that contain the reference. In an example embodiment, only tcRef may be added to the possible inputs of TrafficInfluence_Create in step 6 (530) and to the PCC rules of step 7 (535), but the rest of these steps may be done/performed using existing mechanisms.

At 530, the AF may transmit, to the NEF, Nnef_TrafficInfluence_Create. At 535, the PCC control may comprise a PCC rule containing “tcRef1” instead of detailed inputs for traffic steering control.

In an example embodiment, in order to (implicitly) update the PCC rules, the AF (or the PCF) may simply update (and the PCF may also authorize, as during the creation) in the UDR the traffic control data that corresponds with a given reference. The SMF may be notified about this update, which may mean that no explicit update of the SM policy association may be required (thus avoiding the need for sending e.g. 1000 HTTP requests from the PCF to the SMF).

At 540, the AF may transmit, to the NEF, Nnef_TcDataManagement_Update. At 545, the NEF may transmit, to the UDR, Nudr_DM_Update. At 550, the PCF may check and/or update the data in the UDR. At 555, the UDR may transmit, to the SMF, Nudr_DM_Notify.

In an example embodiment, the provisioning of PFDs may be as defined in TS 23.502, and they may be referenced in the PCC rule via the application ID. The PFD defined in TS 23.503 may include the following information: PFD id; and one or more of the following: 3-tuple(s) including protocol, server side IP address and port number; the significant parts of the URL to be matched, e.g. host name; and/or a domain name matching criteria and information about applicable protocol(s). It may be noted that, based on the agreement between AF and mobile operator, the PFD may be designed to convey proprietary extension(s) for proprietary application traffic detection mechanism(s). It may be noted that how the PFD(s) are used in service flow detection may be specified in clause 6.2.2.2. The PFD defined in TS 23.503 may optionally be extended to include one or more of the following (with the same meaning as defined within PCC rules): 5QI; ARP; gate status; data network access identifier; and/or Per DNAI: N6 traffic routing information.

In an example embodiment, if the same information is provided both in a PCC rule containing the application ID, and in the PFD, the information in the PCC rule may prevail. In an alternative example embodiment, if the same information is provided both in a PCC rule containing the application ID, and in the PFD, the information in the PFD may prevail.

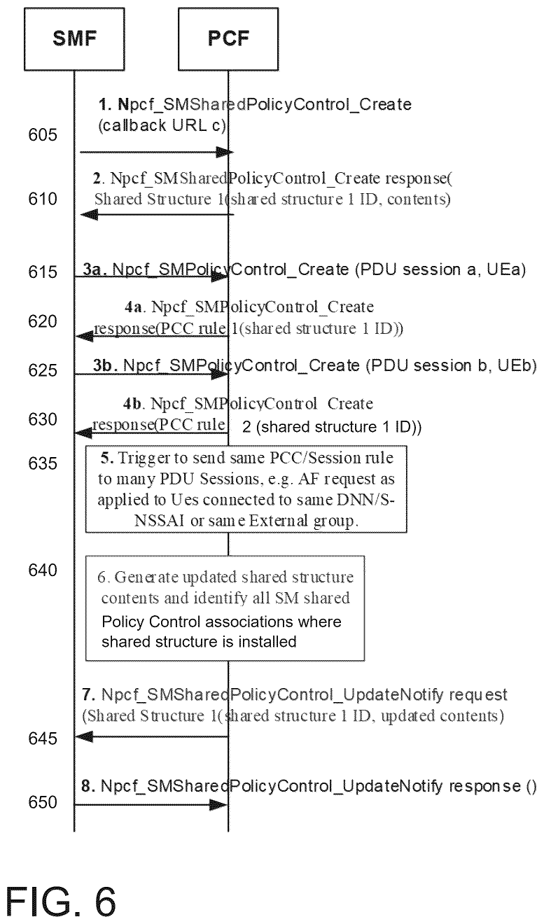

Referring now to FIG. 6, illustrated is an example of implicit PCC rule updates based on references. At 605, the SMF may detect at the NRF PCF(s) serving DNN/NSSAI that the SMF also serves. For each such PCF, the SMF may create a SM shared policy association and provide, in the request, a URL where updates may be received. For example, the SMF may transmit, to the PCF, a Npcf_SMSharedPolicyControl_Create request. At 610, the PCF may accept the creation of a SM shared policy association. It may provide shared structures to describe parts of the contents of PCC rules, each with an ID assigned by the PCF. For example, the PCF may transmit, to the SMF, a Npcf_SMSharedPolicyControl_Create response.

In an example embodiment, the shared structure may, for example, contain the information indicated in TABLE 2:

TABLE 2

| | Policy control (QoSData) | |
|---|---|---|
| 5QI | Identifier of the authorized QoS | Mandatory, |
| | parameters for the service data | unless qosRef |
| | flow. | is provided |
| ARP | The Allocation and Retention | Mandatory, |
| | Priority for the service data flow | unless qosRef |
| | consisting of the priority level, | is provided |
| | the pre-emption capability and the | |
| | pre-emption vulnerability. | |
| Gate status | The gate status indicates whether | Optional |
| | the service data flow may pass | |
| | (Gate is open) or shall be | |
| | discarded (Gate is closed). | |
| . . . | . . . | . . . |

| | AF influenced Traffic Steering | |
|---|---|---|
| | Enforcement Control | |
| | (TrafficControlData) | |
| Data Network | Identifier of the target Data | Optional |
| Access | Network Access. | |
| Identifier | | |
| Per DNAI: N6 | Describes the information for | Optional |
| traffic routing | traffic steering to the DNAI. | |
| information | | |

At 615, 625, for each PDU session, the SMF may create an SM policy association with the PCF, for example as described in 3GPP TS 29.513 clause 5.2. The SMF may provide the PDU session ID and UE ID and its own SMF ID in the request. For example, the SMF may transmit, to the PCF, a Npcf_SMPolicyControl_Create request. At 620, 630, for each PDU session, the PCF may accept the creation of a SM policy association. In the example of FIG. 6, the contents of the PCC rules installed for two PDU sessions may be the same. The PCF may provide PCC rules, and may include reference(s) to shared structure(s) in such PCC rules. For example, the PCF may transmit, to the SMF, a Npcf_SMPolicyControl_Create response, which may include the PCC rule(s). Structures may be associated with the policy association be virtue of the fact that it is referenced by one of the PCC rules provided for this policy association.

At 635, due to internal PCF logic or due to an external AF request that targets a group of UEs (e.g. Nnef_TrafficInfluence or Nnef_AfSessionWithQOS, see 3GPP TS 29.522), the PCF may be required to update PCC rules (with the same contents) for multiple PDU sessions (i.e. multiple SM policy associations). For example, the PCF may detect a trigger to send the same PCC/session rule to many PDU sessions, for example an AF request as applied to UEs connected to a same DNN/S-NSSAI or a same external group. At 640, the PCF may derive related shared structure(s) and the updated contents for those shared structures, and may identify the SM shared policy associations where those shared structures are installed. It may also decide to create new shared structures and install them in all SM shared policy associations. At 645, the PCF may invoke Npcf_SMSharedPolicyControl_UpdateNotify only once per handling SMF and may provide instructions to install, update, or deinstall/uninstall shared structures. If the PCF installs new shared structures, it may also update SM policy associations with PCC rules that reference the new shared structure. If the PCF deinstalls/uninstalls shared structures, it may previously update SM policy associations with PCC rules that reference the shared structure to remove those references. At 650, the SMF may respond to the UpdateNotify request and handle the traffic matching all PCC rules that reference the shared structure according to the updated shared structure instructions. For example, the SMF may transmit, to the PCF, a Npcf_SMSharedPolicyControl_UpdateNotify response.

Example embodiments of the present disclosure may be applicable to Npcf_PolicyAuthorization between AF/NEF to PCF.

Example embodiments of the present disclosure may be applicable for QoS data (e.g. instead of traffic control data), for example replacing tcRef with qosRef, TrafficInfluence_Create with AsSessionWithQoS_Create, etc.

While 5GC terminology is used in the present disclosure, example embodiments of the present disclosure may be applicable to EPC scenarios. Therefore, the PCF may be replaced by PCRF, and the SMF may be replaced by PGW/PCEF. Diameter messages may apply instead of the service operations indicated in the call flows.

In TS 23.502 FIG. 4.15.6.13.3-1, the AF session with required QoS call flow may be updated based on one or more of the example embodiments of the present disclosure where the multiple UE/PDU session with similar QoS update from the AF/NEF may be updated.

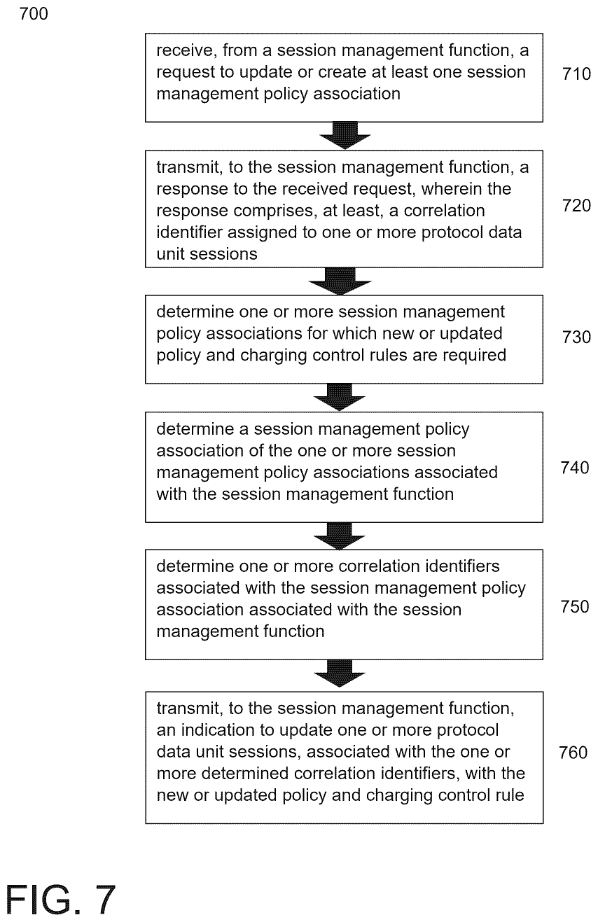

FIG. 7 illustrates the potential steps of an example method 700. The example method 700 may include: receiving, from a session management function, a request to update or create at least one session management policy association, 710; transmitting, to the session management function, a response to the received request, wherein the response comprises, at least, a correlation identifier assigned one or more protocol data unit sessions, 720; determining one or more session management policy associations for which new or updated policy and charging control rules are required, 730; determining a session management policy association of the one or more session management policy associations associated with the session management function, 740; determining one or more correlation identifiers associated with the session management policy association associated with the session management function, 750; and transmitting, to the session management function, an indication to update one or more protocol data unit sessions, associated with the one or more determined correlation identifiers, with the new or updated policy and charging control rules, 760. The example method 700 may be performed, for example, with a PCF.

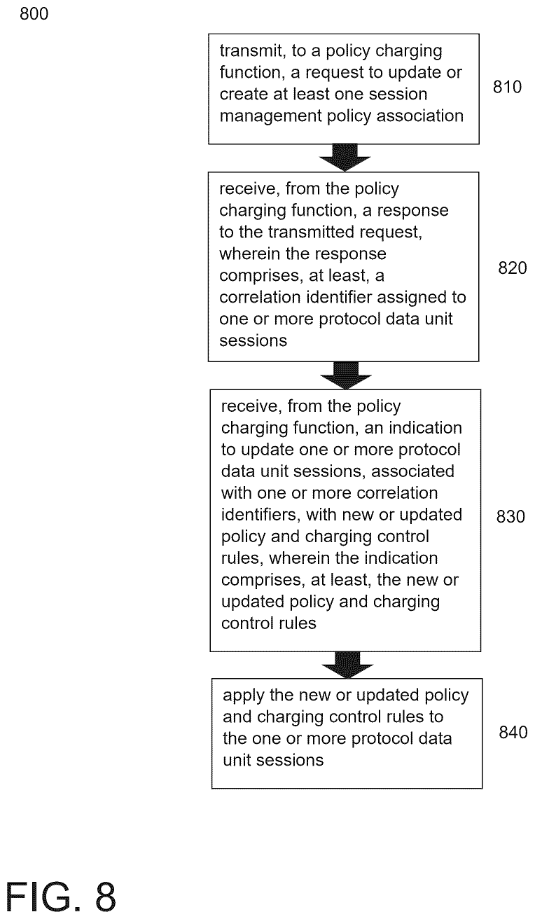

FIG. 8 illustrates the potential steps of an example method 800. The example method 800 may include: transmitting, to a policy charging function, a request to update or create at least one session management policy association, 810; receiving, from the policy charging function, a response to the transmitted request, wherein the response comprises, at least, a correlation identifier assigned to one or more protocol data unit sessions, 820; receiving, from the policy charging function, an indication to update one or more protocol data unit sessions, associated with one or more correlation identifiers, with new or updated policy and charging control rules, wherein the indication comprises, at least, the new or updated policy and charging control rules, 830; and applying the new or updated policy and charging control rules to the one or more protocol data unit sessions, 840. The example method 800 may be performed, for example, with a SMF.

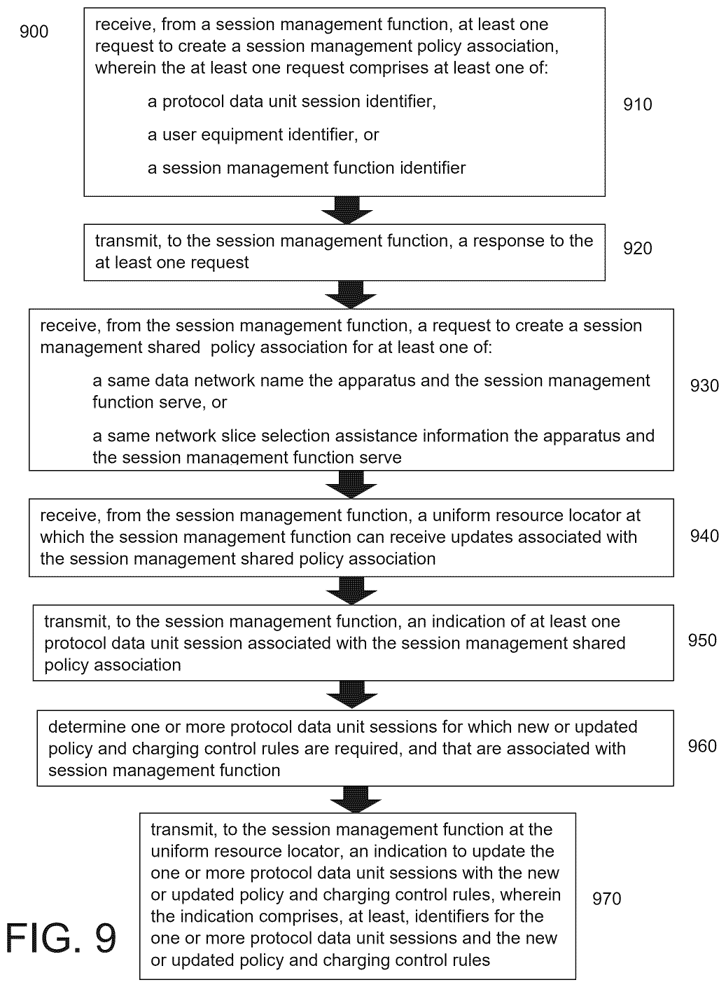

FIG. 9 illustrates the potential steps of an example method 900. The example method 900 may include: receiving, from a session management function, at least one request to create a session management policy association, wherein the at least one request comprises at least one of: a protocol data unit session identifier, a user equipment identifier, or a session management function identifier, 910; transmitting, to the session management function, a response to the at least one request, 920; receiving, from the session management function, a request to create a session management shared policy association for at least one of: a same data network name the apparatus and the session management function serve, or a same network slice selection assistance information the apparatus and the session management function serve, 930; receiving, from the session management function, a uniform resource locator at which the session management function can receive updates associated with the session management shared policy association, 940; transmitting, to the session management function, an indication of at least one protocol data unit session associated with the session management shared policy association, 950; determining one or more protocol data unit sessions for which new or updated policy and charging control rules are required, and that are associated with session management function, 960; and transmitting, to the session management function at the uniform resource locator, an indication to update the one or more protocol data unit sessions with the new or updated policy and charging control rules, wherein the indication comprises, at least, identifiers for the one or more protocol data unit sessions and the new or updated policy and charging control rules, 970. The example method 900 may be performed, for example, with a PCF.

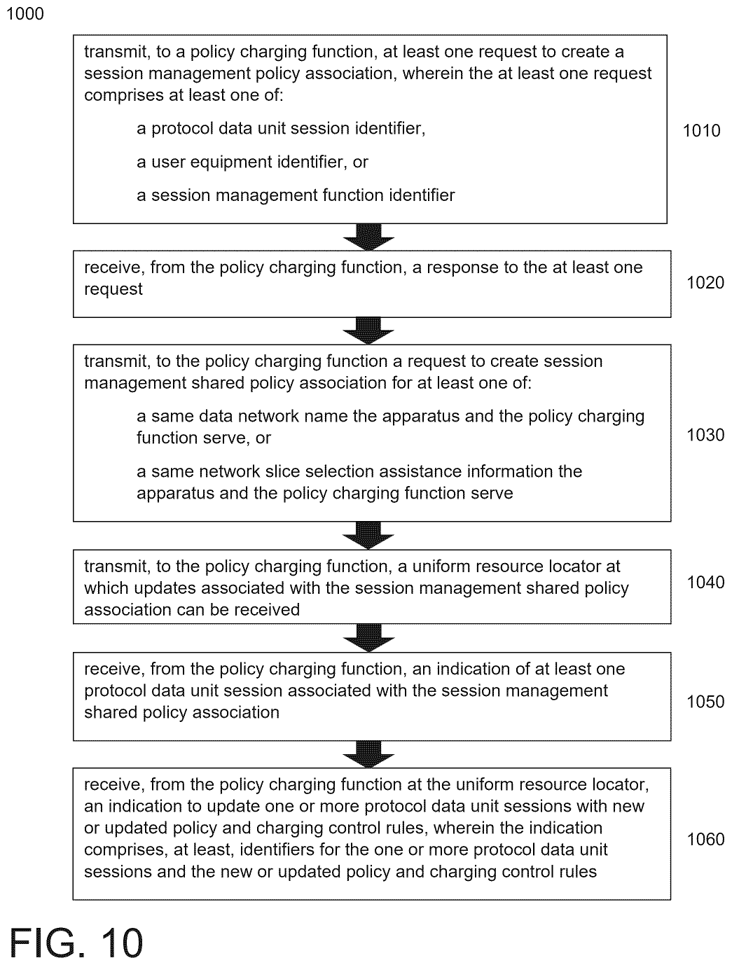

FIG. 10 illustrates the potential steps of an example method 1000. The example method 1000 may include: transmitting, to a policy charging function, at least one request to create a session management policy association, wherein the at least one request comprises at least one of: a protocol data unit session identifier, a user equipment identifier, or a session management function identifier, 1010; receiving, from the policy charging function, a response to the at least one request, 1020; transmitting, to the policy charging function a request to create session management shared policy association for at least one of: a same data network name the apparatus and the policy charging function serve, or a same network slice selection assistance information the apparatus and the policy charging function serve, 1030; transmitting, to the policy charging function, a uniform resource locator at which updates associated with the session management shared policy association can be received, 1040; receiving, from the policy charging function, an indication of at least one protocol data unit session associated with the session management shared policy association, 1050; and receiving, from the policy charging function at the uniform resource locator, an indication to update one or more protocol data unit sessions with new or updated policy and charging control rules, wherein the indication comprises, at least, identifiers for the one or more protocol data unit sessions and the new or updated policy and charging control rules, 1060. The example method 1000 may be performed, for example, with a SMF.

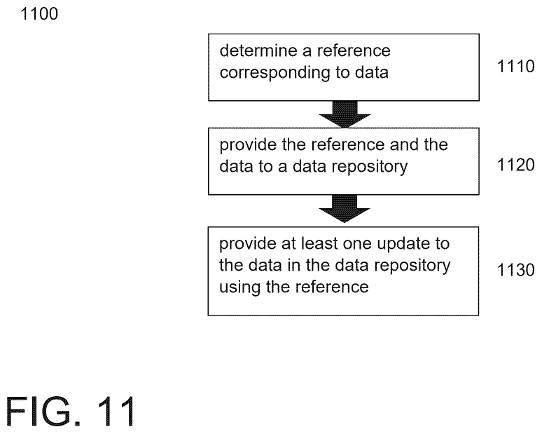

FIG. 11 illustrates the potential steps of an example method 1100. The example method 1100 may include: determining a reference corresponding to data, 1110; providing the reference and the data to a data repository, 1120; and providing at least one update to the data in the data repository using the reference, 1130. The example method 1100 may be performed, for example, with an AF.

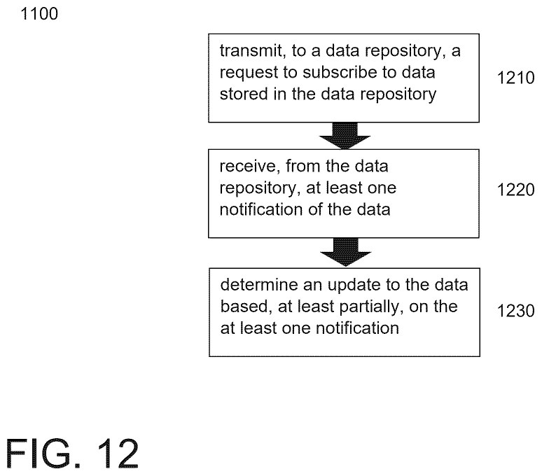

FIG. 12 illustrates the potential steps of an example method 1200. The example method 1200 may include: transmitting, to a data repository, a request to subscribe to data stored in the data repository, 1210; receiving, from the data repository, at least one notification of the data, 1220; and determining an update to the data based, at least partially, on the at least one notification, 1230. The example method 1200 may be performed, for example, with a SMF.

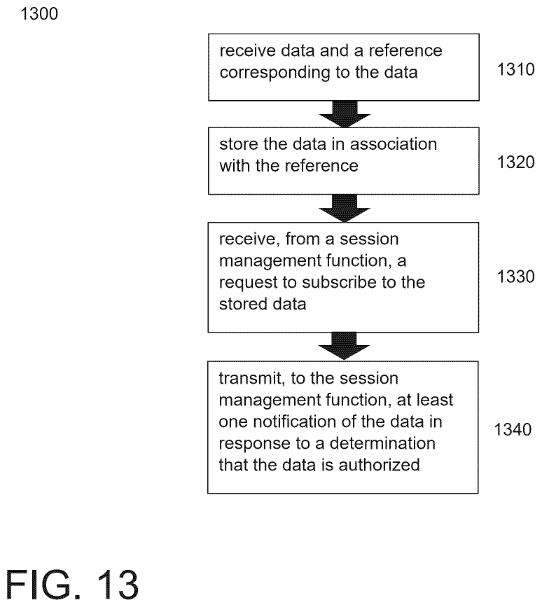

FIG. 13 illustrates the potential steps of an example method 1300. The example method 1300 may include: receiving data and a reference corresponding to the data, 1310; storing the data in association with the reference, 1320; receiving, from a session management function, a request to subscribe to the stored data, 1330; and transmitting, to the session management function, at least one notification of the data in response to a determination that the data is authorized, 1340. The example method 1300 may be performed, for example, with a UDR.

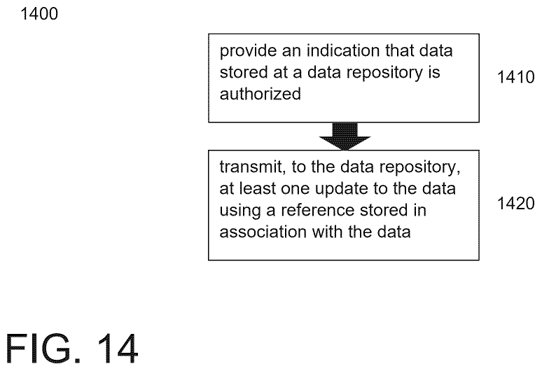

FIG. 14 illustrates the potential steps of an example method 1400. The example method 1400 may include: providing an indication that data stored at a data repository is authorized, 1410; and transmitting, to the data repository, at least one update to the data using a reference stored in association with the data, 1420. The example method 1400 may be performed, for example, with a PCF.

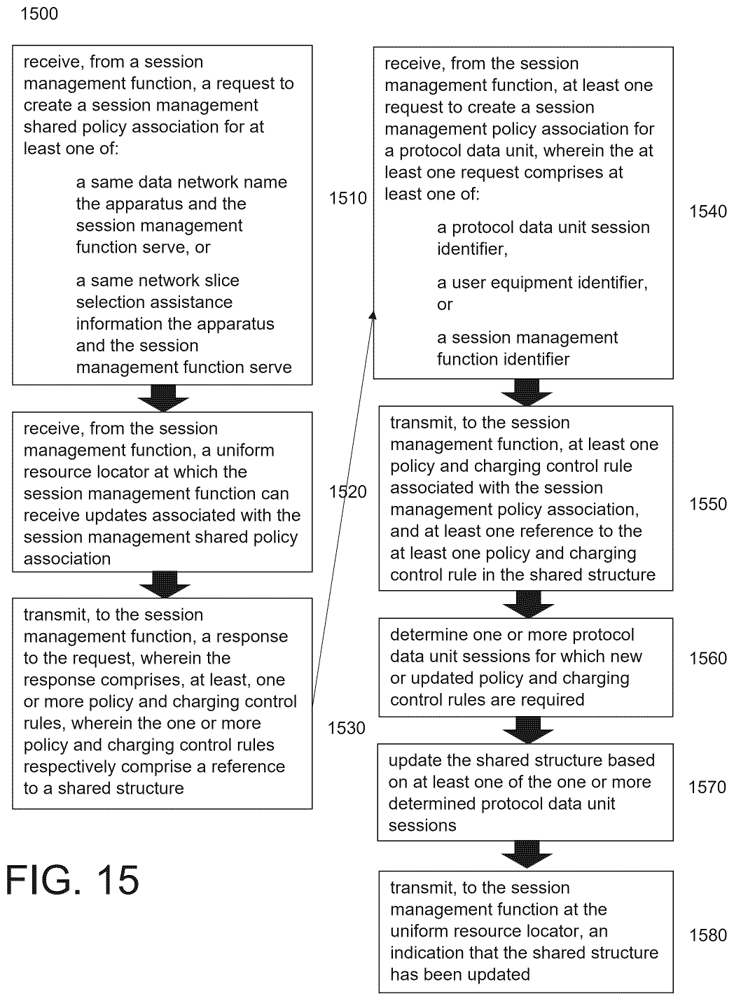

FIG. 15 illustrates the potential steps of an example method 1500. The example method 1500 may include: receiving, from a session management function, a request to create a session management shared policy association for at least one of: a same data network name the apparatus and the session management function serve, or a same network slice selection assistance information the apparatus and the session management function serve, 1510; receiving, from the session management function, a uniform resource locator at which the session management function can receive updates associated with the session management shared policy association, 1520; transmitting, to the session management function, a response to the request, wherein the response comprises, at least, one or more policy and charging control rules, wherein the one or more policy and charging control rules respectively comprise a reference to a shared structure, 1530; receiving, from the session management function, at least one request to create a session management policy association for a protocol data unit, wherein the at least one request comprises at least one of: a protocol data unit session identifier, a user equipment identifier, or a session management function identifier, 1540; transmitting, to the session management function, at least one policy and charging control rule associated with the session management policy association, and at least one reference to the at least one policy and charging control rule in the shared structure, 1550; determining one or more protocol data unit sessions for which new or updated policy and charging control rules are required, 1560; updating the shared structure based on at least one of the one or more determined protocol data unit sessions, 1570; and transmitting, to the session management function at the uniform resource locator, an indication that the shared structure has been updated, 1580. The example method 1500 may be performed, for example, with a PCF.

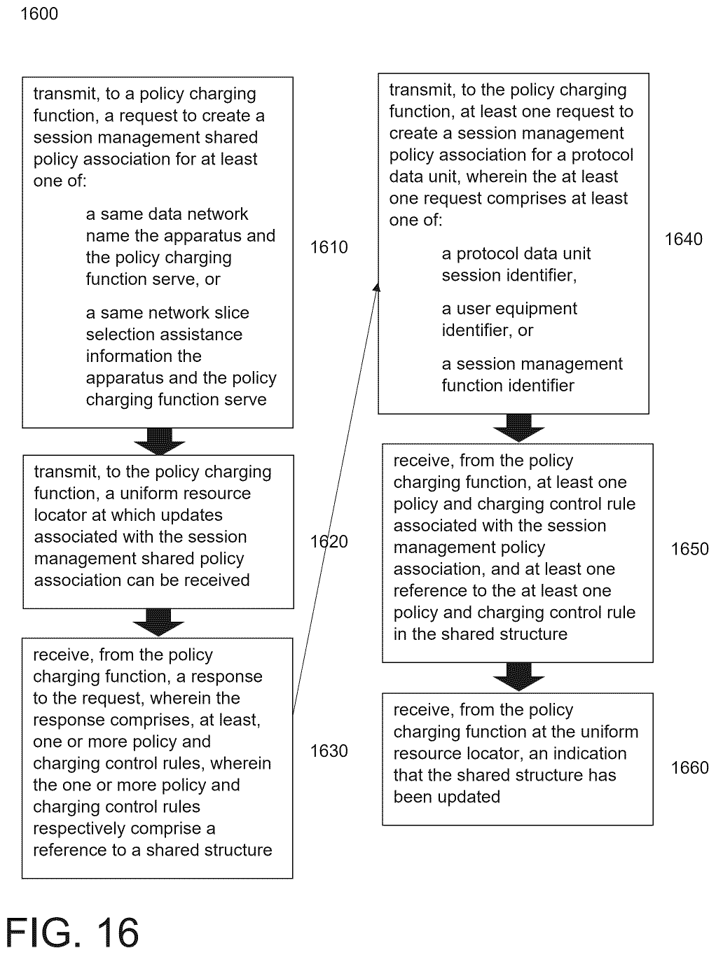

FIG. 16 illustrates the potential steps of an example method 1600. The example method 1600 may include: transmitting, to a policy charging function, a request to create a session management shared policy association for at least one of: a same data network name the apparatus and the policy charging function serve, or a same network slice selection assistance information the apparatus and the policy charging function serve, 1610; transmitting, to the policy charging function, a uniform resource locator at which updates associated with the session management shared policy association can be received, 1620; receiving, from the policy charging function, a response to the request, wherein the response comprises, at least, one or more policy and charging control rules, wherein the one or more policy and charging control rules respectively comprise a reference to a shared structure, 1630; transmitting, to the policy charging function, at least one request to create a session management policy association for a protocol data unit, wherein the at least one request comprises at least one of: a protocol data unit session identifier, a user equipment identifier, or a session management function identifier, 1640; receiving, from the policy charging function, at least one policy and charging control rule associated with the session management policy association, and at least one reference to the at least one policy and charging control rule in the shared structure, 1650; and receiving, from the policy charging function at the uniform resource locator, an indication that the shared structure has been updated, 1660. The example method 1600 may be performed, for example, with a SMF.

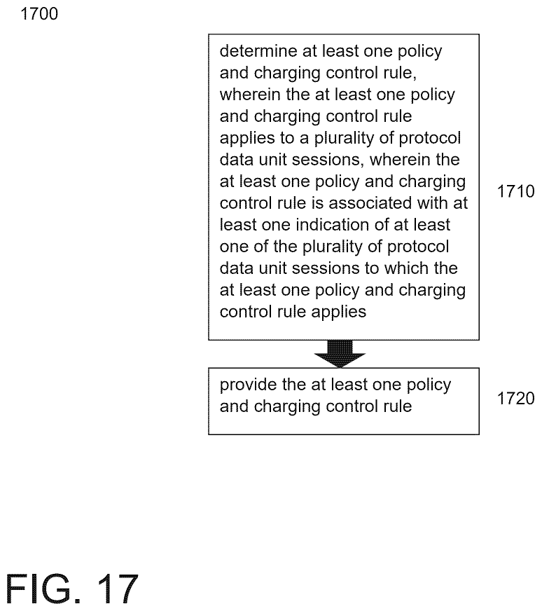

FIG. 17 illustrates the potential steps of an example method 1700. The example method 1700 may include: determining at least one policy and charging control rule, wherein the at least one policy and charging control rule applies to a plurality of protocol data unit sessions, wherein the at least one policy and charging control rule is associated with at least one indication of at least one of the plurality of protocol data unit sessions to which the at least one policy and charging control rule applies, 1710; and providing the at least one policy and charging control rule, 1720. The example method 1700 may be performed, for example, with a PCF.

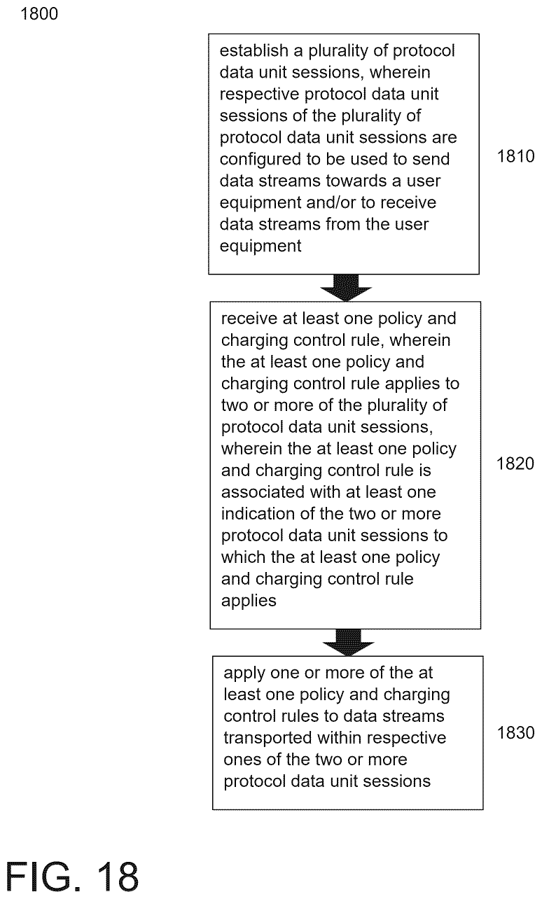

FIG. 18 illustrates the potential steps of an example method 1800. The example method 1800 may include: establishing a plurality of protocol data unit sessions, wherein respective protocol data unit sessions of the plurality of protocol data unit sessions are configured to be used to send data streams towards a user equipment and/or to receive data streams from the user equipment, 1810; receiving at least one policy and charging control rule, wherein the at least one policy and charging control rule applies to two or more of the plurality of protocol data unit sessions, wherein the at least one policy and charging control rule is associated with at least one indication of the two or more protocol data unit sessions to which the at least one policy and charging control rule applies, 1820; and applying one or more of the at least one policy and charging control rules to data streams transported within respective ones of the two or more protocol data unit sessions, 1830. The example method 1800 may be performed, for example, with a SMF.

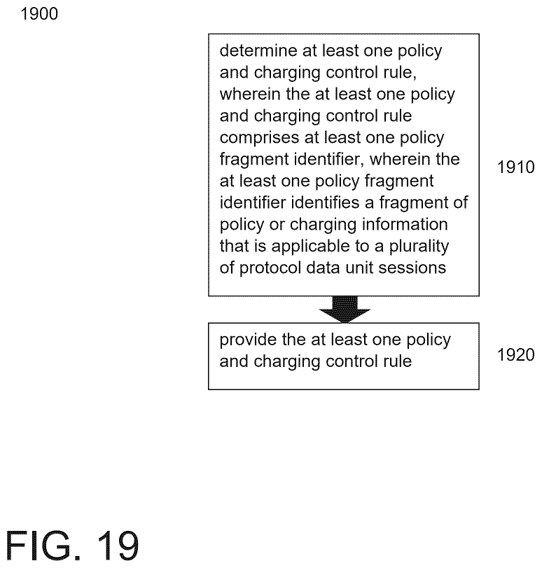

FIG. 19 illustrates the potential steps of an example method 1900. The example method 1900 may include: determining at least one policy and charging control rule, wherein the at least one policy and charging control rule comprises at least one policy fragment identifier, wherein the at least one policy fragment identifier identifies a fragment of policy or charging information that is applicable to a plurality of protocol data unit sessions, 1910; and providing the at least one policy and charging control rule, 1920. The example method 1900 may be performed, for example, with a PCF.

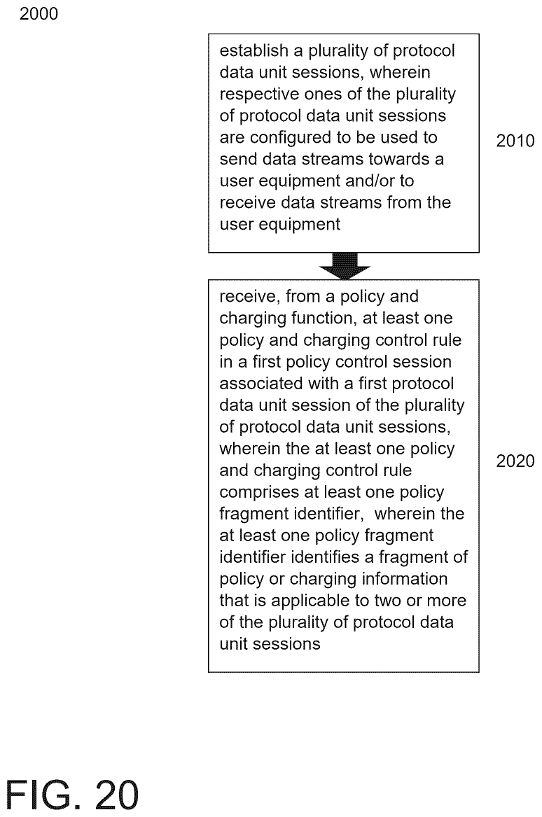

FIG. 20 illustrates the potential steps of an example method 2000. The example method 2000 may include: establishing a plurality of protocol data unit sessions, wherein respective ones of the plurality of protocol data unit sessions are configured to be used to send data streams towards a user equipment and/or to receive data streams from the user equipment, 2010; and receiving, from a policy and charging function, at least one policy and charging control rule in a first policy control session associated with a first protocol data unit session of the plurality of protocol data unit sessions, wherein the at least one policy and charging control rule comprises at least one policy fragment identifier, wherein the at least one policy fragment identifier identifies a fragment of policy or charging information that is applicable to two or more of the plurality of protocol data unit sessions, 2020. The example method 2000 may be performed, for example, with a SMF.

In accordance with one example embodiment, an apparatus may comprise: at least one processor; and at least one memory storing instructions that, when executed by the at least one processor, cause the apparatus at least to: determine at least one policy and charging control rule, wherein the at least one policy and charging control rule may apply to a plurality of protocol data unit sessions, wherein the at least one policy and charging control rule may be associated with at least one indication of at least one of the plurality of protocol data unit sessions to which the at least one policy and charging control rule applies; and provide the at least one policy and charging control rule.

The at least one indication of the at least one of the plurality of protocol data unit sessions to which the at least one policy and charging control rule applies may comprise at least one of: a protocol data unit session identifier, an identifier of a user equipment using the at least one protocol data unit session, an identifier of a policy control session, wherein the policy control session may be associated with the at least one protocol data unit session, a correlation identifier assigned to at least one policy control session, wherein respective ones of the at least one policy control session may be associated with the at least one protocol data unit session, an identifier of a data network name used for the at least one protocol data unit session, or an identifier of a slice used for the at least one protocol data unit session.

The example apparatus may be further configured to: receive a request to establish the policy control session associated with the at least one protocol data unit session; assign the correlation identifier to the at least one policy control session; and provide a response to the request to establish the policy control session, wherein the response may comprise, at least, the correlation identifier.

The example apparatus may be further configured to: provide the at least one policy and charging control rule within a policy control session associated with the at least one protocol data unit session.

The example apparatus may be further configured to: provide the at least one policy and charging control rule within a policy control session that is not associated with the at least one protocol data unit session.

The example apparatus may be further configured to: provide an update to the at least one policy and charging control rule, wherein the update may comprise at least one of: a protocol data unit session identifier to which the update applies, an identifier of a user equipment using the at least one protocol data unit session to which the update applies, an identifier of a policy control session, wherein the policy control session may be associated with the at least one protocol data unit session to which the update applies, a correlation identifier assigned to at least one policy control session, wherein respective ones of the at least one policy control session may be associated with the at least one protocol data unit session to which the update applies, an identifier of a data network name used for the at least one protocol data unit session to which the update applies, or an identifier of a slice used for the at least one protocol data unit session to which the update applies.

The plurality of protocol data unit sessions may be associated with at least one of: a same data network name, a same single-network slice selection assistance information, a group identifier for a group user of equipments, or a common characteristic.

In accordance with one aspect, an example method may be provided comprising: determining, with a policy charging function, at least one policy and charging control rule, wherein the at least one policy and charging control rule may apply to a plurality of protocol data unit sessions, wherein the at least one policy and charging control rule may be associated with at least one indication of at least one of the plurality of protocol data unit sessions to which the at least one policy and charging control rule applies; and providing the at least one policy and charging control rule.

The at least one indication of the at least one of the plurality of protocol data unit sessions to which the at least one policy and charging control rule applies may comprise at least one of: a protocol data unit session identifier, an identifier of a user equipment using the at least one protocol data unit session, an identifier of a policy control session, wherein the policy control session may be associated with the at least one protocol data unit session, a correlation identifier assigned to at least one policy control session, wherein respective ones of the at least one policy control session may be associated with the at least one protocol data unit session, an identifier of a data network name used for the at least one protocol data unit session, or an identifier of a slice used for the at least one protocol data unit session.

The example method may further comprise: receiving a request to establish the policy control session associated with the at least one protocol data unit session; assigning the correlation identifier to the at least one policy control session; and providing a response to the request to establish the policy control session, wherein the response may comprise, at least, the correlation identifier.

The example method may further comprise: providing the at least one policy and charging control rule within a policy control session associated with the at least one protocol data unit session.

The example method may further comprise: providing the at least one policy and charging control rule within a policy control session that is not associated with the at least one protocol data unit session.

The example method may further comprise: providing an update to the at least one policy and charging control rule, wherein the update may comprise at least one of: a protocol data unit session identifier to which the update applies, an identifier of a user equipment using the at least one protocol data unit session to which the update applies, an identifier of a policy control session, wherein the policy control session may be associated with the at least one protocol data unit session to which the update applies, a correlation identifier assigned to at least one policy control session, wherein respective ones of the at least one policy control session may be associated with the at least one protocol data unit session to which the update applies, an identifier of a data network name used for the at least one protocol data unit session to which the update applies, or an identifier of a slice used for the at least one protocol data unit session to which the update applies.

The plurality of protocol data unit sessions may be associated with at least one of: a same data network name, a same single-network slice selection assistance information, a group identifier for a group of user equipments, or a common characteristic.

In accordance with one example embodiment, an apparatus may comprise: circuitry configured to perform: determining at least one policy and charging control rule, wherein the at least one policy and charging control rule may apply to a plurality of protocol data unit sessions, wherein the at least one policy and charging control rule may be associated with at least one indication of at least one of the plurality of protocol data unit sessions to which the at least one policy and charging control rule applies; and circuitry configured to perform: providing the at least one policy and charging control rule.

In accordance with one example embodiment, an apparatus may comprise: processing circuitry; memory circuitry including computer program code, the memory circuitry and the computer program code configured to, with the processing circuitry, enable the apparatus to: determine at least one policy and charging control rule, wherein the at least one policy and charging control rule may apply to a plurality of protocol data unit sessions, wherein the at least one policy and charging control rule may be associated with at least one indication of at least one of the plurality of protocol data unit sessions to which the at least one policy and charging control rule applies; and provide the at least one policy and charging control rule.

As used in this application, the term “circuitry” or “means” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for: determining at least one policy and charging control rule, wherein the at least one policy and charging control rule may apply to a plurality of protocol data unit sessions, wherein the at least one policy and charging control rule may be associated with at least one indication of at least one of the plurality of protocol data unit sessions to which the at least one policy and charging control rule applies; and providing the at least one policy and charging control rule.

The at least one indication of the at least one of the plurality of protocol data unit sessions to which the at least one policy and charging control rule applies may comprise at least one of: a protocol data unit session identifier, an identifier of a user equipment using the at least one protocol data unit session, an identifier of a policy control session, wherein the policy control session may be associated with the at least one protocol data unit session, a correlation identifier assigned to at least one policy control session, wherein respective ones of the at least one policy control session may be associated with the at least one protocol data unit session, an identifier of a data network name used for the at least one protocol data unit session, or an identifier of a slice used for the at least one protocol data unit session.

The means may be further configured for: receiving a request to establish the policy control session associated with the at least one protocol data unit session; assigning the correlation identifier to the at least one policy control session; and providing a response to the request to establish the policy control session, wherein the response may comprise, at least, the correlation identifier.

The means may be further configured for: providing the at least one policy and charging control rule within a policy control session associated with the at least one protocol data unit session.

The means may be further configured for: providing the at least one policy and charging control rule within a policy control session that is not associated with the at least one protocol data unit session.

The means may be further configured for: providing an update to the at least one policy and charging control rule, wherein the update may comprise at least one of: a protocol data unit session identifier to which the update applies, an identifier of a user equipment using the at least one protocol data unit session to which the update applies, an identifier of a policy control session, wherein the policy control session may be associated with the at least one protocol data unit session to which the update applies, a correlation identifier assigned to at least one policy control session, wherein respective ones of the at least one policy control session may be associated with the at least one protocol data unit session to which the update applies, an identifier of a data network name used for the at least one protocol data unit session to which the update applies, or an identifier of a slice used for the at least one protocol data unit session to which the update applies.

The plurality of protocol data unit sessions may be associated with at least one of: a same data network name, a same single-network slice selection assistance information, a group identifier for a group of user equipments, or a common characteristic.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: determine at least one policy and charging control rule, wherein the at least one policy and charging control rule may apply to a plurality of protocol data unit sessions, wherein the at least one policy and charging control rule may be associated with at least one indication of at least one of the plurality of protocol data unit sessions to which the at least one policy and charging control rule applies; and cause providing of the at least one policy and charging control rule.

In accordance with one example embodiment, a non-transitory computer-readable medium comprising program instructions stored thereon for performing at least the following: determining at least one policy and charging control rule, wherein the at least one policy and charging control rule may apply to a plurality of protocol data unit sessions, wherein the at least one policy and charging control rule may be associated with at least one indication of at least one of the plurality of protocol data unit sessions to which the at least one policy and charging control rule applies; and causing providing of the at least one policy and charging control rule.

In accordance with another example embodiment, a non-transitory program storage device readable by a machine may be provided, tangibly embodying instructions executable by the machine for performing operations, the operations comprising: determining at least one policy and charging control rule, wherein the at least one policy and charging control rule may apply to a plurality of protocol data unit sessions, wherein the at least one policy and charging control rule may be associated with at least one indication of at least one of the plurality of protocol data unit sessions to which the at least one policy and charging control rule applies; and causing providing of the at least one policy and charging control rule.

In accordance with another example embodiment, a non-transitory computer-readable medium comprising instructions that, when executed by an apparatus, cause the apparatus to perform at least the following: determining at least one policy and charging control rule, wherein the at least one policy and charging control rule may apply to a plurality of protocol data unit sessions, wherein the at least one policy and charging control rule may be associated with at least one indication of at least one of the plurality of protocol data unit sessions to which the at least one policy and charging control rule applies; and causing providing of the at least one policy and charging control rule.

A computer implemented system comprising: at least one processor and at least one non-transitory memory storing instructions that, when executed by the at least one processor, cause the system at least to perform: determining at least one policy and charging control rule, wherein the at least one policy and charging control rule may apply to a plurality of protocol data unit sessions, wherein the at least one policy and charging control rule may be associated with at least one indication of at least one of the plurality of protocol data unit sessions to which the at least one policy and charging control rule applies; and causing providing of the at least one policy and charging control rule.

A computer implemented system comprising: means for determining at least one policy and charging control rule, wherein the at least one policy and charging control rule may apply to a plurality of protocol data unit sessions, wherein the at least one policy and charging control rule may be associated with at least one indication of at least one of the plurality of protocol data unit sessions to which the at least one policy and charging control rule applies; and means for causing providing of the at least one policy and charging control rule.

In accordance with one example embodiment, an apparatus may comprise: at least one processor; and at least one memory storing instructions that, when executed by the at least one processor, cause the apparatus at least to: establish a plurality of protocol data unit sessions, wherein respective protocol data unit sessions of the plurality of protocol data unit sessions may be configured to be used to send data streams towards a user equipment and/or to receive data streams from the user equipment; receive at least one policy and charging control rule, wherein the at least one policy and charging control rule may apply to two or more of the plurality of protocol data unit sessions, wherein the at least one policy and charging control rule may be associated with at least one indication of the two or more protocol data unit sessions to which the at least one policy and charging control rule applies; and apply one or more of the at least one policy and charging control rules to data streams transported within respective ones of the two or more protocol data unit sessions.

The at least one indication of the two or more protocol data unit sessions to which the at least one policy and charging control rule applies may comprise at least one of: a protocol data unit session identifier, an identifier of a user equipment using the two or more protocol data unit sessions, an identifier of a policy control session, wherein the policy control session may be associated with the two or more protocol data unit sessions, a correlation identifier assigned to at least one policy control session, wherein respective ones of the at least one policy control session may be associated with the two or more protocol data unit sessions, an identifier of a data network name used for the two or more protocol data unit sessions, or an identifier of a slice used for the two or more protocol data unit sessions.

The example apparatus may be further configured to: transmit a request to establish a policy control session associated with at least one protocol data unit session; and receive a response to the request to establish the policy control session, wherein the response may contain the correlation identifier.

The example apparatus may be further configured to: receive the at least one policy and charging control rule within a policy control session associated with one of the two or more protocol data unit sessions.

The example apparatus may be further configured to: receive the at least one policy and charging control rule within a policy control session that is not associated with the two or more protocol data unit sessions.

The example apparatus may be further configured to: provide an update to the at least one policy and charging control rule, wherein the update may comprise at least one of: a protocol data unit session identifier associated with the update, an identifier of a user equipment using the two or more protocol data unit sessions associated with the update, an identifier of a policy control session, wherein the policy control session may be associated with the two or more protocol data unit sessions associated with the update, a correlation identifier assigned to at least one policy control session, wherein respective ones of the at least one policy control session may be associated with the two or more protocol data unit sessions associated with the update, an identifier of a data network name used for the two or more protocol data unit sessions associated with the update, or an identifier of a slice used for the two or more protocol data unit sessions associated with the update.

The plurality of protocol data unit sessions may be associated with at least one of: a same data network name, a same single-network slice selection assistance information, a group identifier for a group of user equipments, or a common characteristic.

In accordance with one aspect, an example method may be provided comprising: establishing, with a session management function, a plurality of protocol data unit sessions, wherein respective protocol data unit sessions of the plurality of protocol data unit sessions may be configured to be used to send data streams towards a user equipment and/or to receive data streams from the user equipment; receiving at least one policy and charging control rule, wherein the at least one policy and charging control rule may apply to two or more of the plurality of protocol data unit sessions, wherein the at least one policy and charging control rule may be associated with at least one indication of the two or more protocol data unit sessions to which the at least one policy and charging control rule applies; and applying one or more of the at least one policy and charging control rules to data streams transported within respective ones of the two or more protocol data unit sessions.

The at least one indication of the two or more protocol data unit sessions to which the at least one policy and charging control rule applies may comprise at least one of: a protocol data unit session identifier, an identifier of a user equipment using the two or more protocol data unit sessions, an identifier of a policy control session, wherein the policy control session may be associated with the two or more protocol data unit sessions, a correlation identifier assigned to at least one policy control session, wherein respective ones of the at least one policy control session may be associated with the two or more protocol data unit sessions, an identifier of a data network name used for the two or more protocol data unit sessions, or an identifier of a slice used for the two or more protocol data unit sessions.

The example method may further comprise: transmitting a request to establish a policy control session associated with at least one protocol data unit session; and receiving a response to the request to establish the policy control session, wherein the response may contain the correlation identifier.

The example method may further comprise: receiving the at least one policy and charging control rule within a policy control session associated with one of the two or more protocol data unit sessions.

The example method may further comprise: receiving the at least one policy and charging control rule within a policy control session that is not associated with the two or more protocol data unit sessions.

The example method may further comprise: providing an update to the at least one policy and charging control rule, wherein the update may comprise at least one of: a protocol data unit session identifier associated with the update, an identifier of a user equipment using the two or more protocol data unit sessions associated with the update, an identifier of a policy control session, wherein the policy control session may be associated with the two or more protocol data unit sessions associated with the update, a correlation identifier assigned to at least one policy control session, wherein respective ones of the at least one policy control session may be associated with the two or more protocol data unit sessions associated with the update, an identifier of a data network name used for the two or more protocol data unit sessions associated with the update, or an identifier of a slice used for the two or more protocol data unit sessions associated with the update.

The plurality of protocol data unit sessions may be associated with at least one of: a same data network name, a same single-network slice selection assistance information, a group identifier for a group of equipments, user or a common characteristic.

In accordance with one example embodiment, an apparatus may comprise: circuitry configured to perform: establishing a plurality of protocol data unit sessions, wherein respective protocol data unit sessions of the plurality of protocol data unit sessions may be configured to be used to send data streams towards a user equipment and/or to receive data streams from the user equipment; circuitry configured to perform: receiving at least one policy and charging control rule, wherein the at least one policy and charging control rule may apply to two or more of the plurality of protocol data unit sessions, wherein the at least one policy and charging control rule may be associated with at least one indication of the two or more protocol data unit sessions to which the at least one policy and charging control rule applies; and circuitry configured to perform: applying one or more of the at least one policy and charging control rules to data streams transported within respective ones of the two or more protocol data unit sessions.

In accordance with one example embodiment, an apparatus may comprise: processing circuitry; memory circuitry including computer program code, the memory circuitry and the computer program code configured to, with the processing circuitry, enable the apparatus to: establish a plurality of protocol data unit sessions, wherein respective protocol data unit sessions of the plurality of protocol data unit sessions may be configured to be used to send data streams towards a user equipment and/or to receive data streams from the user equipment; receive at least one policy and charging control rule, wherein the at least one policy and charging control rule may apply to two or more of the plurality of protocol data unit sessions, wherein the at least one policy and charging control rule may be associated with at least one indication of the two or more protocol data unit sessions to which the at least one policy and charging control rule applies; and apply one or more of the at least one policy and charging control rules to data streams transported within respective ones of the two or more protocol data unit sessions.

In accordance with one example embodiment, an apparatus may comprise means for: establishing a plurality of protocol data unit sessions, wherein respective protocol data unit sessions of the plurality of protocol data unit sessions may be configured to be used to send data streams towards a user equipment and/or to receive data streams from the user equipment; receiving at least one policy and charging control rule, wherein the at least one policy and charging control rule may apply to two or more of the plurality of protocol data unit sessions, wherein the at least one policy and charging control rule may be associated with at least one indication of the two or more protocol data unit sessions to which the at least one policy and charging control rule applies; and applying one or more of the at least one policy and charging control rules to data streams transported within respective ones of the two or more protocol data unit sessions.

The at least one indication of the two or more protocol data unit sessions to which the at least one policy and charging control rule applies may comprise at least one of: a protocol data unit session identifier, an identifier of a user equipment using the two or more protocol data unit sessions, an identifier of a policy control session, wherein the policy control session may be associated with the two or more protocol data unit sessions, a correlation identifier assigned to at least one policy control session, wherein respective ones of the at least one policy control session may be associated with the two or more protocol data unit sessions, an identifier of a data network name used for the two or more protocol data unit sessions, or an identifier of a slice used for the two or more protocol data unit sessions.

The means may be further configured for: transmitting a request to establish a policy control session associated with at least one protocol data unit session; and receiving a response to the request to establish the policy control session, wherein the response may contain the correlation identifier.

The means may be further configured for: receiving the at least one policy and charging control rule within a policy control session associated with one of the two or more protocol data unit sessions.

The means may be further configured for: receiving the at least one policy and charging control rule within a policy control session that is not associated with the two or more protocol data unit sessions.

The means may be further configured for: providing an update to the at least one policy and charging control rule, wherein the update comprises at least one of: a protocol data unit session identifier associated with the update, an identifier of a user equipment using the two or more protocol data unit sessions associated with the update, an identifier of a policy control session, wherein the policy control session may be associated with the two or more protocol data unit sessions associated with the update, a correlation identifier assigned to at least one policy control session, wherein respective ones of the at least one policy control session may be associated with the two or more protocol data unit sessions associated with the update, an identifier of a data network name used for the two or more protocol data unit sessions associated with the update, or an identifier of a slice used for the two or more protocol data unit sessions associated with the update.

The plurality of protocol data unit sessions may be associated with at least one of: a same data network name, a same single-network slice selection assistance information, a group identifier for a group user of equipments, or a common characteristic.

In accordance with one example embodiment, a non-transitory computer-readable medium comprising instructions stored thereon which, when executed with at least one processor, cause the at least one processor to: cause establishing of a plurality of protocol data unit sessions, wherein respective protocol data unit sessions of the plurality of protocol data unit sessions may be configured to be used to send data streams towards a user equipment and/or to receive data streams from the user equipment; cause receiving of at least one policy and charging control rule, wherein the at least one policy and charging control rule may apply to two or more of the plurality of protocol data unit sessions, wherein the at least one policy and charging control rule may be associated with at least one indication of the two or more protocol data unit sessions to which the at least one policy and charging control rule applies; and apply one or more of the at least one policy and charging control rules to data streams transported within respective ones of the two or more protocol data unit sessions.

In accordance with h one example embodiment, a non-transitory computer-readable medium comprising program instructions stored thereon for performing at least the following: causing establishing of a plurality of protocol data unit sessions, wherein respective protocol data unit sessions of the plurality of protocol data unit sessions may be configured to be used to send data streams towards a user equipment and/or to receive data streams from the user equipment; causing receiving of at least one policy and charging control rule, wherein the at least one policy and charging control rule may apply to two or more of the plurality of protocol data unit sessions, wherein the at least one policy and charging control rule may be associated with at least one indication of the two or more protocol data unit sessions to which the at least one policy and charging control rule applies; and applying one or more of the at least one policy and charging control rules to data streams transported within respective ones of the two or more protocol data unit sessions.

In accordance with another example embodiment, a non-transitory program storage device readable by a machine may be provided, tangibly embodying instructions executable by the machine for performing operations, the operations comprising: causing establishing of a plurality of protocol data unit sessions, wherein respective protocol data unit sessions of the plurality of protocol data unit sessions may be configured to be used to send data streams towards a user equipment and/or to receive data streams from the user equipment; causing receiving of at least one policy and charging control rule, wherein the at least one policy and charging control rule may apply to two or more of the plurality of protocol data unit sessions, wherein the at least one policy and charging control rule may be associated with at least one indication of the two or more protocol data unit sessions to which the at least one policy and charging control rule applies; and applying one or more of the at least one policy and charging control rules to data streams transported within respective ones of the two or more protocol data unit sessions.

In accordance with another example embodiment, a non-transitory computer-readable medium comprising instructions that, when executed by an apparatus, cause the apparatus to perform at least the following: causing establishing of a plurality of protocol data unit sessions, wherein respective protocol data unit sessions of the plurality of protocol data unit sessions may be configured to be used to send data streams towards a user equipment and/or to receive data streams from the user equipment; causing receiving of at least one policy and charging control rule, wherein the at least one policy and charging control rule may apply to two or more of the plurality of protocol data unit sessions, wherein the at least one policy and charging control rule may be associated with at least one indication of the two or more protocol data unit sessions to which the at least one policy and charging control rule applies; and applying one or more of the at least one policy and charging control rules to data streams transported within respective ones of the two or more protocol data unit sessions.

A computer implemented system comprising: at least one processor and at least one non-transitory memory storing instructions that, when executed by the at least one processor, cause the system at least to perform: causing establishing of a plurality of protocol data unit sessions, wherein respective protocol data unit sessions of the plurality of protocol data unit sessions may be configured to be used to send data streams towards a user equipment and/or to receive data streams from the user equipment; causing receiving of at least one policy and charging control rule, wherein the at least one policy and charging control rule may apply to two or more of the plurality of protocol data unit sessions, wherein the at least one policy and charging control rule may be associated with at least one indication of the two or more protocol data unit sessions to which the at least one policy and charging control rule applies; and applying one or more of the at least one policy and charging control rules to data streams transported within respective ones of the two or more protocol data unit sessions.

A computer implemented system comprising: means for causing establishing of a plurality of protocol data unit sessions, wherein respective protocol data unit sessions of the plurality of protocol data unit sessions may be configured to be used to send data streams towards a user equipment and/or to receive data streams from the user equipment; means for causing receiving of at least one policy and charging control rule, wherein the at least one policy and charging control rule may apply to two or more of the plurality of protocol data unit sessions, wherein the at least one policy and charging control rule may be associated with at least one indication of the two or more protocol data unit sessions to which the at least one policy and charging control rule applies; and means for applying one or more of the at least one policy and charging control rules to data streams transported within respective ones of the two or more protocol data unit sessions.

In accordance with one example embodiment, an apparatus may comprise: at least one processor; and at least one memory storing instructions that, when executed by the at least one processor, cause the apparatus at least to: determine at least one policy and charging control rule, wherein the at least one policy and charging control rule may comprise at least one policy fragment identifier, wherein the at least one policy fragment identifier may identify a fragment of policy or charging information that is applicable to a plurality of protocol data unit sessions; and provide the at least one policy and charging control rule.

The example apparatus may be further configured to: receive a request to establish a policy control session not associated with the plurality of protocol data unit sessions; and provide the at least one policy fragment identifier, and the fragment of policy or charging information identified with the at least one policy fragment identifier, within the policy control session not associated with the plurality of protocol data unit sessions.

The example apparatus may be further configured to: provide, to a database, the at least one policy fragment identifier, and the fragment of policy or charging information identified with the at least one policy fragment identifier.

The example apparatus may be further configured to: provide at least one update using the at least one policy fragment identifier.

The example apparatus may be further configured to: authorize at least one update associated with the fragment of policy or charging information.

The fragment of policy or charging information identified with the at least one policy fragment identifier may be comprised within a packet flow description extended with at least one additional content.

In accordance with one aspect, an example method may be provided comprising: determining, with a policy charging function, at least one policy and charging control rule, wherein the at least one policy and charging control rule may comprise at least one policy fragment identifier, wherein the at least one policy fragment identifier may identify a fragment of policy or charging information that is applicable to a plurality of protocol data unit sessions; and providing the at least one policy and charging control rule.

The example method may further comprise: receiving a request to establish a policy control session not associated with the plurality of protocol data unit sessions; and providing the at least one policy fragment identifier, and the fragment of policy or charging information identified with the at least one policy fragment identifier, within the policy control session not associated with the plurality of protocol data unit sessions.

The example method may further comprise: providing, to a database, the at least one policy fragment identifier, and the fragment of policy or charging information identified with the at least one policy fragment identifier.

The example method may further comprise: providing at least one update using the at least one policy fragment identifier.

The example method may further comprise: authorizing at least one update associated with the fragment of policy or charging information.

The fragment of policy or charging information identified with the at least one policy fragment identifier may be comprised within a packet flow description extended with at least one additional content.

In accordance with one example embodiment, an apparatus may comprise: circuitry configured to perform: determining at least one policy and charging control rule, wherein the at least one policy and charging control rule may comprise at least one policy fragment identifier, wherein the at least one policy fragment identifier may identify a fragment of policy or charging information that is applicable to a plurality of protocol data unit sessions; and circuitry configured to perform: providing the at least one policy and charging control rule.

In accordance with one example embodiment, an apparatus may comprise: processing circuitry; memory circuitry including computer program code, the memory circuitry and the computer program code configured to, with the processing circuitry, enable the apparatus to: determine at least one policy and charging control rule, wherein the at least one policy and charging control rule may comprise at least one policy fragment identifier, wherein the at least one policy fragment identifier may identify a fragment of policy or charging information that is applicable to a plurality of protocol data unit sessions; and provide the at least one policy and charging control rule.

In accordance with one example embodiment, an apparatus may comprise means for: determining at least one policy and charging control rule, wherein the at least one policy and charging control rule may comprise at least one policy fragment identifier, wherein the at least one policy fragment identifier may identify a fragment of policy or charging information that is applicable to a plurality of protocol data unit sessions; and providing the at least one policy and charging control rule.

The means may be further configured for: receiving a request to establish a policy control session not associated with the plurality of protocol data unit sessions; and providing the at least one policy fragment identifier, and the fragment of policy or charging information identified with the at least one policy fragment identifier, within the policy control session not associated with the plurality of protocol data unit sessions.

The means may be further configured for: providing, to a database, the at least one policy fragment identifier, and the fragment of policy or charging information identified with the at least one policy fragment identifier.

The means may be further configured for: providing at least one update using the at least one policy fragment identifier.

The means may be further configured for: authorizing at least one update associated with the fragment of policy or charging information.

The fragment of policy or charging information identified with the at least one policy fragment identifier may be comprised within a packet flow description extended with at least one additional content.

In accordance with one example embodiment, a non-transitory computer-readable medium comprising instructions stored thereon which, when executed with at least one processor, cause the at least one processor to: determine at least one policy and charging control rule, wherein the at least one policy and charging control rule may comprise at least one policy fragment identifier, wherein the at least one policy fragment identifier may identify a fragment of policy or charging information that is applicable to a plurality of protocol data unit sessions; and cause providing of the at least one policy and charging control rule.

In accordance with one example embodiment, a non-transitory computer-readable medium comprising program instructions stored thereon for performing at least the following: determining at least one policy and charging control rule, wherein the at least one policy and charging control rule may comprise at least one policy fragment identifier, wherein the at least one policy fragment identifier may identify a fragment of policy or charging information that is applicable to a plurality of protocol data unit sessions; and causing providing of the at least one policy and charging control rule.

In accordance with another example embodiment, a non-transitory program storage device readable by a machine may be provided, tangibly embodying instructions executable by the machine for performing operations, the operations comprising: determining at least one policy and charging control rule, wherein the at least one policy and charging control rule may comprise at least one policy fragment identifier, wherein the at least one policy fragment identifier may identify a fragment of policy or charging information that is applicable to a plurality of protocol data unit sessions; and causing providing of the at least one policy and charging control rule.

In accordance with another example embodiment, a non-transitory computer-readable medium comprising instructions that, when executed by an apparatus, cause the apparatus to perform at least the following: determining at least one policy and charging control rule, wherein the at least one policy and charging control rule may comprise at least one policy fragment identifier, wherein the at least one policy fragment identifier may identify a fragment of policy or charging information that is applicable to a plurality of protocol data unit sessions; and causing providing of the at least one policy and charging control rule.

A computer implemented system comprising: at least one processor and at least one non-transitory memory storing instructions that, when executed by the at least one processor, cause the system at least to perform: determining at least one policy and charging control rule, wherein the at least one policy and charging control rule may comprise at least one policy fragment identifier, wherein the at least one policy fragment identifier may identify a fragment of policy or charging information that is applicable to a plurality of protocol data unit sessions; and causing providing of the at least one policy and charging control rule.

A computer implemented system comprising: means for determining at least one policy and charging control rule, wherein the at least one policy and charging control rule may comprise at least one policy fragment identifier, wherein the at least one policy fragment identifier may identify a fragment of policy or charging information that is applicable to a plurality of protocol data unit sessions; and means for causing providing of the at least one policy and charging control rule.

In accordance with one example embodiment, an apparatus may comprise: at least one processor; and at least one memory storing instructions that, when executed by the at least one processor, cause the apparatus at least to: establish a plurality of protocol data unit sessions, wherein respective ones of the plurality of protocol data unit sessions may be configured to be used to send data streams towards a user equipment and/or to receive data streams from the user equipment; and receive, from a policy and charging function, at least one policy and charging control rule in a first policy control session associated with a first protocol data unit session of the plurality of protocol data unit sessions, wherein the at least one policy and charging control rule may comprise at least one policy fragment identifier, wherein the at least one policy fragment identifier may identify a fragment of policy or charging information that is applicable to two or more of the plurality of protocol data unit sessions.

The example apparatus may be further configured to: receive the at least one policy fragment identifier.

The example apparatus may be further configured to: transmit, to a database, a request to subscribe to notifications about one or more fragments of policy or charging information; receive, from the database, a notification comprising at least: at least one of the one or more fragments of policy or charging information, and one or more policy fragment identifiers respectively identifying the at least one of the one or more fragments of policy or charging information; and apply, to data streams transported within the first protocol data unit session, policies denoted by the one or more fragments of policy or charging information in combination with the at least one policy and charging control rule.

The example apparatus may be further configured to: transmit, to the policy and charging function, a request to establish a second policy control session not associated with the first protocol data unit session; and receive, in the second policy control session, one or more fragments of policy or charging information, and one or more policy fragment identifiers respectively identifying the one or more fragments of policy or charging information.

The example apparatus may be further configured to: receive a packet flow description, wherein the packet flow description may comprise the at least one policy fragment identifier and one or more fragments of policy or charging information respectively identified with the at least one policy fragment identifier.

In accordance with one aspect, an example method may be provided comprising: establishing, with a session management function, a plurality of protocol data unit sessions, wherein respective ones of the plurality of protocol data unit sessions may be configured to be used to send data streams towards a user equipment and/or to receive data streams from the user equipment; and receiving, from a policy and charging function, at least one policy and charging control rule in a first policy control session associated with a first protocol data unit session of the plurality of protocol data unit sessions, wherein the at least one policy and charging control rule may comprise at least one policy fragment identifier, wherein the at least one policy fragment identifier may identify a fragment of policy or charging information that is applicable to two or more of the plurality of protocol data unit sessions.

The example method may further comprise: receiving the at least one policy fragment identifier.

The example method may further comprise: transmitting, to a database, a request to subscribe to notifications about one or more fragments of policy or charging information; receiving, from the database, a notification comprising at least: at least one of the one or more fragments of policy or charging information, and one or more policy fragment identifiers respectively identifying the at least one of the one or more fragments of policy or charging information; and applying, to data streams transported within the first protocol data unit session, policies denoted by the one or more fragments of policy or charging information in combination with the at least one policy and charging control rule.

The example method may further comprise: transmitting, to the policy and charging function, a request to establish a second policy control session not associated with the first protocol data unit session; and receiving, in the second policy control session, one or more fragments of policy or charging information, and one or more policy fragment identifiers respectively identifying the one or more fragments of policy or charging information.

The example method may further comprise: receiving a packet flow description, wherein the packet flow description may comprise the at least one policy fragment identifier and one or more fragments of policy or charging information respectively identified with the at least one policy fragment identifier.

In accordance with one example embodiment, an apparatus may comprise: circuitry configured to perform: establishing a plurality of protocol data unit sessions, wherein respective ones of the plurality of protocol data unit sessions may be configured to be used to send data streams towards a user equipment and/or to receive data streams from the user equipment; and circuitry configured to perform: receiving, from a policy and charging function, at least one policy and charging control rule in a first policy control session associated with a first protocol data unit session of the plurality of protocol data unit sessions, wherein the at least one policy and charging control rule may comprise at least one policy fragment identifier, wherein the at least one policy fragment identifier may identify a fragment of policy or charging information that is applicable to two or more of the plurality of protocol data unit sessions.

In accordance with one example embodiment, an apparatus may comprise: processing circuitry; memory circuitry including computer program code, the memory circuitry and the computer program code configured to, with the processing circuitry, enable the apparatus to: establish a plurality of protocol data unit sessions, wherein respective ones of the plurality of protocol data unit sessions may be configured to be used to send data streams towards a user equipment and/or to receive data streams from the user equipment; and receive, from a policy and charging function, at least one policy and charging control rule in a first policy control session associated with a first protocol data unit session of the plurality of protocol data unit sessions, wherein the at least one policy and charging control rule may comprise at least one policy fragment identifier, wherein the at least one policy fragment identifier may identify a fragment of policy or charging information that is applicable to two or more of the plurality of protocol data unit sessions.

In accordance with one example embodiment, an apparatus may comprise means for: establishing a plurality of protocol data unit sessions, wherein respective ones of the plurality of protocol data unit sessions may be configured to be used to send data streams towards a user equipment and/or to receive data streams from the user equipment; and receiving, from a policy and charging function, at least one policy and charging control rule in a first policy control session associated with a first protocol data unit session of the plurality of protocol data unit sessions, wherein the at least one policy and charging control rule may comprise at least one policy fragment identifier, wherein the at least one policy fragment identifier may identify a fragment of policy or charging information that is applicable to two or more of the plurality of protocol data unit sessions.

The means may be further configured for: receiving the at least one policy fragment identifier.

The means may be further configured for: transmitting, to a database, a request to subscribe to notifications about one or more fragments of policy or charging information; receiving, from the database, a notification comprising at least: at least one of the one or more fragments of policy or charging information, and one or more policy fragment identifiers respectively identifying the at least one of the one or more fragments of policy or charging information; and applying, to data streams transported within the first protocol data unit session, policies denoted by the one or more fragments of policy or charging information in combination with the at least one policy and charging control rule.

The means may be further configured for: transmitting, to the policy and charging function, a request to establish a second policy control session not associated with the first protocol data unit session; and receiving, in the second policy control session, one or more fragments of policy or charging information, and one or more policy fragment identifiers respectively identifying the one or more fragments of policy or charging information.

The means may be further configured for: receiving a packet flow description, wherein the packet flow description may comprise the at least one policy fragment identifier and one or more fragments of policy or charging information respectively identified with the at least one policy fragment identifier.

In accordance with one example embodiment, a non-transitory computer-readable medium comprising instructions stored thereon which, when executed with at least one processor, cause the at least one processor to: cause establishing of a plurality of protocol data unit sessions, wherein respective ones of the plurality of protocol data unit sessions may be configured to be used to send data streams towards a user equipment and/or to receive data streams from the user equipment; and cause receiving, from a policy and charging function, of at least one policy and charging control rule in a first policy control session associated with a first protocol data unit session of the plurality of protocol data unit sessions, wherein the at least one policy and charging control rule may comprise at least one policy fragment identifier, wherein the at least one policy fragment identifier may identify a fragment of policy or charging information that is applicable to two or more of the plurality of protocol data unit sessions.

In accordance with one example embodiment, a non-transitory computer-readable medium comprising program instructions stored thereon for performing at least the following: causing establishing of a plurality of protocol data unit sessions, wherein respective ones of the plurality of protocol data unit sessions may be configured to be used to send data streams towards a user equipment and/or to receive data streams from the user equipment; and causing receiving, from a policy and charging function, of at least one policy and charging control rule in a first policy control session associated with a first protocol data unit session of the plurality of protocol data unit sessions, wherein the at least one policy and charging control rule may comprise at least one policy fragment identifier, wherein the at least one policy fragment identifier may identify a fragment of policy or charging information that is applicable to two or more of the plurality of protocol data unit sessions.

In accordance with another example embodiment, a non-transitory program storage device readable by a machine may be provided, tangibly embodying instructions executable by the machine for performing operations, the operations comprising: causing establishing of a plurality of protocol data unit sessions, wherein respective ones of the plurality of protocol data unit sessions may be configured to be used to send data streams towards a user equipment and/or to receive data streams from the user equipment; and causing receiving, from a policy and charging function, of at least one policy and charging control rule in a first policy control session associated with a first protocol data unit session of the plurality of protocol data unit sessions, wherein the at least one policy and charging control rule may comprise at least one policy fragment identifier, wherein the at least one policy fragment identifier may identify a fragment of policy or charging information that is applicable to two or more of the plurality of protocol data unit sessions.

In accordance with another example embodiment, a non-transitory computer-readable medium comprising instructions that, when executed by an apparatus, cause the apparatus to perform at least the following: causing establishing of a plurality of protocol data unit sessions, wherein respective ones of the plurality of protocol data unit sessions may be configured to be used to send data streams towards a user equipment and/or to receive data streams from the user equipment; and causing receiving, from a policy and charging function, of at least one policy and charging control rule in a first policy control session associated with a first protocol data unit session of the plurality of protocol data unit sessions, wherein the at least one policy and charging control rule may comprise at least one policy fragment identifier, wherein the at least one policy fragment identifier may identify a fragment of policy or charging information that is applicable to two or more of the plurality of protocol data unit sessions.

A computer implemented system comprising: at least one processor and at least one non-transitory memory storing instructions that, when executed by the at least one processor, cause the system at least to perform: causing establishing of a plurality of protocol data unit sessions, wherein respective ones of the plurality of protocol data unit sessions may be configured to be used to send data streams towards a user equipment and/or to receive data streams from the user equipment; and causing receiving, from a policy and charging function, of at least one policy and charging control rule in a first policy control session associated with a first protocol data unit session of the plurality of protocol data unit sessions, wherein the at least one policy and charging control rule may comprise at least one policy fragment identifier, wherein the at least one policy fragment identifier may identify a fragment of policy or charging information that is applicable to two or more of the plurality of protocol data unit sessions.

A computer implemented system comprising: means for causing establishing of a plurality of protocol data unit sessions, wherein respective ones of the plurality of protocol data unit sessions may be configured to be used to send data streams towards a user equipment and/or to receive data streams from the user equipment; and means for causing receiving, from a policy and charging function, of at least one policy and charging control rule in a first policy control session associated with a first protocol data unit session of the plurality of protocol data unit sessions, wherein the at least one policy and charging control rule may comprise at least one policy fragment identifier, wherein the at least one policy fragment identifier may identify a fragment of policy or charging information that is applicable to two or more of the plurality of protocol data unit sessions.

In accordance with one example embodiment, an apparatus may comprise: at least one processor; and at least one memory storing instructions that, when executed by the at least one processor, cause the apparatus at least to: receive, from a session management function, a request to update or create at least one session management policy association; transmit, to the session management function, a response to the received request, wherein the response may comprise, at least, a correlation identifier assigned to one or more protocol data unit sessions; determine one or more session management policy associations for which new or updated policy and charging control rules are required; determine a session management policy association of the one or more session management policy associations associated with the session management function; determine one or more correlation identifiers associated with the session management policy association associated with the session management function; and transmit, to the session management function, an indication to update one or more protocol data unit sessions, associated with the one or more determined correlation identifiers, with the new or updated policy and charging control rules.

The one or more protocol data unit sessions may comprise a plurality of protocol data unit sessions.

The plurality of protocol data unit sessions may be associated with at least one of: a same data network name, a same single-network slice selection assistance information, a group identifier for a group of user equipments, or a common characteristic.

The one or more session management policy associations for which the new or updated policy and charging control rules are required may be determined based, at least partially, on at least one of: policy charging function logic, or an external application function request.

The example apparatus may be further configured to: transmit, to the session management function, an indication of at least one protocol data unit session associated with the one or more determined correlation identifiers to which the new or updated policy and charging control rules do not apply.

The example apparatus may be further configured to: receive, from the session management function, an indication of a failure to apply the new or update policy and charging control rules to a protocol data unit session of the one or more protocol data unit sessions.

The example apparatus may be further configured to: transmit, to the protocol data unit session, an indication to update one or more session management policies based, at least one partially, on the new or updated policy and charging control rules.

The indication to update the one or more protocol data unit sessions may comprise, at least, the one or more determined correlation identifiers and the new or updated policy and charging control rules.

The indication to update the one or more protocol data unit sessions may comprise, at least, a list of the one or more protocol data unit sessions and the new or updated policy and charging control rules.

The list of the one or more protocol data unit sessions may comprise an array of identifiers of the one or more protocol data unit sessions.

In accordance with one aspect, an example method may be provided comprising: receiving, with a policy charging function from a session management function, a request to update or create at least one session management policy association; transmitting, to the session management function, a response to the received request, wherein the response may comprise, at least, a correlation identifier assigned to one or more protocol data unit sessions; determining one or more session management policy associations for which new or updated policy and charging control rules are required; determining a session management policy association of the one or more session management policy associations associated with the session management function; determining one or more correlation identifiers associated with the session management policy association associated with the session management function; and transmitting, to the session management function, an indication to update one or more protocol data unit sessions, associated with the one or more determined correlation identifiers, with the new or updated policy and charging control rules.

The one or more protocol data unit sessions may comprise a plurality of protocol data unit sessions.

The plurality of protocol data unit sessions may be associated with at least one of: a same data network name, a same single-network slice selection assistance information, a group identifier for a group of user equipments, or a common characteristic.

The one or more session management policy associations for which the new or updated policy and charging control rules are required may be determined based, at least partially, on at least one of: policy charging function logic, or an external application function request.

The example method may further comprise: transmitting, to the session management function, an indication of at least one protocol data unit session associated with the one or more determined correlation identifiers to which the new or updated policy and charging control rules do not apply.

The example method may further comprise: receiving, from the session management function, an indication of a failure to apply the new or update policy and charging control rules to a protocol data unit session of the one or more protocol data unit sessions.

The example method may further comprise: transmitting, to the protocol data unit session, an indication to update one or more session management policies based, at least one partially, on the new or updated policy and charging control rules.

The indication to update the one or more protocol data unit sessions may comprise, at least, the one or more determined correlation identifiers and the new or updated policy and charging control rules.

The indication to update the one or more protocol data unit sessions may comprise, at least, a list of the one or more protocol data unit sessions and the new or updated policy and charging control rules.

The list of the one or more protocol data unit sessions may comprise an array of identifiers of the one or more protocol data unit sessions.

In accordance with one example embodiment, an apparatus may comprise: circuitry configured to perform: receiving, from a session management function, a request to update or create at least one session management policy association; circuitry configured to perform: transmitting, to the session management function, a response to the received request, wherein the response may comprise, at least, a correlation identifier assigned to one or more protocol data unit sessions; circuitry configured to perform: determining one or more session management policy associations for which new or updated policy and charging control rules are required; circuitry configured to perform: determining a session management policy association of the one or more session management policy associations associated with the session management function; circuitry configured to perform: determining one or more correlation identifiers associated with the session management policy association associated with the session management function; and circuitry configured to perform: transmitting, to the session management function, an indication to update one or more protocol data unit sessions, associated with the one or more determined correlation identifiers, with the new or updated policy and charging control rules.

In accordance with one example embodiment, an apparatus may comprise: processing circuitry; memory circuitry including computer program code, the memory circuitry and the computer program code configured to, with the processing circuitry, enable the apparatus to: receive, from a session management function, a request to update or create at least one session management policy association; transmit, to the session management function, a response to the received request, wherein the response may comprise, at least, a correlation identifier assigned to one or more protocol data unit sessions; determine one or more session management policy associations for which new or updated policy and charging control rules are required; determine a session management policy association of the one or more session management policy associations associated with the session management function; determine one or more correlation identifiers associated with the session management policy association associated with the session management function; and transmit, to the session management function, an indication to update one or more protocol data unit sessions, associated with the one or more determined correlation identifiers, with the new or updated policy and charging control rules.

In accordance with one example embodiment, an apparatus may comprise means for: receiving, from a session management function, a request to update or create at least one session management policy association; transmitting, to the session management function, a response to the received request, wherein the response may comprise, at least, a correlation identifier assigned to one or more protocol data unit sessions; determining one or more session management policy associations for which new or updated policy and charging control rules are required; determining a session management policy association of the one or more session management policy associations associated with the session management function; determining one or more correlation identifiers associated with the session management policy association associated with the session management function; and transmitting, to the session management function, an indication to update one or more protocol data unit sessions, associated with the one or more determined correlation identifiers, with the new or updated policy and charging control rules.

The one or more protocol data unit sessions may comprise a plurality of protocol data unit sessions.

The plurality of protocol data unit sessions may be associated with at least one of: a same data network name, a same single-network slice selection assistance information, a group identifier for a group of user equipments, or a common characteristic.

The one or more session management policy associations for which the new or updated policy and charging control rules are required may be determined based, at least partially, on at least one of: policy charging function logic, or an external application function request.

The means may be further configured for: transmitting, to the session management function, an indication of at least one protocol data unit session associated with the one or more determined correlation identifiers to which the new or updated policy and charging control rules do not apply.

The means may be further configured for: receiving, from the session management function, an indication of a failure to apply the new or update policy and charging control rules to a protocol data unit session of the one or more protocol data unit sessions.

The means may be further configured for: transmitting, to the protocol data unit session, an indication to update one or more session management policies based, at least one partially, on the new or updated policy and charging control rules.

The indication to update the one or more protocol data unit sessions may comprise, at least, the one or more determined correlation identifiers and the new or updated policy and charging control rules.

The indication to update the one or more protocol data unit sessions may comprise, at least, a list of the one or more protocol data unit sessions and the new or updated policy and charging control rules.

The list of the one or more protocol data unit sessions may comprise an array of identifiers of the one or more protocol data unit sessions.

In accordance with one example embodiment, a non-transitory computer-readable medium comprising instructions stored thereon which, when executed with at least one processor, cause the at least one processor to: cause receiving, from a session management function, of a request to update or create at least one session management policy association; cause transmitting, to the session management function, of a response to the received request, wherein the response may comprise, at least, a correlation identifier assigned to one or more protocol data unit sessions; determine one or more session management policy associations for which new or updated policy and charging control rules are required; determine a session management policy association of the one or more session management policy associations associated with the session management function; determine one or more correlation identifiers associated with the session management policy association associated with the session management function; and cause transmitting, to the session management function, of an indication to update one or more protocol data unit sessions, associated with the one more determined correlation identifiers, with the new or updated policy and charging control rules.

In accordance with one example embodiment, a non-transitory computer-readable medium comprising program instructions stored thereon for performing at least the following: causing receiving, from a session management function, of a request to update or create at least one session management policy association; causing transmitting, to the session management function, of a response to the received request, wherein the response may comprise, at least, a correlation identifier assigned to one or more protocol data unit sessions; determining one or more session management policy associations for which new or updated policy and charging control rules are required; determining a session management policy association of the one or more session management policy associations associated with the session management function; determining one or more correlation identifiers associated with the session management policy association associated with the session management function; and causing transmitting, to the session management function, of an indication to update one or more protocol data unit sessions, associated with the one or more determined correlation identifiers, with the new or updated policy and charging control rules.

In accordance with another example embodiment, a non-transitory program storage device readable by a machine may be provided, tangibly embodying instructions executable by the machine for performing operations, the operations comprising: causing receiving, from a session management function, of a request to update or create at least one session management policy association; causing transmitting, to the session management function, of a response to the received request, wherein the response may comprise, at least, a correlation identifier assigned to one or more protocol data unit sessions; determining one or more session management policy associations for which new or updated policy and charging rules control are required; determining a session management policy association of the one or more session management policy associations associated with the session management function; determining one or more correlation identifiers associated with the session management policy association associated with the session management function; and causing transmitting, to the session management function, of an indication to update one or more protocol data unit sessions, associated with the one or more determined correlation identifiers, with the new or updated policy and charging control rules.

In accordance with another example embodiment, a non-transitory computer-readable medium comprising instructions that, when executed by an apparatus, cause the apparatus to perform at least the following: causing receiving, from a session management function, of a request to update or create at least one session management policy association; causing transmitting, to the session management function, of a response to the received request, wherein the response may comprise, at least, a correlation identifier assigned to one or more protocol data unit sessions; determining one or more session management policy associations for which new or updated policy and charging control rules are required; determining a session management policy association of the one or more session management policy associations associated with the session management function; determining one or more correlation identifiers associated with the session management policy association associated with the session management function; and causing transmitting, to the session management function, of an indication to update one or more protocol data unit sessions, associated with the one or more determined correlation identifiers, with the new or updated policy and charging control rules.

A computer implemented system comprising: at least one processor and at least one non-transitory memory storing instructions that, when executed by the at least one processor, cause the system at least to perform: causing receiving, from a session management function, of a request to update or create at least one session management policy association; causing transmitting, to the session management function, of a response to the received request, wherein the response may comprise, at least, a correlation identifier assigned to one or more protocol data unit sessions; determining one or more session management policy associations for which new or updated policy and charging control rules are required; determining a session management policy association of the one or more session management policy associations associated with the session management function; determining one or more correlation identifiers associated with the session management policy association associated with the session management function; and causing transmitting, to the session management function, of an indication to update one or more protocol data unit sessions, associated with the one or more determined correlation identifiers, with the new or updated policy and charging control rules.

A computer implemented system comprising: means for causing receiving, from a session management function, of a request to update or create at least one session management policy association; means for causing transmitting, to the session management function, of a response to the received request, wherein the response may comprise, at least, a correlation identifier assigned to one or more protocol data unit sessions; means for determining one or more session management policy associations for which new or updated policy and charging control rules are required; means for determining a session management policy association of the one or more session management policy associations associated with the session management function; means for determining one or more correlation identifiers associated with the session management policy association associated with the session management function; and means for causing transmitting, to the session management function, of an indication to update one or more protocol data unit sessions, associated with the one or more determined correlation identifiers, with the new or updated policy and charging control rules.

In accordance with one example embodiment, an apparatus may comprise: at least one processor; and at least one memory storing instructions that, when executed by the at least one processor, cause the apparatus at least to: transmit, to a policy charging function, a request to update or create at least one session management policy association; receive, from the policy charging function, a response to the transmitted request, wherein the response may comprise, at least, a correlation identifier assigned to one or more protocol data unit sessions; receive, from the policy charging function, an indication to update one or more protocol data unit sessions, associated with one or more correlation identifiers, with new or updated policy and charging control rules, wherein the indication may comprise, at least, the new or updated policy and charging control rules; and apply the new or updated policy and charging control rules to the one or more protocol data unit sessions.

The one or more protocol data unit sessions may comprise a plurality of protocol data unit sessions.

The plurality of protocol data unit sessions may be associated with at least one of: a same data network name, a same single-network slice selection assistance information, a group identifier for a group of user equipments, or a common characteristic.

The example apparatus may be further configured to: receive, from the policy charging function, an indication of at least one protocol data unit session associated with the one or more correlation identifiers to which the new or updated policy and charging control rules do not apply.

The example apparatus may be further configured to: transmit, to the policy charging function, an indication of a failure to apply the new or update policy and charging control rules to a protocol data unit session of the one or more protocol data unit sessions.

The indication to update the one or more protocol data unit sessions may comprise, at least, the one or more correlation identifiers, wherein the example apparatus may be further configured to: determine the one or more protocol data unit sessions based, at least partially, on the one or more correlation identifiers.

The indication to update the one or more protocol data unit sessions may comprise, at least, a list of the one or more protocol data unit sessions.

The list of the one or more protocol data unit sessions may comprise an array of identifiers of the one or more protocol data unit sessions.

In accordance with one aspect, an example method may be provided comprising: transmitting, with a session management function to a policy charging function, a request to update or create at least one management policy association; receiving, from the policy charging function, a response to the transmitted request, wherein the response may comprise, at least, a correlation identifier assigned to one or more protocol data unit sessions; receiving, from the policy charging function, an indication to update one or more protocol data unit sessions, associated with one or more correlation identifiers, with new or updated policy and charging control rules, wherein the indication may comprise, at least, the new or updated policy and charging control rules; and applying the new or updated policy and charging control rules to the one or more protocol data unit sessions.

The one or more protocol data unit sessions may comprise a plurality of protocol data unit sessions.

The plurality of protocol data unit sessions may be associated with at least one of: a same data network name, a same single-network slice selection assistance information, a group identifier for a group of user equipments, or a common characteristic.

The example method may further comprise: receiving, from the policy charging function, an indication of at least one protocol data unit session associated with the one or more correlation identifiers to which the new or updated policy and charging control rules do not apply.

The example method may further comprise: transmitting, to the policy charging function, an indication of a failure to apply the new or update policy and charging control rules to a protocol data unit session of the one or more protocol data unit sessions.

The indication to update the one or more protocol data unit sessions may comprise, at least, the one or more correlation identifiers, wherein the example method may further comprise: determining the one or more protocol data unit sessions based, at least partially, on the one or more correlation identifiers.

The indication to update the one or more protocol data unit sessions may comprise, at least, a list of the one or more protocol data unit sessions.

The list of the one or more protocol data unit sessions may comprise an array of identifiers of the one or more protocol data unit sessions.

In accordance with one example embodiment, an apparatus may comprise: circuitry configured to perform: transmitting, to a policy charging function, a request to update or create at least one session management policy association; circuitry configured to perform: receiving, from the policy charging function, a response to the transmitted request, wherein the response may comprise, at least, a correlation identifier assigned to one or more protocol data unit sessions; circuitry configured to perform: receiving, from the policy charging function, an indication to update one or more protocol data unit sessions, associated with one or more correlation identifiers, with new or updated policy and charging control rules, wherein the indication may comprise, at least, the new or updated policy and charging control rules; and circuitry configured to perform: applying the new or updated policy and charging control rules to the one or more protocol data unit sessions.

In accordance with one example embodiment, an apparatus may comprise: processing circuitry; memory circuitry including computer program code, the memory circuitry and the computer program code configured to, with the processing circuitry, enable the apparatus to: transmit, to a policy charging function, a request to update or create at least one session management policy association; receive, from the policy charging function, a response to the transmitted request, wherein the response may comprise, at least, a correlation identifier assigned to one or more protocol data unit sessions; receive, from the policy charging function, an indication to update one or more protocol data unit sessions, associated with one or more correlation identifiers, with new or updated policy and charging control rules, wherein the indication may comprise, at least, the new or updated policy and charging control rules; and apply the new or updated policy and charging control rules to the one or more protocol data unit sessions.

In accordance with one example embodiment, an apparatus may comprise means for: transmitting, to a policy charging function, a request to update or create at least one session management policy association; receiving, from the policy charging function, a response to the transmitted request, wherein the response may comprise, at least, a correlation identifier assigned to one or more protocol data unit sessions; receiving, from the policy charging function, an indication to update one or more protocol data unit sessions, associated with one or more correlation identifiers, with new or updated policy and charging control rules, wherein the indication may comprises, at least, the new or updated policy and charging control rules; and applying the new or updated policy and charging control rules to the one or more protocol data unit sessions.

The one or more protocol data unit sessions may comprise a plurality of protocol data unit sessions.

The plurality of protocol data unit sessions may be associated with at least one of: a same data network name, a same single-network slice selection assistance information, a group identifier for a group of user equipments, or a common characteristic.

The means may be further configured for: receiving, from the policy charging function, an indication of at least one protocol data unit session associated with the one or more correlation identifiers to which the new or updated policy and charging control rules do not apply.

The means may be further configured for: transmitting, to the policy charging function, an indication of a failure to apply the new or update policy and charging control rules to a protocol data unit session of the one or more protocol data unit sessions.

The indication to update the one or more protocol data unit sessions may comprise, at least, the one or more correlation identifiers, wherein the means may be further configured for: determining the one or more protocol data unit sessions based, at least partially, on the one or more correlation identifiers.

The indication to update the one or more protocol data unit sessions may comprise, at least, a list of the one or more protocol data unit sessions.

The list of the one or more protocol data unit sessions may comprise an array of identifiers of the one or more protocol data unit sessions.

In accordance with one example embodiment, a non-transitory computer-readable medium comprising instructions stored thereon which, when executed with at least one processor, cause the at least one processor to: cause transmitting, to a policy charging function, of a request to update or create at least one session management policy association; cause receiving, from the policy charging function, of a response to the transmitted request, wherein the response may comprise, at least, a correlation identifier assigned to one or more protocol data unit sessions; cause receiving, from the policy charging function, of an indication to update one or more protocol data unit sessions, associated with one or more correlation identifiers, with new or updated policy and charging control rules, wherein the indication may comprise, at least, the new or updated policy and charging control rules; and apply the new or updated policy and charging control rules to the one or more protocol data unit sessions.

In accordance with one example embodiment, a non-transitory computer-readable medium comprising program instructions stored thereon for performing at least the following: causing transmitting, to a policy charging function, of a request to update or create at least one session management policy association; causing receiving, from the policy charging function, of a response to the transmitted request, wherein the response may comprise, at least, a correlation identifier assigned to one or more protocol data unit sessions; causing receiving, from the policy charging function, of an indication to update one or more protocol data unit sessions, associated with one or more correlation identifiers, with new or updated policy and charging control rules, wherein the indication may comprise, at least, the new or updated policy and charging control rules; and applying the new or updated policy and charging control rules to the one or more protocol data unit sessions.

In accordance with another example embodiment, a non-transitory program storage device readable by a machine may be provided, tangibly embodying instructions executable by the machine for performing operations, the operations comprising: causing transmitting, to a policy charging function, of a request to update or create at least one session management policy association; causing receiving, from the policy charging function, of a response to the transmitted request, wherein the response may comprise, at least, a correlation identifier assigned to one or more protocol data unit sessions; causing receiving, from the policy charging function, of an indication to update one or more protocol data unit sessions, associated with one or more correlation identifiers, with new or updated policy and charging control rules, wherein the indication may comprise, at least, the new or updated policy and charging control rules; and applying the new or updated policy and charging control rules to the one or more protocol data unit sessions.

In accordance with another example embodiment, a non-transitory computer-readable medium comprising instructions that, when executed by an apparatus, cause the apparatus to perform at least the following: causing transmitting, to a policy charging function, of a request to update or create at least one session management policy association; causing receiving, from the policy charging function, of a response to the transmitted request, wherein the response may comprise, at least, a correlation identifier assigned to one or more protocol data unit sessions; causing receiving, from the policy charging function, of an indication to update one or more protocol data unit sessions, associated with one or more correlation identifiers, with new or updated policy and charging control rules, wherein the indication may comprise, at least, the new or updated policy and charging control rules; and applying the new or updated policy and charging control rules to the one or more protocol data unit sessions.

A computer implemented system comprising: at least one processor and at least one non-transitory memory storing instructions that, when executed by the at least one processor, cause the system at least to perform: causing transmitting, to a policy charging function, of a request to update or create at least one session management policy association; causing receiving, from the policy charging function, of a response to the transmitted request, wherein the response may comprise, at least, a correlation identifier assigned to one or more protocol data unit sessions; causing receiving, from the policy charging function, of an indication to update one or more protocol data unit sessions, associated with one or more correlation identifiers, with new or updated policy and charging control rules, wherein the indication may comprise, at least, the new or updated policy and charging control rules; and applying the new or updated policy and charging control rules to the one or more protocol data unit sessions.

A computer implemented system comprising: means for causing transmitting, to a policy charging function, of a request to update or create at least one session management policy association; means for causing receiving, from the policy charging function, of a response to the transmitted request, wherein the response may comprise, at least, a correlation identifier assigned to one or more protocol data unit sessions; means for causing receiving, from the policy charging function, of an indication to update one or more protocol data unit sessions, associated with one or more correlation identifiers, with new or updated policy and charging control rules, wherein the indication may comprise, at least, the new or updated policy and charging control rules; and means for applying the new or updated policy and charging control rules to the one or more protocol data unit sessions.

In accordance with one example embodiment, an apparatus may comprise: at least one processor; and at least one memory storing instructions that, when executed by the at least one processor, cause the apparatus at least to: receive, from a session management function, at least one request to create a session management policy association, wherein the at least one request may comprise at least one of: a protocol data unit session identifier, a user equipment identifier, or a session management function identifier; transmit, to the session management function, a response to the at least one request; receive, from the session management function, a request to create a session management shared policy association for at least one of: a same data network name the apparatus and the session management function serve, or a same network slice selection assistance information the apparatus and the session management function serve; receive, from the session management function, a uniform resource locator at which the session management function may receive updates associated with the session management shared policy association; transmit, to the session management function, an indication of at least one protocol data unit session associated with the session management shared policy association; determine one or more protocol data unit sessions for which new or updated policy and charging control rules may be required, and that may be associated with session management function; and transmit, to the session management function at the uniform resource locator, an indication to update the one or more protocol data unit sessions with the new or updated policy and charging control rules, wherein the indication may comprise, at least, identifiers for the one or more protocol data unit sessions and the new or updated policy and charging control rules.

In accordance with one aspect, an example method may be provided comprising: receiving, with a policy charging function from a session management function, at least one request to create a session management policy association, wherein the at least one request may comprise at least one of: a protocol data unit session identifier, a user equipment identifier, or a session management function identifier; transmitting, to the session management function, a response to the at least one request; receiving, from the session management function, a request to create a session management shared policy association for at least one of: a same data network name the policy charging function and the session management function serve, or a same network slice selection assistance information the policy charging function and the session management function serve; receiving, from the session management function, a uniform resource locator at which the session management function may receive updates associated with the session management shared policy association; transmitting, to the session management function, an indication of at least one protocol data unit session associated with the session management shared policy association; determining one or more protocol data unit sessions for which new or updated policy and charging control rules may be required, and that may be associated with session management function; and transmitting, to the session management function at the uniform resource locator, an indication to update the one or more protocol data unit sessions with the new or updated policy and charging control rules, wherein the indication may comprise, at least, identifiers for the one or more protocol data unit sessions and the new or updated policy and charging control rules.

In accordance with one example embodiment, an apparatus may comprise: circuitry configured to perform: receiving, with a policy charging function from a session management function, at least request to create a session management policy association, wherein the at least one request may comprise at least one of: a protocol data unit session identifier, a user equipment identifier, or a session management function identifier; circuitry configured to perform: transmitting, to the session management function, a response to the at least one request; circuitry configured to perform: receiving, from the session management function, a request to create a session management shared policy association for at least one of: a same data network name the policy charging function and the session management function serve, or a same network slice selection assistance information the policy charging function and the session management function serve; circuitry configured to perform: receiving, from the session management function, a uniform resource locator at which the session management function may receive updates associated with the session management shared policy association; circuitry configured to perform: transmitting, to the session management function, an indication of at least one protocol data unit session associated with the session management shared policy association; circuitry configured to perform: determining one or more protocol data unit sessions for which new or updated policy and charging control rules may be required, and that may be associated with session management function; and circuitry configured to perform: transmitting, to the session management function at the uniform resource locator, an indication to update the one or more protocol data unit sessions with the new or updated policy and charging control rules, wherein the indication may comprise, at least, identifiers for the one or more protocol data unit sessions and the new or updated policy and charging control rules.

In accordance with one example embodiment, an apparatus may comprise: processing circuitry; memory circuitry including computer program code, the memory circuitry and the computer program code configured to, with the processing circuitry, enable the apparatus to: receive, from a session management function, at least one request to create a session management policy association, wherein the at least one request may comprise at least one of: a protocol data unit session identifier, a user equipment identifier, or a session management function identifier; transmit, to the session management function, a response to the at least one request; receive, from the session management function, a request to create a session management shared policy association for at least one of: a same data network name the apparatus and the session management function serve, or a same network slice selection assistance information the apparatus and the session management function serve; receive, from the session management function, a uniform resource locator at which the session management function may receive updates associated with the session management shared policy association; transmit, to the session management function, an indication of at least one protocol data unit session associated with the session management shared policy association; determine one or more protocol data unit sessions for which new or updated policy and charging control rules may be required, and that may be associated with session management function; and transmit, to the session management function at the uniform resource locator, an indication to update the one or more protocol data unit sessions with the new or updated policy and charging control rules, wherein the indication may comprise, at least, identifiers for the one or more protocol data unit sessions and the new or updated policy and charging control rules.

In accordance with one example embodiment, an apparatus may comprise means for: receiving, from a session management function, at least one request to create a session management policy association, wherein the at least one request may comprise at least one of: a protocol data unit session identifier, a user equipment identifier, or a session management function identifier; transmitting, to the session management function, a response to the at least one request; receiving, from the session management function, a request to create a session management shared policy association for at least one of: a same data network name the apparatus and the session management function serve, or a same network slice selection assistance information the apparatus and the session management function serve; receiving, from the session management function, a uniform resource locator at which the session management function may receive updates associated with the session management shared policy association; transmitting, to the session management function, an indication of at least one protocol data unit session associated with the session management shared policy association; determining one or more protocol data unit sessions for which new or updated policy and charging control rules may be required, and that may be associated with session management function; and transmitting, to the session management function at the uniform resource locator, an indication to update the one or more protocol data unit sessions with the new or updated policy and charging control rules, wherein the indication may comprise, at least, identifiers for the one or more protocol data unit sessions and the new or updated policy and charging control rules.

In accordance with one example embodiment, a non-transitory computer-readable medium comprising instructions stored thereon which, when executed with at least one processor, cause the at least one processor to: cause receiving, with a policy charging function from a session management function, of at least one request to create a session management policy association, wherein the at least one request may comprise at least one of: a protocol data unit session identifier, a user equipment identifier, or a session management function identifier; cause transmitting, to the session management function, of a response to the at least one request; cause receiving, from the session management function, of a request to create a session management shared policy association for at least one of: a same data network name the policy charging function and the session management function serve, or a same e network slice selection assistance information the policy charging function and the session management function serve; cause receiving, from the session management function, of a uniform resource locator at which the session management function may receive updates associated with the session management shared policy association; cause transmitting, to the session management function, of an indication of at least one protocol data unit session associated with the session management shared policy association; determine one or more protocol data unit sessions for which new or updated policy and charging control rules may be required, and that may be associated with session management function; and cause transmitting, to the session management function at the uniform resource locator, of an indication to update the one or more protocol data unit sessions with the new or updated policy and charging control rules, wherein the indication may comprise, at least, identifiers for the one or more protocol data unit sessions and the new or updated policy and charging control rules.

In accordance with one example embodiment, a non-transitory computer-readable medium comprising program instructions stored thereon for performing at least the following: causing receiving, with a policy charging function from a session management function, of at least one request to create a session management policy association, wherein the at least one request may comprise at least one of: a protocol data unit session identifier, a user equipment identifier, or a session management function identifier; causing transmitting, to the session management function, of a response to the at least one request; causing receiving, from the session management function, of a request to create a session management shared policy association for at least one of: a same data network name the policy charging function and the session management function serve, or a same network slice selection assistance information the policy charging function and the session management function serve; causing receiving, from the session management function, of a uniform resource locator at which the session management function may receive updates associated with the session management shared policy association; causing transmitting, to the session management function, of an indication of at least one protocol data unit session associated with the session management shared policy association; determining one or more protocol data unit sessions for which new or updated policy and charging control rules may be required, and that may be associated with session management function; and causing transmitting, to the session management function at the uniform resource locator, of an indication to update the one or more protocol data unit sessions with the new or updated policy and charging control rules, wherein the indication may comprise, at least, identifiers for the one or more protocol data unit sessions and the new or updated policy and charging control rules.

In accordance with another example embodiment, a non-transitory program storage device readable by a machine may be provided, tangibly embodying instructions executable by the machine for performing operations, the operations comprising: causing receiving, with a policy charging function from a session management function, of at least one request to create a session management policy association, wherein the at least one request may comprise at least one of: a protocol data unit session identifier, a user equipment identifier, or a session management function identifier; causing transmitting, to the session management function, of a response to the at least one request; causing receiving, from the session management function, of a request to create a session management shared policy association for at least one of: a same data network name the policy charging function and the session management function serve, or a same network slice selection assistance information the policy charging function and the session management function serve; causing receiving, from the session management function, of a uniform resource locator at which the session management function may receive updates associated with the session management shared policy association; causing transmitting, to the session management function, of an indication of at least one protocol data unit session associated with the session management shared policy association; determining one or more protocol data unit sessions for which new or updated policy and charging control rules may be required, and that may be associated with session management function; and causing transmitting, to the session management function at the uniform resource locator, of an indication to update the one or more protocol data unit sessions with the new or updated policy and charging control rules, wherein the indication may comprise, at least, identifiers for the one or more protocol data unit sessions and the new or updated policy and charging control rules.

In accordance with another example embodiment, a non-transitory computer-readable medium comprising instructions that, when executed by an apparatus, cause the apparatus to perform at least the following: causing receiving, with a policy charging function from a session management function, of at least one request to create a session management policy association, wherein the at least one request may comprise at least one of: a protocol data unit session identifier, a user equipment identifier, or a session management function identifier; causing transmitting, to the session management function, of a response to the at least one request; causing receiving, from the session management function, of a request to create a session management shared policy association for at least one of: a same data network name the policy charging function and the session management function serve, or a same network slice selection assistance information the policy charging function and the session management function serve; causing receiving, from the session management function, of a uniform resource locator at which the session management function may receive updates associated with the session management shared policy association; causing transmitting, to the session management function, of an indication of at least one protocol data unit session associated with the session management shared policy association; determining one or more protocol data unit sessions for which new or updated policy and charging control rules may be required, and that may be associated with session management function; and causing transmitting, to the session management function at the uniform resource locator, of an indication to update the one or more protocol data unit sessions with the new or updated policy and charging control rules, wherein the indication may comprise, at least, identifiers for the one or more protocol data unit sessions and the new or updated policy and charging control rules.

A computer implemented system comprising: at least one processor and at least one non-transitory memory storing instructions that, when executed by the at least one processor, cause the system at least to perform: causing receiving, with a policy charging function from a session management function, of at least one request to create a session management policy association, wherein the at least one request may comprise at least one of: a protocol data unit session identifier, a user equipment identifier, or a session management function identifier; causing transmitting, to the session management function, of a response to the at least one request; causing receiving, from the session management function, of a request to create a session management shared policy association for at least one of: a same data network name the policy charging function and the session management function serve, or a same network slice selection assistance information the policy charging function and the session management function serve; causing receiving, from the session management function, of a uniform resource locator at which the session management function may receive updates associated with the session management shared policy association; causing transmitting, to the session management function, of an indication of at least one protocol data unit session associated with the session management shared policy association; determining one or more protocol data unit sessions for which new or updated policy and charging control rules may be required, and that may be associated with session management function; and causing transmitting, to the session management function at the uniform resource locator, of an indication to update the one or more protocol data unit sessions with the new or updated policy and charging control rules, wherein the indication may comprise, at least, identifiers for the one or more protocol data unit sessions and the new or updated policy and charging control rules.

A computer implemented system comprising: means for causing receiving, with a policy charging function from a session management function, of at least one request to create a session management policy association, wherein the at least one request may comprise at least one of: a protocol data unit session identifier, a user equipment identifier, or a session management function identifier; means for causing transmitting, to the session management function, of a response to the at least one request; means for causing receiving, from the session management function, of a request to create a session management shared policy association for at least one of: a same data network name the policy charging function and the session management function serve, or a same network slice selection assistance information the policy charging function and the session management function serve; means for causing receiving, from the session management function, of a uniform resource locator at which the session management function may receive updates associated with the session management shared policy association; means for causing transmitting, to the session management function, of an indication of at least one protocol data unit session associated with the session management shared association; means policy for determining one or more protocol data unit sessions for which new or updated policy and charging control rules may be required, and that may be associated with session management function; and means for causing transmitting, to the session management function at the uniform resource locator, of an indication to update the one or more protocol data unit sessions with the new or updated policy and charging control rules, wherein the indication may comprise, at least, identifiers for the one or more protocol data unit sessions and the new or updated policy and charging control rules.

In accordance with one example embodiment, an apparatus may comprise: at least one processor; and at least one memory storing instructions that, when executed by the at least one processor, cause the apparatus at least to: transmit, to a policy charging function, at least one request to create a session management policy association, wherein the at least one request may comprise at least one of: a protocol data unit session identifier, a user equipment identifier, or a session management function identifier; receive, from the policy charging function, a response to the at least one request; transmit, to the policy charging function, a request to create session management shared policy association for at least one of: a same data network name the apparatus and the policy charging function serve, or a same network slice selection assistance information the apparatus and the policy charging function serve; transmit, to the policy charging function, a uniform resource locator at which updates associated with the session management shared policy association can be received; receive, from the policy charging function, an indication of at least one protocol data unit session associated with the session management shared policy association; and receive, from the policy charging function at the uniform resource locator, an indication to update one or more protocol data unit sessions with new or updated policy and charging control rules, wherein the indication may comprise, at least, identifiers for the one or more protocol data unit sessions and the new or updated policy and charging control rules.

In accordance with one aspect, an example method may be provided comprising: transmitting, with a session management function to a policy charging function, at least one request to create a session management policy association, wherein the at least one request may comprise at least one of: a protocol data unit session identifier, a user equipment identifier, or a session management identifier; function receiving, from the policy charging function, a response to the at least one request; transmitting, to the policy charging function, a request to create session management shared policy association for at least one of: a same data network name the session management function and the policy charging function serve, or a same network slice selection assistance information the session management function and the policy charging function serve; transmitting, to the policy charging function, a uniform resource locator at which updates associated with the session management shared policy association may be received; receiving, from the policy charging function, an indication of at least one protocol data unit session associated with the session management shared policy association; and receiving, from the policy charging function at the uniform resource locator, an indication to update one or more protocol data unit sessions with new or updated policy and charging control rules, wherein the indication may comprise, at least, identifiers for the one or more protocol data unit sessions and the new or updated policy and charging control rules.

In accordance with one example embodiment, an apparatus may comprise: circuitry configured to perform: transmitting, with a session management function to a policy charging function, at least one request to create a session management policy association, wherein the at least one request may comprise at least one of: a protocol data unit session identifier, a user equipment identifier, or a session management function identifier; receiving, from the policy charging function, a response to the at least one request; circuitry configured to perform: transmitting, to the policy charging function, a request to create session management shared policy association for at least one of: a same data network name the session management function and the policy charging function serve, or a same network slice selection assistance information the session management function and the policy charging function serve; circuitry configured to perform: transmitting, to the policy charging function, a uniform resource locator at which updates associated with the session management shared policy association may be received; circuitry configured to perform: receiving, from the policy charging function, an indication of at least one protocol data unit session associated with the session management shared policy association; and circuitry configured to perform: receiving, from the policy charging function at the uniform resource locator, an indication to update one or more protocol data unit sessions with new or updated policy and charging control rules, wherein the indication may comprise, at least, identifiers for the one or more protocol data unit sessions and the new or updated policy and charging control rules.

In accordance with one example embodiment, an apparatus may comprise: processing circuitry; memory circuitry including computer program code, the memory circuitry and the computer program code configured to, with the processing circuitry, enable the apparatus to: transmit, to a policy charging function, at least one request to create a session management policy association, wherein the at least one request may comprise at least one of: a protocol data unit session identifier, a user equipment identifier, or a session management function identifier; receive, from the policy charging function, a response to the at least one request; transmit, to the policy charging function, a request to create session management shared policy association for at least one of: a same data network name the apparatus and the policy charging function serve, or a same network slice selection assistance information the apparatus and the policy charging function serve; transmit, to the policy charging function, a uniform resource locator at which updates associated with the session management shared policy association can be received; receive, from the policy charging function, an indication of at least one protocol data unit session associated with the session management shared policy association; and receive, from the policy charging function at the uniform resource locator, an indication to update one or more protocol data unit sessions with new or updated policy and charging control rules, wherein the indication may comprise, at least, identifiers for the one or more protocol data unit sessions and the new or updated policy and charging control rules.

In accordance with one example embodiment, an apparatus may comprise means for: transmitting, to a policy charging function, at least one request to create a session management policy association, wherein the at least one request may comprise at least one of: a protocol data unit session identifier, a user equipment identifier, or a session management function identifier; receiving, from the policy charging function, a response to the at least one request; transmitting, to the policy charging function, a request to create session management shared policy association for at least one of: a same data network name the apparatus and the policy charging function serve, or a same network slice selection assistance information the apparatus and the policy charging function serve; transmitting, to the policy charging function, a uniform resource locator at which updates associated with the session management shared policy association may be received; receiving, from t charging function, an indication of at least one protocol data unit session associated with the session management shared policy association; and receiving, from the policy charging function at the uniform resource locator, an indication to update one or more protocol data unit sessions with new or updated policy and charging control rules, wherein the indication may comprise, at least, identifiers for the one or more protocol data unit sessions and the new or updated policy and charging control rules.

In accordance with one example embodiment, a non-transitory computer-readable medium comprising instructions stored thereon which, when executed with at least one processor, cause the at least one processor to: cause transmitting, with a session management function to a policy charging function, of at least one request to create a session management policy association, wherein the at least one request may comprise at least one of: a protocol data unit session identifier, a user equipment identifier, or a session management function identifier; cause receiving, from the policy charging function, of a response to the at least one request; cause transmitting, to the policy charging function, of a request to create session management shared policy association for at least one of: a same data network name the session management function and the policy charging function serve, or a same network slice selection assistance information the session management function and the policy charging function serve; cause transmitting, to the policy charging function, of a uniform resource locator at which updates associated with the session management association may be received; cause receiving, from the policy charging function, of an indication of at least one protocol data unit session associated with the session management shared policy association; and cause receiving, from the policy charging function at the uniform resource locator, of an indication to update one or more protocol data unit sessions with new or updated policy and charging control rules, wherein the indication may comprise, at least, identifiers for the one or more protocol data unit sessions and the new or updated policy and charging control rules.

In accordance with one example embodiment, a non-transitory computer-readable medium comprising program instructions stored thereon for performing at least the following: causing transmitting, with a session management function to a policy charging function, of at least one request to create a session management policy association, wherein the at least one request may comprise at least one of: a protocol data unit session identifier, a user equipment identifier, or a session management function identifier; causing receiving, from the policy charging function, of a response to the at least one request; causing transmitting, to the policy charging function, of a request to create session management shared policy association for at least one of: a same data network name the session management function and the policy charging function serve, or a same network slice selection assistance information the session management function and the policy charging function serve; causing transmitting, to the policy charging function, of a uniform resource locator at which updates associated with the session management shared policy association may be received; causing receiving, from the policy charging function, of an indication of at least one protocol data unit session associated with the session management shared policy association; and causing receiving, from the policy charging function at the uniform resource locator, of an indication to update one or more protocol data unit sessions with new or updated policy and charging control rules, wherein the indication may comprise, at least, identifiers for the one or more protocol data unit sessions and the new or updated policy and charging control rules.

In accordance with another example embodiment, a non-transitory program storage device readable by a machine may be provided, tangibly embodying instructions executable by the machine for performing operations, the operations comprising: causing transmitting, with a session management function to a policy charging function, of at least one request to create a session management policy association, wherein the at least one request may comprise at least one of: a protocol data unit session identifier, a user equipment identifier, or a session management function identifier; causing receiving, from the policy charging function, of a response to the at least one request; causing transmitting, to the policy charging function, of a request to create session management shared policy association for at least one of: a same data network name the session management function and the policy charging function serve, or a same network slice selection assistance information the session management function and the policy charging function serve; causing transmitting, to the policy charging function, of a uniform resource locator at which updates associated with the session management shared policy association may be received; causing receiving, from the policy charging function, of an indication of at least one protocol data unit session associated with the session management shared policy association; and causing receiving, from the policy charging function at the uniform resource locator, of an indication to update one or more protocol data unit sessions with new or updated policy and charging control rules, wherein the indication may comprise, at least, identifiers for the one or more protocol data unit sessions and the new or updated policy and charging control rules.

In accordance with another example embodiment, a non-transitory computer-readable medium comprising instructions that, when executed by an apparatus, cause the apparatus to perform at least the following: causing transmitting, with a session management function to a policy charging function, of at least one request to create a session management policy association, wherein the at least one request may comprise at least one of: a protocol data unit session identifier, a user equipment identifier, or a session management function identifier; causing receiving, from the policy charging function, of a response to the at least one request; causing transmitting, to the policy charging function, of a request to create session management shared policy association for at least one of: a same data network name the session management function and the policy charging function serve, or a same network slice selection assistance information the session management function and the policy charging function serve; causing transmitting, to the policy charging function, of a uniform resource locator at which updates associated with the session management shared policy association may be received; causing receiving, from the policy charging function, of an indication of at least one protocol data unit session associated with the session management shared policy association; and causing receiving, from the policy charging function at the uniform resource locator, of an indication to update one or more protocol data unit sessions with new or updated policy and charging control rules, wherein the indication may comprise, at least, identifiers for the one or more protocol data unit sessions and the new or updated policy and charging control rules.

A computer implemented system comprising: at least one processor and at least one non-transitory memory storing instructions that, when executed by the at least one processor, cause the system at least to perform: causing transmitting, with a session management function to a policy charging function, of at least one request to create a session management policy association, wherein the at least one request may comprise at least one of: a protocol data unit session identifier, a user equipment identifier, or a session management function identifier; causing receiving, from the policy charging function, of a response to the at least one request; causing transmitting, to the policy charging function, of a request to create session management shared policy association for at least one of: a same data network name the session management function and the policy charging function serve, or a same network slice selection assistance information the session management function and the policy charging function serve; causing transmitting, to the policy charging function, of a uniform resource locator at which updates associated with the session management shared policy association may be received; causing receiving, from the policy charging function, of an indication of at least one protocol data unit session associated with the session management shared policy association; and causing receiving, from the policy charging function at the uniform resource locator, of an indication to update one or more protocol data unit sessions with new or updated policy and charging control rules, wherein the indication may comprise, at least, identifiers for the one or more protocol data unit sessions and the new or updated policy and charging control rules.

A computer implemented system comprising: means for causing transmitting, with a session management function to a policy charging function, of at least one request to create a session management policy association, wherein the at least one request may comprise at least one of: a protocol data unit session identifier, a user equipment identifier, or a session management function identifier; means for causing receiving, from the policy charging function, of a response to the at least one request; means for causing transmitting, to the policy charging function, of a request to create session management shared policy association for at least one of: a same data network name the session management function and the policy charging function serve, or a same network slice selection assistance information the session management function and the policy charging function serve; means for causing transmitting, to the policy charging function, of a uniform resource locator at which updates associated with the session management shared policy association may be received; means for causing receiving, from the policy charging function, of an indication of at least one protocol data unit session associated with the session management shared policy association; and means for causing receiving, from the policy charging function at the uniform resource locator, of an indication to update one or more protocol data unit sessions with new or updated policy and charging control rules, wherein the indication may comprise, at least, identifiers for the one or more protocol data unit sessions and the new or updated policy and charging control rules.

In accordance with one example embodiment, an apparatus may comprise: at least one processor; and at least one memory storing instructions that, when executed by the at least one processor, cause the apparatus at least to: determine a reference corresponding to data; provide the reference and the data to a data repository; and provide at least one update to the data in the data repository using the reference.

The data may comprise traffic control data, and the reference may comprise a traffic control reference.

The data may comprise quality of service data, and the reference may comprise a quality of service reference.

The data repository may comprise a unified data repository.

In accordance with one aspect, an example method may be provided comprising: determining, with an application function, a reference corresponding to data; providing the reference and the data to a data repository; and providing at least one update to the data in the data repository using the reference.

The data may comprise traffic control data, and the reference may comprise a traffic control reference.

The data may comprise quality of service data, and the reference may comprise a quality of service reference.

The data repository may comprise a unified data repository.

In accordance with one example embodiment, an apparatus may comprise: circuitry configured to perform: determining, with an application function, a reference corresponding to data; circuitry configured to perform: providing the reference and the data to a data repository; and circuitry configured to perform: providing at least one update to the data in the data repository using the reference.

In accordance with one example embodiment, an apparatus may comprise: processing circuitry; memory circuitry including computer program code, the memory circuitry and the computer program code configured to, with the processing circuitry, enable the apparatus to: determine a reference corresponding to data; provide the reference and the data to a data repository; and provide at least one update to the data in the data repository using the reference.

In accordance with one example embodiment, an apparatus may comprise means for: determining a reference corresponding to data; providing the reference and the data to a data repository; and providing at least one update to the data in the data repository using the reference.

The data may comprise traffic control data, and the reference may comprise a traffic control reference.

The data may comprise quality of service data, and the reference may comprise a quality of service reference.

The data repository may comprise a unified data repository.

In accordance with one example embodiment, a non-transitory computer-readable medium comprising instructions stored thereon which, when executed with at least one processor, cause the at least one processor to: determine a reference corresponding to data; cause providing of the reference and the data to a data repository; and cause providing of at least one update to the data in the data repository using the reference.

In accordance with one example embodiment, a non-transitory computer-readable medium comprising program instructions stored thereon for performing at least the following: determining a reference corresponding to data; causing providing of the reference and the data to a data repository; and causing providing of at least one update to the data in the data repository using the reference.

In accordance with another example embodiment, a non-transitory program storage device readable by a machine may be provided, tangibly embodying instructions executable by the machine for performing operations, the operations comprising: determining a reference corresponding to data; causing providing of the reference and the data to a data repository; and causing providing of at least one update to the data in the data repository using the reference.

In accordance with another example embodiment, a non-transitory computer-readable medium comprising instructions that, when executed by an apparatus, cause the apparatus to perform at least the following: determining a reference corresponding to data; causing providing of the reference and the data to a data repository; and causing providing of at least one update to the data in the data repository using the reference.

A computer implemented system comprising: at least one processor and at least one non-transitory memory storing instructions that, when executed by the at least one processor, cause the system at least to perform: determining a reference corresponding to data; causing providing of the reference and the data to a data repository; and causing providing of at least one update to the data in the data repository using the reference.

A computer implemented system comprising: means for determining a reference corresponding to data; means for causing providing of the reference and the data to a data repository; and means for causing providing of at least one update to the data in the data repository using the reference.

In accordance with one example embodiment, an apparatus may comprise: at least one processor; and at least one memory storing instructions that, when executed by the at least one processor, cause the apparatus at least to: transmit, to a data repository, a request to subscribe to data stored in the data repository; receive, from the data repository, at least one notification of the data; and determine an update to the data based, at least partially, on the at least one notification.

The data may comprise traffic control data.

The data may comprise quality of service data.

The apparatus may be configured with at least one policy and charging control rule, wherein the at least one policy and charging control rule may be configured to reference, at least, the data and a packet flow descriptor via an application identifier, wherein the packet flow descriptor may comprise at least one of: a 5G quality of service indicator, a guaranteed bandwidth, a maximum bandwidth, an allocation and retention priority, a gate status, a data network access identifier, or N6 traffic routing information associated with respective data network access identifiers.

The data repository may comprise a unified data repository.

In accordance with one aspect, an example method may be provided comprising: transmitting, with a session management function to a data repository, a request to subscribe to data stored in the data repository; receiving, from the data repository, at least one notification of the data; and determining an update to the data based, at least partially, on the at least one notification.

The data may comprise traffic control data.

The data may comprise quality of service data.

The session management function may be configured with at least one policy and charging control rule, wherein the at least one policy and charging control rule may be configured to reference, at least, the data and a packet flow descriptor via an application identifier, wherein the packet flow descriptor may comprise at least one of: a 5G quality of service indicator, a guaranteed bandwidth, a maximum bandwidth, an allocation and retention priority, a gate status, a data network access identifier, or N6 traffic routing information associated with respective data network access identifiers.

The data repository may comprise a unified data repository.

In accordance with one example embodiment, an apparatus may comprise: circuitry configured to perform: transmitting, with a session management function to a data repository, a request to subscribe to data stored in the data repository; circuitry configured to perform: receiving, from the data repository, at least one notification of the data; and circuitry configured to perform: determining an update to the data based, at least partially, on the at least one notification.

In accordance with one example embodiment, an apparatus may comprise: processing circuitry; memory circuitry including computer program code, the memory circuitry and the computer program code configured to, with the processing circuitry, enable the apparatus to: transmit, to a data repository, a request to subscribe to data stored in the data repository; receive, from the data repository, at least one notification of the data; and determine an update to the data based, at least partially, on the at least one notification.

In accordance with one example embodiment, an apparatus may comprise means for: transmitting, to a data repository, a request to subscribe to data stored in the data repository; receiving, from the data repository, at least one notification of the data; and determining an update to the data based, at least partially, on the at least one notification.

The data may comprise traffic control data.

The data may comprise quality of service data.

The apparatus may be configured with at least one policy and charging control rule, wherein the at least one policy and charging control rule may be configured to reference, at least, the data and a packet flow descriptor via an application identifier, wherein the packet flow descriptor may comprise at least one of: a 5G quality of service indicator, a guaranteed bandwidth, a maximum bandwidth, an allocation and retention priority, a gate status, a data network access identifier, or N6 traffic routing information associated with respective data network access identifiers.

The data repository may comprise a unified data repository.

In accordance with one example embodiment, a non-transitory computer-readable medium comprising instructions stored thereon which, when executed with at least one processor, cause the at least one processor to: cause transmitting, to a data repository, of a request to subscribe to data stored in the data repository; cause receiving, from the data repository, of at least one notification of the data; and determine an update to the data based, at least partially, on the at least one notification.

In accordance with one example embodiment, a non-transitory computer-readable medium comprising program instructions stored thereon for performing at least the following: causing transmitting, to a data repository, of a request to subscribe to data stored in the data repository; causing receiving, from the data repository, of at least one notification of the data; and determining an update to the data based, at least partially, on the at least one notification.

In accordance with another example embodiment, a non-transitory program storage device readable by a machine may be provided, tangibly embodying instructions executable by the machine for performing operations, the operations comprising: causing transmitting, to a data repository, of a request to subscribe to data stored in the data repository; causing receiving, from the data repository, of at least one notification of the data; and determining an update to the data based, at least partially, on the at least one notification.

In accordance with another example embodiment, a non-transitory computer-readable medium comprising instructions that, when executed by an apparatus, cause the apparatus to perform at least the following: causing transmitting, to a data repository, of a request to subscribe to data stored in the data repository; causing receiving, from the data repository, of at least one notification of the data; and determining an update to the data based, at least partially, on the at least one notification.

A computer implemented system comprising: at least one processor and at least one non-transitory memory storing instructions that, when executed by the at least one processor, cause the system at least to perform: causing transmitting, to a data repository, of a request to subscribe to data stored in the data repository; causing receiving, from the data repository, of at least one notification of the data; and determining an update to the data based, at least partially, on the at least one notification.

A computer implemented system comprising: means for causing transmitting, to a data repository, of a request to subscribe to data stored in the data repository; means for causing receiving, from the data repository, of at least one notification of the data; and means for determining an update to the data based, at least partially, on the at least one notification.

In accordance with one example embodiment, an apparatus may comprise: at least one processor; and at least one memory storing instructions that, when executed by the at least one processor, cause the apparatus at least to: receive data and a reference corresponding to the data; store the data in association with the reference; receive, from a session management function, a request to subscribe to the stored data; and transmit, to the session management function, at least one notification of the data in response to a determination that the data is authorized.

The data may comprise traffic control data, wherein the reference may comprise a traffic control reference.

The data may comprise quality of service data, wherein the reference may comprise a quality of service reference.

The example apparatus may be further configured to: receive at least one policy and charging control rule for the data using the reference corresponding to the data.

The at least one policy and charging control rule may be configured to reference a packet flow descriptor via an application identifier, wherein the packet flow descriptor may comprise at least one of: a 5G quality of service indicator, a guaranteed bandwidth, a maximum bandwidth, an allocation and retention priority, a gate status, a data network access identifier, or N6 traffic routing information associated with respective data network access identifiers.

The example apparatus may be further configured to: receive at least one update to the data, wherein the at least one update may comprise, at least, the reference corresponding to the data; and transmit, to the session management function, a notification of the at least one update to the data in response to a determination that the at least one update is authorized.

The at least one update may be received from at least one of: an application function, or a policy charging function.

The data may be received from at least one of: an application function, or a policy charging function.

The example apparatus may be further configured to: determine that the data is authorized based, at least partially, on a flag configured to be set by a policy charging function.

In accordance with one aspect, an example method may be provided comprising: receiving, with a unified data repository, data and a reference corresponding to the data; storing the data in association with the reference; receiving, from a session management function, a request to subscribe to the stored data; and transmitting, to the session management function, at least one notification of the data in response to a determination that the data is authorized.

The data may comprise traffic control data, and the reference may comprise a traffic control reference.

The data may comprise quality of service data, and the reference may comprise a quality of service reference.

The example method may further comprise: receiving at least one policy and charging control rule for the data using the reference corresponding to the data.

The at least one policy and charging control rule may be configured to reference a packet flow descriptor via an application identifier, wherein the packet flow descriptor may comprise at least one of: a 5G quality of service indicator, a guaranteed bandwidth, a maximum bandwidth, an allocation and retention priority, a gate status, a data network access identifier, or N6 traffic routing information associated with respective data network access identifiers.

The example method may further comprise: receiving at least one update to the data, wherein the at least one update may comprise, at least, the reference corresponding to the data; and transmitting, to the session management function, a notification of the at least one update to the data in response to a determination that the at least one update is authorized.

The at least one update may be received from at least one of: an application function, or a policy charging function.

The data may be received from at least one of: an application function, or a policy charging function.

The example method may further comprise: determining that the data is authorized based, at least partially, on a flag configured to be set by a policy charging function.

In accordance with one example embodiment, an apparatus may comprise: circuitry configured to perform: receiving data and a reference corresponding to the data; circuitry configured to perform: storing the data in association with the reference; circuitry configured to perform: receiving, from a session management function, a request to subscribe to the stored data; and circuitry configured to perform: transmitting, to the session management function, at least one notification of the data in response to a determination that the data is authorized.

In accordance with one example embodiment, an apparatus may comprise: processing circuitry; memory circuitry including computer program code, the memory circuitry and the computer program code configured to, with the processing circuitry, enable the apparatus to: receive data and a reference corresponding to the data; store the data in association with the reference; receive, from a session management function, a request to subscribe to the stored data; and transmit, to the session management function, at least one notification of the data in response to a determination that the data is authorized.

In accordance with one example embodiment, an apparatus may comprise means for: receiving data and a reference corresponding to the data; storing the data in association with the reference; receiving, from a session management function, a request to subscribe to the stored data; and transmitting, to the session management function, at least one notification of the data in response to a determination that the data is authorized.

The data may comprise traffic control data, and the reference may comprise a traffic control reference.

The data may comprise quality of service data, and the reference may comprise a quality of service reference.

The means may be further configured for: receiving at least one policy and charging control rule for the data using the reference corresponding to the data.

The at least one policy and charging control rule may be configured to reference a packet flow descriptor via an application identifier, wherein the packet flow descriptor may comprise at least one of: a 5G quality of service indicator, a guaranteed bandwidth, a maximum bandwidth, an allocation and retention priority, a gate status, a data network access identifier, or N6 traffic routing information associated with respective data network access identifiers.

The means may be further configured for: receiving at least one update to the data, wherein the at least one update may comprise, at least, the reference corresponding to the data; and transmitting, to the session management function, a notification of the at least one update to the data in response to a determination that the at least one update is authorized.

The at least one update may be received from at least one of: an application function, or a policy charging function.

The data may be received from at least one of: an application function, or a policy charging function.

The means may be further configured for: determining that the data is authorized based, at least partially, on a flag configured to be set by a policy charging function.

In accordance with one example embodiment, a non-transitory computer-readable medium comprising instructions stored thereon which, when executed with at least one processor, cause the at least one processor to: cause receiving of data and a reference corresponding to the data; cause storing of the data in association with the reference; cause receiving, from a session management function, of a request to subscribe to the stored data; and cause transmitting, to the session management function, of at least one notification of the data in response to a determination that the data is authorized.

In accordance with one example embodiment, a non-transitory computer-readable medium comprising program instructions stored thereon for performing at least the following: causing receiving of data and a reference corresponding to the data; causing storing of the data in association with the reference; causing receiving, from a session management function, of a request to subscribe to the stored data; and causing transmitting, to the session management function, of at least one notification of the data in response to a determination that the data is authorized.

In accordance with another example embodiment, a non-transitory program storage device readable by a machine may be provided, tangibly embodying instructions executable by the machine for performing operations, the operations comprising: causing receiving of data and a reference corresponding to the data; causing storing of the data in association with the reference; causing receiving, from a session management function, of a request to subscribe to the stored data; and causing transmitting, to the session management function, of at least one notification of the data in response to a determination that the data is authorized.

In accordance with another example embodiment, a non-transitory computer-readable medium comprising instructions that, when executed by an apparatus, cause the apparatus to perform at least the following: causing receiving of data and a reference corresponding to the data; causing storing of the data in association with the reference; causing receiving, from a session management function, of a request to subscribe to the stored data; and causing transmitting, to the session management function, of at least one notification of the data in response to a determination that the data is authorized.

A computer implemented system comprising: at least one processor and at least one non-transitory memory storing instructions that, when executed by the at least one processor, cause the system at least to perform: causing receiving of data and a reference corresponding to the data; causing storing of the data in association with the reference; causing receiving, from a session management function, of a request to subscribe to the stored data; and causing transmitting, to the session management function, of at least one notification of the data in response to a determination that the data is authorized.

A computer implemented system comprising: means for causing receiving of data and a reference corresponding to the data; means for causing storing of the data in association with the reference; means for causing receiving, from a session management function, of a request to subscribe to the stored data; and means for causing transmitting, to the session management function, of at least one notification of the data in response to a determination that the data is authorized.

In accordance with one example embodiment, an apparatus may comprise: at least one processor; and at least one memory storing instructions that, when executed by the at least one processor, cause the apparatus at least to: provide an indication that data stored at a data repository is authorized; and transmit, to the data repository, at least one update to the data using a reference stored in association with the data.

The data may comprise traffic control data, and the reference may comprise a traffic control reference.

The data may comprise quality of service data, and the reference may comprise a quality of service reference.

The example apparatus may be further configured to: provide at least one policy and charging control rule for the data using the reference corresponding to the data.

The at least one policy and charging control rule may be configured to reference a packet flow descriptor via an application identifier, wherein the packet flow descriptor may comprise at least one of: a 5G quality of service indicator, a guaranteed bandwidth, a maximum bandwidth, an allocation and retention priority, a gate status, a data network access identifier, or N6 traffic routing information associated with respective data network access identifiers.

The indication that the data stored at the data repository is authorized may comprise a flag.

The example apparatus may be further configured to: provide the reference and the data to the data repository.

The example apparatus may be further configured to: transmit, to the data repository, a request to subscribe to the data; receive, from the data repository, at least one notification of the data; and determine whether to authorize the data in response to the at least one notification.

In accordance with one aspect, an example method may be provided comprising: providing, with a policy charging function, an indication that data stored at a data repository is authorized; and transmitting, to the data repository, at least one update to the data using a reference stored in association with the data.

The data may comprise traffic control data, and the reference may comprise a traffic control reference.

The data may comprise quality of service data, and the reference may comprise a quality of service reference.

The example method may further comprise: providing at least one policy and charging control rule for the data using the reference corresponding to the data.

The at least one policy and charging control rule may be configured to reference a packet flow descriptor via an application identifier, wherein the packet flow descriptor may comprise at least one of: a 5G quality of service indicator, a guaranteed bandwidth, a maximum bandwidth, an allocation and retention priority, a gate status, a data network access identifier, or N6 traffic routing information associated with respective data network access identifiers.

The indication that the data stored at the data repository is authorized may comprise a flag.

The example method may further comprise: providing the reference and the data to the data repository.

The example method may further comprise: transmitting, to the data repository, a request to subscribe to the data; receiving, from the data repository, at least one notification of the data; and determining whether to authorize the data in response to the at least one notification.

In accordance with one example embodiment, an apparatus may comprise: circuitry configured to perform: providing an indication that data stored at a data repository is authorized; and circuitry configured to perform: transmitting, to the data repository, at least one update to the data using a reference stored in association with the data.

In accordance with one example embodiment, an apparatus may comprise: processing circuitry; memory circuitry including computer program code, the memory circuitry and the computer program code configured to, with the processing circuitry, enable the apparatus to: provide an indication that data stored at a data repository is authorized; and transmit, to the data repository, at least one update to the data using a reference stored in association with the data.

In accordance with one example embodiment, an apparatus may comprise means for: providing an indication that data stored at a data repository is authorized; and transmitting, to the data repository, at least one update to the data using a reference stored in association with the data.

The data may comprise traffic control data, and the reference may comprise a traffic control reference.

The data may comprise quality of service data, and the reference may comprise a quality of service reference.

The means may be further configured for: providing at least one policy and charging control rule for the data using the reference corresponding to the data.

The at least one policy and charging control rule may be configured to reference a packet flow descriptor via an application identifier, wherein the packet flow descriptor may comprise at least one of: a 5G quality of service indicator, a guaranteed bandwidth, a maximum bandwidth, an allocation and retention priority, a gate status, a data network access identifier, or N6 traffic routing information associated with respective data network access identifiers.

The indication that the data stored at the data repository is authorized may comprise a flag.

The means may be further configured for: providing the reference and the data to the data repository.

The means may be further configured for: transmitting, to the data repository, a request to subscribe to the data; receiving, from the data repository, at least one notification of the data; and determining whether to authorize the data in response to the at least one notification.

In accordance with one example embodiment, a non-transitory computer-readable medium comprising instructions stored thereon which, when executed with at least one processor, cause the at least one processor to: cause providing of an indication that data stored at a data repository is authorized; and cause transmitting, to the data repository, of at least one update to the data using a reference stored in association with the data.

In accordance with one example embodiment, a non-transitory computer-readable medium comprising program instructions stored thereon for performing at least the following: causing providing of an indication that data stored at a data repository is authorized; and causing transmitting, to the data repository, of at least one update to the data using a reference stored in association with the data.

In accordance with another example embodiment, a non-transitory program storage device readable by a machine may be provided, tangibly embodying instructions executable by the machine for performing operations, the operations comprising: causing providing of an indication that data stored at a data repository is authorized; and causing transmitting, to the data repository, of at least one update to the data using a reference stored in association with the data.

In accordance with another example embodiment, a non-transitory computer-readable medium comprising instructions that, when executed by an apparatus, cause the apparatus to perform at least the following: causing providing of an indication that data stored at a data repository is authorized; and causing transmitting, to the data repository, of at least one update to the data using a reference stored in association with the data.

A computer implemented system comprising: at least one processor and at least one non-transitory memory storing instructions that, when executed by the at least one processor, cause the system at least to perform: causing providing of an indication that data stored at a data repository is authorized; and causing transmitting, to the data repository, of at least one update to the data using a reference stored in association with the data.

A computer implemented system comprising: means for causing providing of an indication that data stored at a data repository is authorized; and means for causing transmitting, to the data repository, of at least one update to the data using a reference stored in association with the data.

In accordance with one example embodiment, an apparatus may comprise: at least one processor; and at least one memory storing instructions that, when executed by the at least one processor, cause the apparatus at least to: receive, from a session management function, a request to create a session management shared policy association for at least one of: a same data network name the apparatus and the session management function serve, or a same network slice selection assistance information the apparatus and the session management function serve; receive, from the session management function, a uniform resource locator at which the session management function may receive updates associated with the session management shared policy association; transmit, to the session management function, a response to the request, wherein the response may comprise, at least, one or more policy and charging control rules, wherein the one or more policy and charging control rules respectively may comprise a reference to a shared structure; receive, from the session management function, at least one request to create a session management policy association for a protocol data unit, wherein the at least one request may comprise at least one of: a protocol data unit session identifier, a user equipment identifier, or a session management function identifier; transmit, to the session management function, at least one policy and charging control rule associated with the session management policy association, and at least one reference to the at least one policy and charging control rule in the shared structure; determine one or more protocol data unit sessions for which new or updated policy and charging control rules are required; update the shared structure based on at least one of the one or more determined protocol data unit sessions; and transmit, to the session management function at the uniform resource locator, an indication that the shared structure has been updated.

In accordance with one aspect, an example method may be provided comprising: receiving, with a policy charging function from a session management function, a request to create a session management shared policy association for at least one of: a same data network name the policy charging function and the session management function serve, or a same network slice selection assistance information the policy charging function and the session management function serve; receiving, from the session management function, a uniform resource locator at which the session management function may receive updates associated with the session management shared policy association; transmitting, to the session management function, a response to the request, wherein the response may comprise, at least, one or more policy and charging control rules, wherein the one or more policy and charging control rules respectively may comprise a reference to a shared structure; receiving, from the session management function, at least one request to create a session management policy association for a protocol data unit, wherein the at least one request may comprise at least one of: a protocol data unit session identifier, a user equipment identifier, or a session management function identifier; transmitting, to the session management function, at least one policy and charging control rule associated with the session management policy association, and at least one reference to the at least one policy and charging control rule in the shared structure; determining one or more protocol data unit sessions for which new or updated policy and charging control rules may be required; updating the shared structure based on at least one of the one or more determined protocol data unit sessions; and transmitting, to the session management function at the uniform resource locator, an indication that the shared structure has been updated.

In accordance with one example embodiment, an apparatus may comprise: circuitry configured to perform: receiving, with a policy charging function from a session management function, a request to create a session management shared policy association for at least one of: a same data network name the policy charging function and the session management function serve, or a same network slice selection assistance information the policy charging function and the session management function serve; circuitry configured to perform: receiving, from the session management function, a uniform resource locator at which the session management function may receive updates associated with the session management shared policy association; circuitry configured to perform: transmitting, to the session management function, a response to the request, wherein the response may comprise, at least, one or more policy and charging control rules, wherein the one or more policy and charging control rules respectively may comprise a reference to a shared structure; circuitry configured to perform: receiving, from the session management function, at least one request to create a session management policy association for a protocol data unit, wherein the at least one request may comprise at least one of: a protocol data unit session identifier, a user equipment identifier, or a session management function identifier; circuitry configured to perform: transmitting, to the session management function, at least one policy and charging control rule associated with the session management policy association, and at least one reference to the at least one policy and charging control rule in the shared structure; circuitry configured to perform: determining one or more protocol data unit sessions for which new or updated policy and charging control rules may be required; circuitry configured to perform: updating the shared structure based on at least one of the one or more determined protocol data unit sessions; and circuitry configured to perform: transmitting, to the session management function at the uniform resource locator, an indication that the shared structure has been updated.

In accordance with one example embodiment, an apparatus may comprise: processing circuitry; memory circuitry including computer program code, the memory circuitry and the computer program code configured to, with the processing circuitry, enable the apparatus to: receive, from a session management function, a request to create a session management shared policy association for at least one of: a same data network name the apparatus and the session management function serve, or a same network slice selection assistance information the apparatus and the session management function serve; receive, from the session management function, a uniform resource locator at which the session management function may receive updates associated with the session management shared policy association; transmit, to the session management function, a response to the request, wherein the response may comprise, at least, one or more policy and charging control rules, wherein the one or more policy and charging control rules respectively may comprise a reference to a shared structure; receive, from the session management function, at least one request to create a session management policy association for a protocol data unit, wherein the at least one request may comprise at least one of: a protocol data unit session identifier, a user equipment identifier, or a session management function identifier; transmit, to the session management function, at least one policy and charging control rule associated with the session management policy association, and at least one reference to the at least one policy and charging control rule in the shared structure; determine one or more protocol data unit sessions for which new or updated policy and charging control rules are required; update the shared structure based on at least one of the one or more determined protocol data unit sessions; and transmit, to the session management function at the uniform resource locator, an indication that the shared structure has been updated.

In accordance with one example embodiment, an apparatus may comprise means for: receiving, from a session management function, a request to create a session management shared policy association for at least one of: a same data network name the apparatus and the session management function serve, or a same network slice selection assistance information the apparatus and the session management function serve; receiving, from the session management function, a uniform resource locator at which the session management function can receive updates associated with the session management shared policy association; transmitting, to the session management function, a response to the request, wherein the response may comprise, at least, one or more policy and charging control rules, wherein the one or more policy and charging control rules respectively may comprise a reference to a shared structure; receiving, from the session management function, at least one request to create a session management policy association for a protocol data unit, wherein the at least one request may comprise at least one of: a protocol data unit session identifier, a user equipment identifier, or a session management function identifier; transmitting, to the session management function, at least one policy and charging control rule associated with the session management policy association, and at least one reference to the at least one policy and charging control rule in the shared structure; determining one or more protocol data unit sessions for which new or updated policy and charging control rules may be required; updating the shared structure based on at least one of the one or more determined protocol data unit sessions; and transmitting, to the session management function at the uniform resource locator, an indication that the shared structure has been updated.

In accordance with one example embodiment, a non-transitory computer-readable medium comprising instructions stored thereon which, when executed with at least one processor, cause the at least one processor to: cause receiving, with a policy charging function from a session management function, of a request to create a session management shared policy association for at least one of: a same data network name the policy charging function and the session management function serve, or a same network slice selection assistance information the policy charging function and the session management function serve; cause receiving, from the session management function, of a uniform resource locator at which the session management function may receive updates associated with the session management shared policy association; cause transmitting, to the session management function, of a response to the request, wherein the response may comprise, at least, one or more policy and charging control rules, wherein the one or more policy and charging control rules respectively may comprise a reference to a shared structure; cause receiving, from the session management function, of at least one request to create a session management policy association for a protocol data unit, wherein the at least one request may comprise at least one of: a protocol data unit session identifier, a user equipment identifier, or a session management function identifier; cause transmitting, to the session management function, of at least one policy and charging control rule associated with the session management policy association, and at least one reference to the at least one policy and charging control rule in the shared structure; determine one or more protocol data unit sessions for which new or updated policy and charging control rules may be required; update the shared structure based on at least one of the one or more determined protocol data unit sessions; and cause transmitting, to the session management function at the uniform resource locator, of an indication that the shared structure has been updated.

In accordance with one example embodiment, a non-transitory computer-readable medium comprising program instructions stored thereon for performing at least the following: causing receiving, with a policy charging function from a session management function, of a request to create a session management shared policy association for at least one of: a same data network name the policy charging function and the session management function serve, or a same network slice selection assistance information the policy charging function and the session management function serve; causing receiving, from the session management function, of a uniform resource locator at which the session management function may receive updates associated with the session management shared policy association; causing transmitting, to the session management function, of a response to the request, wherein the response may comprise, at least, one or more policy and charging control rules, wherein the one or more policy and charging control rules respectively may comprise a reference to a shared structure; causing receiving, from the session management function, of at least one request to create a session management policy association for a protocol data unit, wherein the at least one request may comprise at least one of: a protocol data unit session identifier, a user equipment identifier, or a session management function identifier; causing transmitting, to the session management function, of at least one policy and charging control rule associated with the session management policy association, and at least one reference to the at least one policy and charging control rule in the shared structure; determining one or more protocol data unit sessions for which new or updated policy and charging control rules may be required; updating the shared structure based on at least one of the one or more determined protocol data unit sessions; and causing transmitting, to the session management function at the uniform resource locator, of an indication that the shared structure has been updated.

In accordance with another example embodiment, a non-transitory program storage device readable by a machine may be provided, tangibly embodying instructions executable by the machine for performing operations, the operations comprising: causing receiving, with a policy charging function from a session management function, of a request to create a session management shared policy association for at least one of: a same data network name the policy charging function and the session management function serve, or a same network slice selection assistance information the policy charging function and the session management function serve; causing receiving, from the session management function, of a uniform resource locator at which the session management function may receive updates associated with the session management shared policy association; causing transmitting, to the session management function, of a response to the request, wherein the response may comprise, at least, one or more policy and charging control rules, wherein the one or more policy and charging control rules respectively may comprise a reference to a shared structure; causing receiving, from the session management function, of at least one request to create a session management policy association for a protocol data unit, wherein the at least one request may comprise at least one of: a protocol data unit session identifier, a user equipment identifier, or a session management function identifier; causing transmitting, to the session management function, of at least one policy and charging control rule associated with the session management policy association, and at least one reference to the at least one policy and charging control rule in the shared structure; determining one or more protocol data unit sessions for which new or updated policy and charging control rules may be required; updating the shared structure based on at least one of the one or more determined protocol data unit sessions; and causing transmitting, to the session management function at the uniform resource locator, of an indication that the shared structure has been updated.

In accordance with another example embodiment, a non-transitory computer-readable medium comprising instructions that, when executed by an apparatus, cause the apparatus to perform at least the following: causing receiving, with a policy charging function from a session management function, of a request to create a session management shared policy association for at least one of: a same data network name the policy charging function and the session management function serve, or a same network slice selection assistance information the policy charging function and the session management function serve; causing receiving, from the session management function, of a uniform resource locator at which the session management function may receive updates associated with the session management shared policy association; causing transmitting, to the session management function, of a response to the request, wherein the response may comprise, at least, one or more policy and charging control rules, wherein the one or more policy and charging control rules respectively may comprise a reference to a shared structure; causing receiving, from the session management function, of at least one request to create a session management policy association for a protocol data unit, wherein the at least one request may comprise at least one of: a protocol data unit identifier, a session user equipment identifier, or a session management function identifier; causing transmitting, to the session management function, of at least one policy and charging control rule associated with the session management policy association, and at least one reference to the at least one policy and charging control rule in the shared structure; determining one or more protocol data unit sessions for which new or updated policy and charging control rules may be required; updating the shared structure based on at least one of the one or more determined protocol data unit sessions; and causing transmitting, to the session management function at the uniform resource locator, of an indication that the shared structure has been updated.

A computer implemented system comprising: at least one processor and at least one non-transitory memory storing instructions that, when executed by the at least one processor, cause the system at least to perform: causing receiving, with a policy charging function from a session management function, of a request to create a session management shared policy association for at least one of: a same data network name the policy charging function and the session management function serve, or a same network slice selection assistance information the policy charging function and the session management function serve; causing receiving, from the session management function, of a uniform resource locator at which the session management function may receive updates associated with the session management shared policy association; causing transmitting, to the session management function, of a response to the request, wherein the response may comprise, at least, one or more policy and charging control rules, wherein the one or more policy and charging control rules respectively may comprise a reference to a shared structure; causing receiving, from the session management function, of at least one request to create a session management policy association for a protocol data unit, wherein the at least one request may comprise at least one of: a protocol data unit session identifier, a user equipment identifier, or a session management function identifier; causing transmitting, to the session management function, of at least one policy and charging control rule associated with the session management policy association, and at least one reference to the at least one policy and charging control rule in the shared structure; determining one or more protocol data unit sessions for which new or updated policy and charging control rules may be required; updating the shared structure based on at least one of the one or more determined protocol data unit sessions; and causing transmitting, to the session management function at the uniform resource locator, of an indication that the shared structure has been updated.

A computer implemented system comprising: means for causing receiving, with a policy charging function from a session management function, of a request to create a session management shared policy association for at least one of: a same data network name the policy charging function and the session management function serve, or a same network slice selection assistance information the policy charging function and the session management function serve; means for causing receiving, from the session management function, of a uniform resource locator at which the session management function may receive updates associated with the session management shared policy association; means for causing transmitting, to the session management function, of a response to the request, wherein the response may comprise, at least, one or more policy and charging control rules, wherein the one or more policy and charging control rules respectively may comprise a reference to a shared structure; means for causing receiving, from the session management function, of at least one request to create a session management policy association for a protocol data unit, wherein the at least one request may comprise at least one of: a protocol data unit session identifier, a user equipment identifier, or a session management function identifier; means for causing transmitting, to the session management function, of at least one policy and charging control rule associated with the session management policy association, and at least one reference to the at least one policy and charging control rule in the shared structure; means for determining one or more protocol data unit sessions for which new or updated policy and charging control rules may be required; means for updating the shared structure based on at least one of the one or more determined protocol data unit sessions; and means for causing transmitting, to the session management function at the uniform resource locator, of an indication that the shared structure has been updated.

In accordance with one example embodiment, an apparatus may comprise: at least one processor; and at least one memory storing instructions that, when executed by the at least one processor, cause the apparatus at least to: transmit, to a policy charging function, a request to create a session management shared policy association for at least one of: a same data network name the apparatus and the policy charging function serve, or a same network slice selection assistance information the apparatus and the policy charging function serve; transmit, to the policy charging function, a uniform resource locator at which updates associated with the session management shared policy association may be received; receive, from the policy charging function, a response to the request, wherein the response may comprise, at least, one or more policy and charging control rules, wherein the one or more policy and charging control rules respectively may comprise a reference to a shared structure; transmit, to the policy charging function, at least one request to create a session management policy association for a protocol data unit, wherein the at least one request may comprise at least one of: a protocol data unit session identifier, a user equipment identifier, or a session management function identifier; receive, from the policy charging function, at least one policy and charging control rule associated with the session management policy association, and at least one reference to the at least one policy and charging control rule in the shared structure; and receive, from the policy charging function at the uniform resource locator, an indication that the shared structure has been updated.

In accordance with one aspect, an example method may be provided comprising: transmitting, with a session management function to a policy charging function, a request to create a session management shared policy association for at least one of: a same data network name the session management function and the policy charging function serve, or a same network slice selection assistance information the session management function and the policy charging function serve; transmitting, to the policy charging function, a uniform resource locator at which updates associated with the session management shared policy association may be received; receiving, from the policy charging function, a response to the request, wherein the response may comprise, at least, one or more policy and charging control rules, wherein the one or more policy and charging control rules respectively may comprise a reference to a shared structure; transmitting, to the policy charging function, at least one request to create a session management policy association for a protocol data unit, wherein the at least one request may comprise at least one of: a protocol data unit session identifier, a user equipment identifier, or a session management function identifier; receiving, from the policy charging function, at least one policy and charging control rule associated with the session management policy association, and at least one reference to the at least one policy and charging control rule in the shared structure; and receiving, from the policy charging function at the uniform resource locator, an indication that the shared structure has been updated.

In accordance with one example embodiment, an apparatus may comprise: circuitry configured to perform: transmitting, with a session management function to a policy charging function, a request to create a session management shared policy association for at least one of: a same data network name the session management function and the policy charging function serve, or a same network slice selection assistance information the session management function and the policy charging function serve; circuitry configured to perform: transmitting, to the policy charging function, a uniform resource locator at which updates associated with the session management shared policy association may be received; circuitry configured to perform: receiving, from the policy charging function, a response to the request, wherein the response may comprise, at least, one or more policy and charging control rules, wherein the one or more policy and charging control rules respectively may comprise a reference to a shared structure; circuitry configured to perform: transmitting, to the policy charging function, at least one request to create a session management policy association for a protocol data unit, wherein the at least one request may comprise at least one of: a protocol data unit session identifier, a user equipment identifier, or a session management function identifier; circuitry configured to perform: receiving, from the policy charging function, at least one policy and charging control rule associated with the session management policy association, and at least one reference to the at least one policy and charging control rule in the shared structure; and circuitry configured to perform: receiving, from the policy charging function at the uniform resource locator, an indication that the shared structure has been updated.

In accordance with one example embodiment, an apparatus may comprise: processing circuitry; memory circuitry including computer program code, the memory circuitry and the computer program code configured to, with the processing circuitry, enable the apparatus to: transmit, to a policy charging function, a request to create a session management shared policy association for at least one of: a same data network name the apparatus and the policy charging function serve, or a same network slice selection assistance information the apparatus and the policy charging function serve; transmit, to the policy charging function, a uniform resource locator at which updates associated with the session management shared policy association may be received; receive, from the policy charging function, a response to the request, wherein the response may comprise, at least, one or more policy and charging control rules, wherein the one or more policy and charging control rules respectively may comprise a reference to a shared structure; transmit, to the policy charging function, at least one request to create a session management policy association for a protocol data unit, wherein the at least one request may comprise at least one of: a protocol data unit session identifier, a user equipment identifier, or a session management function identifier; receive, from the policy charging function, at least one policy and charging control rule associated with the session management policy association, and at least one reference to the at least one policy and charging control rule in the shared structure; and receive, from the policy charging function at the uniform resource locator, an indication that the shared structure has been updated.

In accordance with one example embodiment, an apparatus may comprise means for: transmitting, to a policy charging function, a request to create a session management shared policy association for at least one of: a same data network name the apparatus and the policy charging function serve, or a same network slice selection assistance information the apparatus and the policy charging function serve; transmitting, to the policy charging function, a uniform resource locator at which updates associated with the session management shared policy association may be received; receiving, from the policy charging function, a response to the request, wherein the response may comprise, at least, one or more policy and charging control rules, wherein the one or more policy and charging control rules respectively may comprise a reference to a shared structure; transmitting, to the policy charging function, at least one request to create a session management policy association for a protocol data unit, wherein the at least one request may comprise at least one of: a protocol data unit session identifier, a user equipment identifier, or a session management function identifier; receiving, from the policy charging function, at least one policy and charging control rule associated with the session management policy association, and at least one reference to the at least one policy and charging control rule in the shared structure; and receiving, from the policy charging function at the uniform resource locator, an indication that the shared structure has been updated.

In accordance with one example embodiment, a non-transitory computer-readable medium comprising instructions stored thereon which, when executed with at least one processor, cause the at least one processor to: cause transmitting, with a session management function to a policy charging function, of a request to create a session management shared policy association for at least one of: a same data network name the session management function and the policy charging function serve, or a same network slice selection assistance information the session management function and the policy charging function serve; cause transmitting, to the policy charging function, of a uniform resource locator at which updates associated with the session management policy association may be received; cause receiving, from the policy charging function, of a response to the request, wherein the response may comprise, at least, one or more policy and charging control rules, wherein the one or more policy and charging control rules respectively may comprise a reference to a shared structure; cause transmitting, to the policy charging function, of at least one request to create a session management policy association for a protocol data unit, wherein the at least one request may comprise at least one of: a protocol data unit session identifier, a user equipment identifier, or a session management function identifier; cause receiving, from the policy charging function, of at least one policy and charging control rule associated with the session management policy association, and at least one reference to the at least one policy and charging control rule in the shared structure; and cause receiving, from the policy charging function at the uniform resource locator, of an indication that the shared structure has been updated.

In accordance with one example embodiment, a non-transitory computer-readable medium comprising program instructions stored thereon for performing at least the following: causing transmitting, with a session management function to a policy charging function, of a request to create a session management shared policy association for at least one of: a same data network name the session management function and the policy charging function serve, or a same network slice selection assistance information the session management function and the policy charging function serve; causing transmitting, to the policy charging function, of a uniform resource locator at which updates associated with the session management shared policy association may be received; causing receiving, from the policy charging function, of a response to the request, wherein the response may comprise, at least, one or more policy and charging control rules, wherein the one or more policy and charging control rules respectively may comprise a reference to a shared structure; causing transmitting, to the policy charging function, of at least one request to create a session management policy association for a protocol data unit, wherein the at least one request may comprise at least one of: a protocol data unit session identifier, a user equipment identifier, or a session management function identifier; causing receiving, from the policy charging function, of at least one policy and charging control rule associated with the session management policy association, and at least one reference to the at least one policy and charging control rule in the shared structure; and causing receiving, from the policy charging function at the uniform resource locator, of an indication that the shared structure has been updated.

In accordance with another example embodiment, a non-transitory program storage device readable by a machine may be provided, tangibly embodying instructions executable by the machine for performing operations, the operations comprising: causing transmitting, with a session management function to a policy charging function, of a request to create a session management shared policy association for at least one of: a same data network name the session management function and the policy charging function serve, or a same network slice selection assistance information the session management function and the policy charging function serve; causing transmitting, to the policy charging function, of a uniform resource locator at which updates associated with the session management shared policy association may be received; causing receiving, from the policy charging function, of a response to the request, wherein the response may comprise, at least, one or more policy and charging control rules, wherein the one or more policy and charging control rules respectively may comprise a reference to a shared structure; causing transmitting, to the policy charging function, of at least one request to create a session management policy association for a protocol data unit, wherein the at least one request may comprise at least one of: a protocol data unit session identifier, a user equipment identifier, or a session management function identifier; causing receiving, from the policy charging function, of at least one policy and charging control rule associated with the session management policy association, and at least one reference to the at least one policy and charging control rule in the shared structure; and causing receiving, from the policy charging function at the uniform resource locator, of an indication that the shared structure has been updated.

In accordance with another example embodiment, a non-transitory computer-readable medium comprising instructions that, when executed by an apparatus, cause the apparatus to perform at least the following: causing transmitting, with a session management function to a policy charging function, of a request to create a session management shared policy association for at least one of: a same data network name the session management function and the policy charging function serve, or a same network slice selection assistance information the session management function and the policy charging function serve; causing transmitting, to the policy charging function, of a uniform resource locator at which updates associated with the session management shared policy association may be received; causing receiving, from the policy charging function, of a response to the request, wherein the response may comprise, at least, one or more policy and charging control rules, wherein the one or more policy and charging control rules respectively may comprise a reference to a shared structure; causing transmitting, to the policy charging function, of at least one request to create a session management policy association for a protocol data unit, wherein the at least one request may comprise at least one of: a protocol data unit session identifier, a user equipment identifier, or a session management function identifier; causing receiving, from the policy charging function, of at least one policy and charging control rule associated with the session management policy association, and at least one reference to the at least one policy and charging control rule in the shared structure; and causing receiving, from the policy charging function at the uniform resource locator, of an indication that the shared structure has been updated.

A computer implemented system comprising: at least one processor and at least one non-transitory memory storing instructions that, when executed by the at least one processor, cause the system at least to perform: causing transmitting, with a session management function to a policy charging function, of a request to create a session management shared policy association for at least one of: a same data network name the session management function and the policy charging function serve, or a same network slice selection assistance information the session management function and the policy charging function serve; causing transmitting, to the policy charging function, of a uniform resource locator at which updates associated with the session management shared policy association may be received; causing receiving, from the policy charging function, of a response to the request, wherein the response may comprise, at least, one or more policy and charging control rules, wherein the one or more policy and charging control rules respectively may comprise a reference to a shared structure; causing transmitting, to the policy charging function, of at least one request to create a session management policy association for a protocol data unit, wherein the at least one request may comprise at least one of: a protocol data unit session identifier, a user equipment identifier, or a session management function identifier; causing receiving, from the policy charging function, of at least one policy and charging control rule associated with the session management policy association, and at least one reference to the at least one policy and charging control rule in the shared structure; and causing receiving, from the policy charging function at the uniform resource locator, of an indication that the shared structure has been updated.

A computer implemented system comprising: means for causing transmitting, with a session management function to a policy charging function, of a request to create a session management shared policy association for at least one of: a same data network name the session management function and the policy charging function serve, or a same network slice selection assistance information the session management function and the policy charging function serve; means for causing transmitting, to the policy charging function, of a uniform resource locator at which updates associated with the session management shared policy association may be received; means for causing receiving, from the policy charging function, of a response to the request, wherein the response may comprise, at least, one or more policy and charging control rules, wherein the one or more policy and charging control rules respectively may comprise a reference to a shared structure; means for causing transmitting, to the policy charging function, of at least one request to create a session management policy association for a protocol data unit, wherein the at least one request may comprise at least one of: a protocol data unit session identifier, a user equipment identifier, or a session management function identifier; means for causing receiving, from the policy charging function, of at least one policy and charging rule associated with the session management policy control association, and at least one reference to the at least one policy and charging control rule in the shared structure; and means for causing receiving, from the policy charging function at the uniform resource locator, of an indication that the shared structure has been updated.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

We claim:

1. An apparatus comprising at least one processor; and at least one memory storing instructions that, when executed by the at least one processor, cause the apparatus at least to perform:
determining at least one policy and charging control rule, wherein the at least one policy and charging control rule applies to a plurality of protocol data unit sessions, wherein the at least one policy and charging control rule is associated with at least one indication of at least one of the plurality of protocol data unit sessions to which the at least one policy and charging control rule applies; and
providing the at least one policy and charging control rule.

2. The apparatus of claim 1, wherein the at least one indication of the at least one of the plurality of protocol data unit sessions to which the at least one policy and charging control rule applies comprises at least one of:
a protocol data unit session identifier,
an identifier of a user equipment using the at least one protocol data unit session,
an identifier of a policy control session, wherein the policy control session is associated with the at least one protocol data unit session,
a correlation identifier assigned to at least one policy control session, wherein respective ones of the at least one policy control session are associated with the at least one protocol data unit session,
an identifier of a data network name used for the at least one protocol data unit session, or
an identifier of a slice used for the at least one protocol data unit session.

3. The apparatus of claim 2, wherein the apparatus is further caused to perform:
receiving a request to establish the policy control session associated with the at least one protocol data unit session;
assigning the correlation identifier to the at least one policy control session; and
providing a response to the request to establish the policy control session, wherein the response comprises, at least, the correlation identifier.

4. The apparatus of claim 1, wherein the apparatus is further caused to perform:
providing the at least one policy and charging control rule within a policy control session associated with one of the at least one protocol data unit session.

5. The apparatus of claim 1, wherein the apparatus is further caused to perform:
providing the at least one policy and charging control rule within a policy control session that is not associated with the at least one protocol data unit session.

6. An apparatus comprising at least one processor; and
at least one memory storing instructions that, when executed by the at least one processor, cause the apparatus at least to perform:
establishing a plurality of protocol data unit sessions, wherein respective protocol data unit sessions of the plurality of protocol data unit sessions are configured to be used to send data streams towards a user equipment and/or to receive data streams from the user equipment;
receiving at least one policy and charging control rule, wherein the at least one policy and charging control rule applies to two or more of the plurality of protocol data unit sessions, wherein the at least one policy and charging control rule is associated with at least one indication of the two or more protocol data unit sessions to which the at least one policy and charging control rule applies; and
applying one or more of the at least one policy and charging control rules to data streams transported within respective ones of the two or more protocol data unit sessions.

7. The apparatus of claim 6, wherein the at least one indication of the two or more protocol data unit sessions to which the at least one policy and charging control rule applies comprises at least one of:
a protocol data unit session identifier,
an identifier of a user equipment using the two or more protocol data unit sessions,
an identifier of a policy control session, wherein the policy control session is associated with the two or more protocol data unit sessions,
a correlation identifier assigned to at least one policy control session, wherein respective ones of the at least one policy control session are associated with the two or more protocol data unit sessions,
an identifier of a data network name used for the two or more protocol data unit sessions, or
an identifier of a slice used for the two or more protocol data unit sessions.

8. The apparatus of claim 7, wherein the apparatus is further caused to perform:
transmitting a request to establish a policy control session associated with at least one protocol data unit session; and
receiving a response to the request to establish the policy control session, wherein the response contains the correlation identifier.

9. The apparatus of claim 6, wherein the apparatus is further caused to perform:
receiving the at least one policy and charging control rule within a policy control session associated with one of the two or more protocol data unit sessions.

10. The apparatus of claim 6, wherein the apparatus is further caused to perform:
receiving the at least one policy and charging control rule within a policy control session that is not associated with the two or more protocol data unit sessions.

11. An apparatus comprising at least one processor; and
at least one memory storing instructions that, when executed by the at least one processor, cause the apparatus at least to perform:
determining at least one policy and charging control rule, wherein the at least one policy and charging control rule comprises at least one policy fragment identifier, wherein the at least one policy fragment identifier identifies a fragment of policy or charging information that is applicable to a plurality of protocol data unit sessions; and
providing the at least one policy and charging control rule.

12. The apparatus of claim 11, wherein the apparatus is further caused to perform:
receiving a request to establish a policy control session not associated with the plurality of protocol data unit sessions; and
providing the at least one policy fragment identifier, and the fragment of policy or charging information identified with the at least one policy fragment identifier, within the policy control session not associated with the plurality of protocol data unit sessions.

13. The apparatus of claim 11, wherein the apparatus is further caused to perform:
providing, to a database, the at least one policy fragment identifier, and the fragment of policy or charging information identified with the at least one policy fragment identifier.

14. The apparatus of claim 11, wherein the fragment of policy or charging information identified with the at least one policy fragment identifier is comprised within a packet flow description extended with at least one additional content.
